(19) United States
(12) Patent Application Publication
(10) Pub. No.: US 2026/0031094 A1
(43) Pub. Date: Jan. 29, 2026

(54) AUDIO PROCESSOR, AUDIO PROCESSING SYSTEM, AUDIO DECODER, METHOD FOR PROVIDING A PROCESSED AUDIO SIGNAL REPRESENTATION AND COMPUTER PROGRAM USING A TIME SCALE MODIFICATION

(71) Applicant: Fraunhofer-Gesellschaft zur Förderung der angewandten Forschung e.V., München (DE)

(72) Inventors: Stefan BAYER, Erlangen (DE); Stefan DÖHLA, Erlangen (DE); Kacper SAGNOWSKI, Erlangen (DE); Markus MULTRUS, Erlangen (DE); Bernd EDLER, Erlangen (DE); Anika TREFFEHN, Erlangen (DE); Karin PREBECK, Erlangen (DE); Dominik HÄUSSLER, Erlangen (DE); Andrea EICHENSEER, Erlangen (DE); Franz REUTELHUBER, Erlangen (DE)

(21) Appl. No.: 19/349,408

(22) Filed: Oct. 3, 2025

Related U.S. Application Data
(63) Continuation of application No. PCT/EP2024/059251, filed on Apr. 4, 2024.

(30) Foreign Application Priority Data
Apr. 5, 2023 (WO) PCT/EP2023/059072

(51) Int. Cl. G10L 21/04; G10L 19/008

(52) U.S. Cl. CPC G10L 21/04; G10L 19/008

(57) ABSTRACT

An audio processor for providing a processed audio signal representation on the basis of an input audio signal representation performs a plurality of processing steps, in order to provide the processed audio signal representation on the basis of the input audio signal representation. The audio processor performs a time scale modification on one or more intermediate audio signals, which are provided by a first processing, in order to obtain one or more time-scale-modified intermediate audio signals, and the audio processor performs a second processing, which follows the first processing, on the basis of the one or more time-scale-modified intermediate audio signals. An audio processing system, a method and a computer program are also described.

### CROSS-REFERENCES TO RELATED APPLICATIONS

This application is a continuation of copending International Application No. PCT/EP2024/059251, filed Apr. 4, 2024, which is incorporated herein by reference in its entirety, and additionally claims priority from International Application Nos. PCT/EP2023/059072, filed Apr. 5, 2023, which is incorporated herein by reference in its entirety.

Embodiments according to the invention are related to an audio processor for providing a processed audio signal representation on the basis of an input audio signal representation.

Further embodiments according to the invention are related to an audio processing system for providing a processed audio signal representation on the basis of an input audio signal representation.

Further embodiments according to the invention are related to an audio decoder for providing a decoded audio representation on the basis of an encoded audio representation.

Further embodiments according to the invention are related to a method for providing a processed audio signal representation on the basis of an input audio signal representation.

Further embodiments according to the invention are related to a computer program.

Embodiment according to the invention are related to an audio processor with multiple stages and (one or more) immediate audio signals and time scale modification on an intermediate audio signal.

### BACKGROUND OF THE INVENTION

In the following, some conventional apparatuses, systems and methods will be described. However, it should be noted that features, functionalities and details of these conventional apparatuses, systems and methods may optionally be introduced into any of the embodiments of the present invention, both individually and in combination. In particular, features, functionalities and details disclosed in the cited/referenced documents may optionally be introduced into the embodiments according to the present invention.

It has been found that in a communication system, the uninterrupted playout of the decoded audio signal is important for a good communication (or hearing impression), advantageously with as low delay as possible. Typically, a communication codec creates information for consecutive frames of 20 milliseconds. If the (audio) information is sent via a packet-based network, the individual packets containing one or more frames of audio information are not guaranteed to be arriving at the receiver at constant time intervals but can arrive at times different from the expected one within the framing grid of the codec itself. This deviation is the so-called network jitter.

To ensure smooth playout despite this, a mechanism can be introduced to manage the possible jitter, the so-called jitter buffer management (JBM). In the simplest case, a buffer is used, large enough to compensate for the jitter while keeping the playout delay fixed. Since this approach is too simplistic (e.g., for many applications) and would require large buffers (and consequently creates large delays), so-called adaptive JBMs are used that can adapt to varying network conditions while keeping the playout delay low to only cover the variation of the network jitter, e.g., by dropping silent frames or adding artificial silent ones [1], or in a more sophisticated way, additionally to dropping frames or adding silent frames or frames marked as corrupted, time scale modification (TSM) is applied to the decoded audio signal for a more fine grain adjustment of the playout delay [2][3]. For example, FIG. 5a shows the modules of the JBM described in [2].

It should be noted that modules of the EVS jitter buffer management solution may optionally be used in embodiments according to the invention. Moreover, embodiments of the invention could optionally be used in connection with EVS frames.

Also, the complete decoding flow including the acoustic front end of a device where the decoding process is run is shown in FIG. 5b. The acoustic front end synchronously asks the receiver output buffer for a constant frame (or a constant flow) of decoded PCM samples, i.e., pulls the PCM buffer. Typically, the frame size pulled is equal to the frame size of one decoded frame of audio data, e.g. 20 milliseconds in EVS.

The time scaling procedure in the EVS standard is a waveform similarity overlap add (WSOLA). FIG. 5c and FIG. 5d show how the shortening and lengthening of input frames is done.

In a scope of a communication codec like the upcoming 3GPP immersive voice and audio services (IVAS) [4] it is now possible to send complex audio scenes comprising more than one audio channel. To achieve low bit rates for such complex scenes, usually based on multi-channel configurations, object-based audio or e.g. as scene based audio in an Ambisonics representation, typically less channels of audio than put into the encoder are coded as transport channels (TCs) together with parametric information to reconstruct the full audio scene at the decoder, i.e. the number of reconstructed channels at the decoder is typically greater than the number of channels of audio transported in the encoded frames [5][6]. FIG. 6 shows a generic block diagram for such operating modes. The requested output format might differ from the encoded format and further rendering may be needed to get from the encoded format to the output format.

The renderer may work directly on the time domain samples of the decoded transport channels or may employ a time-frequency transform before the processing, i.e., transforming the time domain samples to the frequency domain, or in a more general sense to the filter bank domain used for the processing (FD), typically dividing one frame of time domain samples into a smaller number of time slots. Furthermore, the metadata associated with the decoded transport channels may also be divided into subframes, wherein one of the multiple sets of metadata for a frame is associated with a specific subframe. Each subframe comprises multiple samples of the decoded transport channels or, in the case of frequency domain processing in the renderer, one or more time slots.

FIG. 5e shows such processing where the frame decoded transport channels frame (TC frame) is processed by a time frequency transform, resulting in a number of time slots (TS) of frequency domain samples. The renderer reconstructs and renders the output format using parameters associated to the TC frame, in this example a number of parameter sets are used, each one associated with one subframe (SF), each comprising a number of time slots. The renderer produces the desired output channels in the frequency domain and the desired output channels time samples are generated by the inverse time frequency domain transform of the rendered frequency domain time slots.

Furthermore the rendering might include a binaural rendering with additional listener position information (part of the rendering parameters in FIG. 6), here the so called motion-to-sound delay is of great importance to the listening impression and should be as low as possible, especially if one likes to achieve a fine grain JBM like in [2][3], the TSM should be done in the same manner for all output channels.

The straightforward way to have a JBM for such a decoder would be a TSM like in [2][3] applied on the output channels and synchronized across all output channels. FIG. 8 shows a block diagram of such a solution. The only difference to the EVS JBM solution is that the TSM module is now a multi-channel (MC) TSM that is synchronized across all output channels. It has been found that this naïve approach has several drawbacks. It increases the complexity since the TSM has to be applied on all output channels. It is harder to achieve good quality over all frames due to differences in the audio signal and the necessity of the synchronized TSM over all channels. The motion-to-sound delay in case of a binaural renderer with listener position information is increased. Furthermore the TSM together with the receiver output buffer cause the delay and hence the motion-to-sound delay not to be constant.

Generally such a decoder can be seen as belonging to a class of audio processors where the processor has multiple stages with intermediate audio signals and each processing stage might optionally get parameters to steer the processing (FIG. 7).

It has been recognized that so the IVAS parametric reconstruction from FIG. 6 we can see as 2 stage audio processor where the Input Audio Signal Representation are the coded frames, stage 1 is the Transport Channel and Metadata decoder (and needs no processing parameter), the decoded transport channels are the intermediate audio signal 1, stage 2 is the reconstruction and rendering, processing parameters 2 are the decoded metadata and additional rendering parameters and processed audio signal are the final output channels.

It should be noted that the above mentioned general concepts may optionally be employed in embodiments according to the present invention.

In view of this situation, there is a desire to have a concept which allows for a time scale modification with an improved tradeoff between complexity, processing latency and achievable hearing impression.

### SUMMARY

An embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals.

Another embodiment may have an audio processing system for providing a processed audio signal representation on the basis of an input audio signal representation, wherein the audio processing system is configured to perform a plurality of processing steps, in order to provide the processed audio signal representation on the basis of the input audio signal representation; wherein the audio processing system is configured to perform a time scale modification on one or more intermediate audio signals, which are provided by a first processing on the basis of the input audio representation, in order to acquire one or more time-scale-modified intermediate audio signals, and wherein the audio processing system is configured to perform a second processing, which follows the first processing and which provides the processed audio signal representation, on the basis of the one or more time-scale-modified intermediate audio signals, or on the basis of signals derived from the one or more time scale modified intermediate audio signals; wherein functionalities of the audio processing system are distributed to two or more devices.

Another embodiment may have an audio decoder for providing a decoded audio representation on the basis of an encoded audio representation, wherein the audio decoder comprises an audio processor according to the invention. Another embodiment may have a method for providing a processed audio signal representation on the basis of an input audio signal representation, wherein the method comprises performing a plurality of processing steps, in order to provide the processed audio signal representation on the basis of the input audio signal representation; wherein the method comprises performing a time scale modification on one or more intermediate audio signals, which are provided by a first processing on the basis of the input audio representation, in order to acquire one or more time-scale-modified intermediate audio signals, and wherein the method comprises performing a second processing, which follows the first processing and which provides the processed audio signal representation, on the basis of the one or more time-scale-modified intermediate audio signals.

Another embodiment may have a non-transitory digital storage medium having a computer program stored thereon to perform the method for providing a processed audio signal representation on the basis of an input audio signal representation, wherein the method comprises performing a plurality of processing steps, in order to provide the processed audio signal representation on the basis of the input audio signal representation; wherein the method comprises performing a time scale modification on one or more intermediate audio signals, which are provided by a first processing on the basis of the input audio representation, in order to acquire one or more time-scale-modified intermediate audio signals, and wherein the method comprises performing a second processing, which follows the first processing and which provides the processed audio signal representation, on the basis of the one or more time-scale-modified intermediate audio signals, when said computer program is run by a computer.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing, that is performed by the audio processor, on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein audio processor is configured to perform the first processing for time segments of a first length; and wherein audio processor is configured to perform the second processing for time segments of a second length which is shorter than the first length, or wherein the audio processor is configured to perform the second processing with temporal increments of a second length, which is smaller than the first length, wherein one or more intermediate audio signals of the second length are input into the second processing for each execution of the second processing; wherein a granularity of the time scale modification is finer than the second length, such that the time scale modification may result in frame lengths of the one or more time scale modified intermediate audio signals which deviate from integer multiples of the second length.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio signal processor is configured to provide the one or more time-scale-modified intermediate audio signals such that a length of a respective frame of the one or more time-scale-modified intermediate audio signals is different from a multiple of a block size used in the second processing; and/or wherein the audio processor is configured to perform the second processing with step-wise temporal increments, wherein the audio signal processor is configured to provide the one or more time-scale-modified intermediate audio signals such that a length of a respective frame of the one or more time-scale-modified intermediate audio signals is different from a multiple of the temporal increments.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio signal processor is configured to form a block of samples for the second processing on the basis of one or more time domain samples associated with a previous frame of the one or more time-scale-modified intermediate audio signals and on the basis of one or more time domain samples associated with a current frame of the one or more time-scale-modified intermediate audio signals, and wherein the audio signal processor is configured to form one or more blocks of samples for the second processing on the basis of a plurality time domain samples associated with a current frame of the one or more time-scale-modified intermediate audio signals, until there are not enough time domain samples associated with a current frame of the one or more time-scale-modified intermediate audio signals left to form a block of samples for the second processing, such that blocks of samples for the second processing having uniform length are formed even if the time scale modification changes a frame length to be different from an integer multiple of the length of the blocks of samples used for the second processing, and wherein the audio signal processor is configured to buffer one or more residual time domain samples, i.e. excessive time domain samples which are not sufficient for a formation of a block of samples for the second processing, associated with a current frame of the one or more time-scale-modified intermediate audio signals for a formation of a block of samples for the second processing which includes one or more time domain samples associated with a subsequent frame of the one or more time-scale-modified intermediate audio signals.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to use one or more buffered residual time domain samples, i.e. excessive time domain samples which are not sufficient for a formation of a block of samples for the second processing, associated with a previous frame and a maximum possible number of time domain samples associated with the current frame of the one or more time-scale-modified intermediate audio signals for a formation of blocks of samples for the second processing associated with the current frame, such that blocks of samples for the second processing having uniform length are formed even if the time scale modification changes a frame length to be different from an integer multiple of the length of the blocks of samples used for the second processing.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to selectively switch to a special time scale modification mode for frames classified as silent; and wherein the audio processor is configured to perform the time scale modification in such a manner that no buffering of residual frames is required, when operating in the special time scale modification mode; wherein a number of time domain samples of a current time-scale modified frame plus a number of buffered time domain samples of a previous time scale modified frame is an integer multiple of a number of time domain samples of a block of time domain samples processed by the second processing, or wherein a number of time domain samples of a current time-scale modified frame plus a number of buffered time domain samples of a previous time scale modified frame is an integer multiple of a number of time domain samples input into the second processing to make a temporal increment when operating in the special time scale modification mode.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to time-interpolate between one or more processing parameters associated with a previous frame of the one or more intermediate audio signals and one or more processing parameters associated with a current frame of the one or more intermediate audio signals, in order to acquire processing parameters associated with different time instances of a current frame of the one or more time-scale modified intermediate audio signals using an interpolation function which determines contributions of the one or more processing parameters associated with the previous frame and contributions of one or more processing parameters associated with the current frame in a linear combination of processing parameters; wherein for a temporally shortened audio frame, the interpolation function comprises a larger slope for a portion of the time scale modified current frame which has been acquired using an overlap-add-combination than for a portion of the time scale modified current frame which is unmodified; and/or wherein for a temporally lengthened audio frame, the interpolation function comprises a smaller slope for a portion of the time scale modified current frame which has been acquired using an overlap-add-combination than for a portion of the time scale modified current frame which is unmodified.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to time-interpolate between one or more processing parameters associated with a previous frame of the one or more intermediate audio signals and one or more processing parameters associated with a current frame of the one or more intermediate audio signals, in order to acquire processing parameters associated with different time instances of a current frame of the one or more time-scale modified intermediate audio signals using an interpolation function which determines contributions of the one or more processing parameters associated with the previous frame and contributions of one or more processing parameters associated with the current frame in a linear combination of processing parameters; wherein the audio processor is configured to acquire interpolated processing parameters Pinter[n] associated with time instances having time index n according to

$$Pinter [ n ] = ga , f [ n ] P + ( 1 - ga , f ) Pprev ,$$

wherein P is a processing parameter or a set of processing parameters associated with a current frame of the one or more intermediate audio signals, wherein Pprev is a processing parameter or a set of processing parameters associated with a previous frame of the one or more intermediate audio signals, wherein Pinter is a processing parameter or a set of processing parameters associated with a time instance n in a current frame of the one or more time scale modified intermediate audio signals, and wherein ga,f is an interpolation function; wherein the interpolation function ga,f is defined as

$${g}_{a , f} [ n ] = max ( 0 , {g}_{a} [ n ] ) ,$$

$$and$$

$$wherein$$

$${g}_{a} [ n ] = \{ \begin{matrix}\frac{n + 1 + ( {L}_{seg} - {L}_{rem} )}{2 {L}_{seg}} , & {L}_{Seg} \leq n < {L}_{f} \\ ( n + 1 ) \frac{2 {L}_{seg} + 1 - {L}_{rem}}{2 {L}_{seg} ( {L}_{seg} + 1 )} , & 0 \leq n < {L}_{Seg}\end{matrix}$$

wherein n is a time index, wherein Lrem=Lf−Lseg, wherein Lf is a length of a frame to be processed; wherein Lseg is the length of a portion in which an overlap-and-add is applied by the time scale modification.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to perform, as the second processing, a processing of values of the one or more time-scale-modified intermediate audio signals according to

$$y [ n ] = ( {g}_{a , f} [ n ] M + ( 1 - {g}_{a , f} [ n ] ) {M}_{prev} ) x [ n ] , 0 \leq n < {L}_{f}$$

or according to

$${y}_{k} [ n ] = ( {g}_{a , f} [ n ] {M}_{k} + ( 1 - {g}_{a , f} [ n ] ) {M}_{k , prev} ) {x}_{k} [ n ] , 0 \leq n < {L}_{f} ,$$

wherein x[n] and xk[n] are of values or sets of value of the one or more time-scale-modified intermediate audio signals, wherein M is a processing parameter or a set of processing parameters associated with a current frame of the one or more intermediate audio signals; wherein Mprev is a processing parameter or a set of processing parameters associated with a previous frame of the one or more intermediate audio signals, wherein n is a time index, wherein Lf is a length of a frame to be processed, and wherein ga,f is an interpolation function.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; Wherein the audio processor is configured to determine a mapping vector defining an association between time slots of the one or more time scale modified intermediate audio signals and subframe indices of subframes of the one or more original intermediate audio signals in dependence on the time scale modification such that the mapping describes which processing parameters are allocated with which time slot of the time scale modified intermediate audio signals.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; Wherein the audio processor is configured to determine a mapping vector defining an association between time slots of the one or more time scale modified intermediate audio signals and time slots of the one or more original intermediate audio signals in dependence on the time scale modification, such that the mapping vector describes which processing parameters are allocated with which time slot of the time scale modified intermediate audio signals.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to modify a subframe grid of subframes of the one or more time scale modified intermediate audio signals in dependence on a time scale modification of a current frame, wherein lengths of subframes of the one or more time scale modified intermediate audio signals are left unchanged, and wherein the second processing is configured to perform a subframe-based operation.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; Wherein the audio processor is configured to modify a transient position information in dependence on the time scale modification.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to determine a mapping vector defining an association between time slots of the one or more time scale modified intermediate audio signals and subframe indices of subframes of the one or more original intermediate audio signals in dependence on the time scale modification such that the mapping describes which processing parameters are allocated with which time slot of the time scale modified intermediate audio signals; wherein the audio processor is configured to determine the mapping vector according to

$${m}_{sf} [ n ] = modulo ( {n}_{offset} + max ( 0 , \frac{⌊ ( 2 {L}_{seg} - 1 ) {g}_{a , map} [ n ] ⌉}{{L}_{sf}} ) , {L}_{md} )$$

or according to

$${m}_{sf} [ n ] = max ( 0 , \frac{⌊ ( 2 {L}_{seg} - 1 ) {g}_{a , map} [ n ] ⌉}{{L}_{sf}} )$$

Wherein m_{sf}[n] is an element of the mapping vector; Wherein n is a time slot index; Wherein n_{offset} is an offset value; Wherein L_{seg} is a half of a length of a frame of the one or more original intermediate audio signals in time slots; Wherein 2L_{seg} is a length of a frame of the one or more original intermediate audio signals in time slots; Wherein Lsf is a length of a subframe in time slots; Wherein L_{md} is a length of a metadata buffer; Wherein n_{offset} is; and Wherein g_{a,map}[n] is an interpolation function; Wherein └ ┐ denotes a rounding to a nearest integer; Wherein modulo is a modulo operation and Wherein a division is an integer division.

Another embodiment may have an audio processor for providing a processed audio signal representation on the basis of an input audio signal representation, wherein the audio processor is configured to perform a plurality of processing steps, in order to provide the processed audio signal representation on the basis of the input audio signal representation; wherein the audio processor is configured to perform a time scale modification on one or more intermediate audio signals, which are provided by a first processing on the basis of the input audio representation, in order to acquire one or more time-scale-modified intermediate audio signals, and wherein the audio processor is configured to perform a second processing, which follows the first processing and which provides the processed audio signal representation, on the basis of the one or more time-scale-modified intermediate audio signals; wherein the audio processor is configured to determine a mapping vector defining an association between time slots of the one or more time scale modified intermediate audio signals and time slots of the one or more original intermediate audio signals in dependence on the time scale modification, such that the mapping vector describes which processing parameters are allocated with which time slot of the time scale modified intermediate audio signals, wherein the audio processor is configured to determine the mapping vector according to

$${m}_{ts} [ n ] = max ( 0 , ⌊ ( 2 {L}_{seg} - 1 ) {g}_{a , map} [ n ] ⌉ )$$

Wherein n is a time slot index, Wherein 2Lseg is a length of a frame of the one or more original intermediate audio signals in time slots; and Wherein g_{a,map}[n] is an interpolation function.

An embodiment according to the invention creates an audio processor (e.g. an audio decoder) for providing a processed (e.g. decoded and rendered) audio signal representation (e.g. in the form of a plurality of rendered time domain audio signals) on the basis of an input audio signal representation (e.g. an encoded representation of a multi-channel audio content). The audio processor is configured to perform a plurality of processing steps (e.g. separate processing functionalities; e.g. a first processing and a second processing), in order to provide the processed audio signal representation on the basis of the input audio signal representation. The audio processor is configured to perform a time scale modification (e.g. a modification of a length of an audio signal portion, e.g. an audio frame, provided by the first processing) on one or more intermediate audio signals, which are provided by a first processing (e.g. a first processing step), in order to obtain one or more time-scale-modified intermediate audio signals. The audio processor is configured to perform a second processing [e.g. a second processing step; e.g. an upmix and/or a rendering], which follows the first processing [e.g. the first processing step], on the basis of the one or more time-scale-modified intermediate audio signals.

This embodiment is based on the finding that it is advantageous, in many applications, to perform a time scale modification on one or more intermediate signals in an audio signal processor, wherein a first processing provides the one or more intermediate signals, wherein the time scale modification is applied to these one or more intermediate signals, and wherein a subsequent second processing, which follows the first processing, is performed (i.e., applied to) the one or more time scale-modified intermediate audio signals.

It has been recognized that the one or more intermediate signals are often better-suited for a time scale modification with a high temporal resolution (e.g., with a fine temporal granularity), while one or more input audio signals of the first processing are often not-well suited for such a time scale modification. Furthermore, it has been recognized that it is relatively easy to adequately adapt processing parameters, which may, for example, adjust the second processing, to the time scale modification. It has been recognized that processing parameters can more easily and more accurately be adapted to the time scale modification if the time scale modification is applied to one more intermediate audio signals between the first processing and the second processing. For example, it has been recognized that an application of the time scale modification before the first processing would make it significantly more difficult to have the processing parameters of the second processing adapted said time scale modification. Furthermore, it has been recognized that applying the time scale modification after the second processing, would, in some cases, result in an inadequately long latency until adaptations of processing parameters of the second processing exhibit an effect on the processed (output) audio signal representation. Also, applying the time scale modification after the second processing would result in a variable motion-to-sound delay, which would degrade the hearing impression.

In contrast, by applying the time scale modification before the second processing, which may, for example, use one or more motion parameters to obtain the processed audio signal representation und adapts the processed audio signal representation to a motion defined by the one or more motion parameters, a motion-to-sound delay can be kept constant, since there is no need for any time scale modification after the second processing. Thus, a particularly good hearing impression can be achieved.

In other words, it has been recognized that a processing after the time scale modification (TSM) allows for achieving a constant delay between processing parameters and processed audio signal.

In addition, it has also been recognized that an additional receiver output buffer is no longer necessary since we can now render exactly the amount of audio signal asked e.g. by an acoustic frontend. Thus, an implementation effort is reduced.

Moreover, it has also been recognized that, in many applications, a number of intermediate audio signals is a smaller than a number of audio signals of the processed audio signal representation, such that an application of the time scale modification to the one or more intermediate audio signals may also bring along a reduction of complexity.

To conclude, it has been recognized that the application of the time scale modification to one or more intermediate audio signals, i.e., between a first processing and a second processing, constitutes a particularly good solution that brings along a good comprise between an achievable audio quality, an implementation complexity and a responsiveness.

In an embodiment, the audio processor is configured to perform the second processing in dependence on one or more parameters (e.g. in dependence on decoded metadata or rendering parameters), wherein, for example, the one or more parameters which are used in the second processing may be temporally associated with frames or subframes of the one or more intermediate audio signals (e.g. before the time scale modification).

It has been recognized that an efficient audio processing can be made by performing the second processing in dependence on one or more parameters. Accordingly, the second processing can be adapted in accordance with processing parameters which are input into the audio processor, wherein the processing parameters may, for example, originate from the input audio representation (which may, for example, comprise the processing parameters as a side information) and/or wherein the processing parameters may be based on a user interaction. Thus, the second processing may be used to adapt the intermediate audio signal representation to have characteristics defined in the input audio signal representation and/or to have characteristics that are defined by a user interaction. However, it has been found that applying the processing parameters in the second processing, i.e., after the time scale modification, often brings along the effect that the processed audio signal representation provides a good hearing impression. Also, by applying processing parameters, which depend on user interaction, in the second processing, i.e., after the time scale modification, typically results in a quick response of the processed audio signal representation to user interactions, which typically, well-satisfies users expectations.

In an embodiment, the audio processor is configured to adapt the second processing to the time scale modification (e.g. by adapting metadata used in the second processing, which may, for example, be derived from an encoded audio representation, to the time scale modification, and/or by adapting one or more (internal) processing parameters of the second processing, e.g. interpolation steps, to the time scale modification).

It has been recognized that such an adaptation of the second processing to the time scale modification typically results in a particularly good hearing impression. For example, a shortening or lengthening of the one or more time scale modified intermediate audio signals (when compared to the one or more (original) audio signals) may be taken into account in the second processing. Just as an example, a speed with which parameters of the second processing change can be adapted to the time scale modification (such that, for example, parameters applied in the second processing change (relatively) slowly if the time scale modification comprises a lengthening, and such that parameters used in the second processing change comparatively fast (er) if the time scale modification comprises a shortening). Accordingly, by having the possibility to adapt characteristics of internal processing functions of the second processing to the time scale modification and/or to adapt one or more parameters used in the second processing to the time scale modification, it can be achieved that the second processing well fits the characteristics of the time scale modified intermediate audio signals. Accordingly, a good hearing impression can be achieved.

It has been found that an adaptation of one or more processing parameters, which are considered in the second processing (i.e., which adapt the characteristics of the second processing) results in a good audio processing that provides a good hearing impression. For example, it has been found that the time scale modification, which results in a lengthening or shortening of the time scale modified intermediate audio signal may have the effect that original processing parameters intended for the use by the second processing may no longer fit the one or more time scale modified intermediate audio signals that are input into the second processing. Thus, by adapting the processing parameters to the time scale modification (e.g. using an interpolation or an extrapolation or a repetition), or by a generation of an additional parameter or parameter set (e.g. in the case of a lengthening of the time scale modified intermediate audio signals) or by a cancellation of a parameter or parameter set (e.g. in the case of a shortening of the time scale modified intermediate audio signals) it is typically possible to reduce or even eliminate audible artefacts in the processed audio signal representation that may otherwise originate from the time scale modification.

Thus, the processing parameters, which are typically in a temporal relationship with the one or more intermediate audio signals, can be adapted to a new, modified time scale of the time scale modified intermediate audio signals, such that the second processing processes portions of the one or more time scale modified intermediate audio signals with the “proper” associated parameters. Accordingly, a good audio quality can be achieved with moderate effort.

In an embodiment, the audio processor (e.g. a parameter adapter which is part of the audio processor) is configured to adapt one or more processing parameters (e.g. decoded metadata and/or rendering parameters; e.g. metadata defining how the second processing should perform a rendering and/or an upmix; e.g. spatial metadata defining how the second processing should perform a rendering and/or an upmix; e.g. metadata defining a relationship (e.g. a level difference and/or a phase difference and/or a correlation and/or a covariance) between two or more upmixed and/or rendered audio signals which are obtained by the second processing; e.g. metadata defining a direction; e.g. metadata associated with one or more transport channel signals, which are intermediate audio signals) to the time scale modification (e.g. to an outcome of the time scaling, wherein, for example, a target value for the time scaling is determined by a jitter buffer control or by a user setting, and wherein, for example, an actual value of the time scaling is determined in dependence on characteristics of the one or more intermediate signals), to obtain adapted processing parameters. The audio processor may be configured to perform the second processing in dependence on the one or more adapted parameters.

The adaptation of the of the one or more processing parameters to the time scale modification allows to perform the second processing in synchronism with the time scale modified intermediate audio signals and therefore brings along a good hearing impression.

In an embodiment of the audio processor, the one or more processing parameters are temporally associated with the one or more intermediate audio signals (e.g. temporally associated with respective frames or subframes of the one or more intermediate audio systems), wherein, for example, one processing parameter, or one set of processing parameters, may be associated with every subframe of the one or more intermediate audio signals (wherein, for example, the one or more processing parameters are spatial metadata with subframes associated to the time-domain intermediate audio signal). The audio processor may be configured to obtain the adapted processing parameters such that the adapted processing parameters are adapted to a timing of the time-scale-modified intermediate audio signals.

It has been recognized that obtaining the adapted parameters such that the adapted processing parameters are adapted to timing of the time scale modified intermediate audio signals may ensure a proper association between the one or more time scale modified intermediate audio signals and the processing parameters. For example, the shortening or lengthening of the one or more intermediate audio signals, which is caused by the time scale modification, may invalidate an original temporal association between portions (subframes) of the one or more intermediate audio signals and processing parameters. However, the adaptation of the processing parameters may re-establish a proper temporal alignment between adapted processing parameters and associated portions in (e.g. subframes) of the one or more time scale modified intermediate audio signals. However, the adaption of the processing parameters may comprise the establishment of a proper temporal association, but may also comprise a quantitative modification of the processing parameters, e.g. by interpolation or extrapolation or other processing functionalities. Thus, it may be achieved that the proper processing parameters, which may be modified when compared to the original processing parameters, are associated with the portions, (e.g., subframes) of the one or more time scale modified intermediate audio signals. Consequently, a degradation of hearing impression by the time scale modification can be prevented or at least reduced to an acceptable level.

In an embodiment, the audio processor is configured to obtain the adapted processing parameters using a temporal interpolation (e.g. between two or more (original) processing parameters), wherein, for example, the temporal interpolation is determined by a time associated with the adapted processing parameters and times associated with the original processing parameters (e.g. such that the adapted processing parameters are adapted in accordance with the time scale modification). Alternatively, however, a temporal extrapolation could be used.

By obtaining the adapted processing parameters using a temporal interpolation, an effect that the original processing parameters do not properly fit the time scale of the one or more time scale modified intermediate audio signals can be addressed. For example, as an effect of the time scale modification, original processing parameters, which are originally associated with portions (e.g. subframes) of the (original) intermediate audio signals may no longer fit to a processing parameter time grid of the one or more time scale modified intermediate audio signals. Just as an example, an original processing parameter (or an original set of processing parameters) may be associated with a subframe of a certain length of the (original) one or more intermediate audio signals. However, this subframe of the certain length may be mapped onto a portion of the one or more time scale modified intermediate audio signals having a different length. If the second processing requires that there's one processing parameter, or one set of processing parameters, per the given length of the one or more time scale modified intermediate audio signals, it becomes apparent that the original parameter or the original set of parameters does not fit to the full temporal portion of the one or more time scale modified intermediate audios signals onto which the corresponding portion of the (original) intermediate audio signals are mapped by the time-scaling. Wording it differently, since the one or more time scale modified intermediate audio signals have a different temporal duration that the one or more (original) intermediate audio signals on which the time scale modified intermediate audio signals are based, there is no one-to-one correspondence between parameter time portions of the original intermediate audio signals (to which original processing parameters are associated) and parameter time portions of the time scale modified intermediate audio signals.

However, it has been recognized that an adaptation of processing parameters associated with parameter time portions of the one or more time scale modified intermediate audio signals can be achieved by an interpolation, wherein, for example, one or more processing parameters or sets of processing parameters can be associated with respective time instances of the (original) one or more intermediate audio signals and also with respective time instances of the one or more time scale modified intermediate audio signals, and can, therefore, be considered as support points for an interpolation-based determination of one or more processing parameters associated with required parameter time instances of the time scale modified intermediate audio signals. Worded yet differently, using knowledge of the time scale modification, processing parameter time instances can be mapped from the time scale of the one or more (original) intermediate audio signals to the time scale of the (one or more) time scale modified intermediate audio signals, wherein time instances on the time scale of the time scale modified intermediate audio signals for which processing parameters are required may be different from those parameter time instances which are obtained by the mapping of the parameter time instances based on the parameter time instances of the original processing parameters. Thus, processing parameters adapted to the required parameter time instances may be obtained by the interpolation, e.g., using the mapped parameter time instances. Consequently, interpolated processing parameters may be obtained which are well-usable for the further processing of the one or more time scale modified intermediate audio signals.

In particular, it has been found that interpolation techniques are well-suited for obtaining a undistorted processed output audio signal representation by the second processing.

In an embodiment, the audio processor is configured to apply a time scale modification on one or more decoded transport channels (wherein the one or more decoded transport channels are the one or more intermediate audio signals), e.g. in order to counteract a jitter of transport packets, which comprise an encoded representation of the one or more transport channels (e.g. in order to shorten or lengthen frames of the decoded transport channels, e.g. with a sub-frame resolution; e.g. controlled by a jitter buffer control).

It has been found that applying a time scale modification on one or more decoded transport signals often results in a particularly good compromise between computational complexity and an achievable quality. For example, it has been recognized that applying a time scale modification on one or more decoded transport channels is typically possible with a finer temporal granularity (resolution) when compared to a time scaling of an encoded representation (e.g., an encoded representation of transport channels). Moreover, it has also been recognized that it is typically advantageous to apply a time scale modification to the decoded transport channels, since applying the time scale modification to the decoded transport channels typically requires a smaller processing effort when compared to applying a time scale modification to output audio signals (e.g., individual channel signals) provided, for example, by a subsequent processing of the decoded transport channels. For example, it has been recognized that output audio signals obtained by a further processing of the decoded transport channels typically comprise a larger amount of audio information (e.g., more channels and/or a higher bandwidth) compared to the transport channels. Furthermore, it has been recognized that the application of the time scale modification to the decoded transport channels is also particularly advantageous since this typically does not affect “real time” characteristics of the output audio signals that are derived from the decoded transport channels, because “real time” relevant parameters are typically applied in the further processing following the time scale modification. In other words, it has been recognized that the application of the time scale modification on the decoded transport channels allows for an efficient time scaling which will provide the chance to introduce real time characteristics into the output audio signal representation. Moreover, it should be noted that such a time scale modification of one or more decoded transport channels allows to partially compensate to jitter of transport packets, a content of which may represent the one or more transport channels in an encoded form.

In an embodiment, the audio processor is configured to obtain (e.g. using a rendering, wherein, for example, a number of output channels may be different from a number of channels input into an audio encoder) or reconstruct (wherein, for example, a number of output channels may be equal to a number of channels input into an audio encoder) a plurality of output audio channels (which may form the output audio representation) on the basis of the one or more decoded transport channels (which may be the one or more intermediate audio signals) and metadata (wherein the metadata may, for example, be obtained on the basis of the encoded representation, e.g. using a rendering and/or using an upmixing, wherein, for example, the rendering may comprise an upmixing of the transport channels to loudspeaker signals associated with a plurality of loudspeakers, and/or wherein the rendering may comprise a binauralization, in which two headphone signals are generated using an information about a position of a listener (wherein the information about the position of the listener may, for example, be used to determine a head related transfer function which is applied to derive the two headphone signals on the basis of the one or more decoded transport channels).

It has been recognized that obtaining or reconstructing plurality of output audio channels on the basis of the one or more decoded transport channels after the time scale modification (e.g., after the time scale modification is applied to the one or more decoded transport channels) and using metadata provides for a particularly good compromise between an achievable hearing impression and a complexity. As outlined earlier, for example, real time processing can be applied in the “second processing”, i.e., when obtaining or reconstructing a plurality of output audio channels on the basis of the one or more decoded transport channels after the time scaling. Consequently, the output audio representation may be obtained in such a manner that the output audio representation can be adapted to user's requirements in real time or quasi real time, without having a delaying impact of the time scale modification. Thus, the splitting into a decoding, which is performed before the time scale modification, and a rendering or upmixing, which is performed after the time scale modification, is shown to bring along very good results at low complexity.

In an embodiment, the audio processor is configured to apply a same time scale modification to a plurality of decoded transport channels, or even to all decoded transport channels, e.g. in a synchronized manner (e.g. to ensure that lengths of a plurality of resulting time scaled decoded transport channels, which are for example input into a rendering and/or into an upmixing, are equal; e.g. to thereby obtain a plurality of time scale modified decoded transport channels).

It has been found that applying a time scale modification to a plurality of decoded transport channels (or even to all decoded transport channels) in a synchronized manner results in time scale modified intermediate audio signals, namely time scale modified decoded transport channels, which are well-usable in a subsequent upmixing or rendering, or in any other multi-channel audio channel generation. Moreover, the synchronization of the time scale modification of the difference decoded transport channels may allow to avoid audible distortions or at least significant audible distortions in all transport channels, since the specific characteristics of all decoded transport channels may, for example, be taken into account.

In an embodiment, the audio processor is configured to adapt metadata for an obtaining or reconstruction of the output audio channels (wherein the metadata which is adapted may, for example, be associated with the transport channels, and wherein the metadata which is adapted may, for example, be included in the encoded audio representation) in dependence on the time scale modification (e.g. in dependence on time by which the one or more decoded transport channels are shortened or lengthened; e.g. such that the adapted metadata is adapted to a changed duration of the time scale modified decoded transport channels).

By using such an adaptation of the metadata for obtaining the reconstruction of the output audio signals, a good hearing impression can be achieved even though the time scale modification is between the first processing (e.g., the decoding of transport channels) and the second processing. Thus, appropriate metadata can be provided even though a timing relationship between the one or more output signals of the first processing and the one or more input signals of the second processing is varied (e.g., in a manner varying over time) by the time scale modification.

In an embodiment, the audio processor is configured to perform the first processing (e.g. the decoding of encoded transport channels) for (e.g. per) time segments (e.g. of an audio content) of a first length (e.g. frame-wisely; e.g. with a first temporal granularity, wherein, for example, the first temporal granularity is a frame, comprising a plurality of subframes). Moreover, audio processor is configured to perform the second processing for (e.g. per) time segments (e.g. of the audio content) of a second length which is shorter than the first length (e.g. subframe-wisely; e.g. with a second temporal granularity which is finer than the first temporal granularity, wherein, for example, the second temporal granularity is a sub-frame, e.g. comprising a plurality of time slots], or the audio processor is configured to perform the second processing with (e.g. step-wise) temporal increments of a second length, which is smaller than the first length (wherein, for example, portions of the one or more intermediate output signals of the second length are input into the second processing for each execution of the second processing, such that, for example, each execution of the second processing advances a processing of the time-scale-modified intermediate audio signals by a step of the second length (measured on the time scale of the one or more time-scale-modified intermediate audio signals)).

It has been found that using different temporal granularity (e.g., time segments of different lengths) for the first processing and for the second processing allows for a high efficiency of the processing and also brings along good real time characteristics of the decoding (for example by using a relatively short temporal granularity in the second processing). For example, by frame-wisely decoding encoded transport channels in the first processing, a good compromise between bit rate requirements and achievable audio quality is reached. On the other hand, the “post-processing” (e.g., an upmixing or rendering which is performed by the second processing) has been found to be more efficient and to provide a better audio quality when operating on shorter time portions (of the time scale modified intermediate audio signals) than the first processing. For example, by using relatively small portions in the second processing, or by making comparatively small (step-wise) temporal increments in the second processing, signals comprising multiple sources can be handled in an efficient manner while providing a good impression. Thus, it has been recognized that usage of different temporal granularity in different processing steps is a good choice in terms of efficiency and achievable audio quality, wherein the application of the time scaling in between these processing steps using different temporal granularities has been found to be an advantageous concept which does not significantly compromise the results of the processing.

In an embodiment, a granularity of the time scale modification (e.g. one sample) is finer than the second length (e.g. one subframe, comprising a plurality of time slots).

It has been recognized that, in many applications, it is desirable to have a granularity of the time scale modification which is finer than the second length. In particular, it has been recognized that a relatively fine granularity of the time scale modification helps to reduce artifacts caused by the time scale modification, even though such a fine granularity of the time scaling may result in frame lengths of the time scale modified intermediate audio signals which deviates from integer multiples of the second length. However, it has been recognized that it is possible to deal with such lengths of the blocks or frames of the time scale modified intermediate information without introducing significant artifacts.

In an embodiment of the audio processor, the first processing (e.g. the decoding of one or more transport channels) is configured to block-wisely provide time domain samples (e.g. using a block-wise frequency-domain-to-time-domain transform; e.g. using a modified discrete cosine transform), wherein a block of time domain samples provided by the first processing comprises a first number of time domain samples. Furthermore, the second processing (e.g. the upmixing and/or rendering of the one or more transport channels into output audio signals that make up the processed audio signal representation) is configured to operate on blocks of time domain samples which are based on time-scale modified time domain samples that are derived from the time domain samples provided by the first processing using the time scale modification (e.g. by block-wisely transforming blocks of time scale modified time domain samples into a spectral domain), wherein the blocks of time domain samples processed by the second processing comprise a shorter length than the blocks of time domain samples provided by the first processing. Alternatively, the second processing (e.g. the upmixing and/or rendering of the one or more transport channels into output audio signals that make up the processed audio signal representation) is configured to input, per processing step, a block of a plurality of time domain samples which is based on time-scale modified time domain samples that are derived from the time domain samples provided by the first processing using the time scale modification (e.g. by advancing a processing by the block of the plurality of time scale modified time domain samples), wherein the block of a plurality of time domain samples input into the second processing per processing step comprises a shorter length than the blocks of time domain samples provided by the first processing.

It has been found that a processing of comparatively short blocks of time domain samples in the second processing, or an input of a comparatively short block of time domain samples as new time domain samples in the second processing, brings along a comparatively fine temporal resolution in the second processing, which allows the processed (output) audio representation to bring along a good audio quality and which allows for a real time or quasi-real time adjustment of the second processing. On the other hand, high efficiency, e.g., a high bit rate efficiency, of the processing of comparatively large blocks in the first processing can still be exploited. Also, it has been recognized that the usage of different temporal granularities in the first processing and in the second processing can still be used in an advantageous manner even though the time scale modification is in between the first processing and the second processing. Thus, a good compromise between efficiency and achievable audio quality can be achieved, wherein the processors also comprise good real time or quasi real time capabilities.

In an embodiment of the audio processor, blocks of time domain samples processed by the second processing comprise a plurality of time domain samples, wherein, for example, a time resolution of the second processing, e.g. of a time-frequency transform which is performed by the second processing, is smaller than a time resolution of a time domain signal which makes us the intermediate signal (e.g. a time resolution of the decoded transport channel time signal).

However, it has been found that processing, in the second processing, blocks of time domain samples comprising a plurality of time domain samples brings along a good efficiency, and that it is not necessary to use a temporally very fine second processing after the time scaling modification (even if the time scaling modification is adjustable with a single-sample granularity). Thus, a good computational efficiency can be achieved with such a concept, since a block-wise processing is typically more efficient than a single-sample-granularity second processing.

In an embodiment of the audio processor, metadata (e.g. sets of metadata), which are used in the second processing, are associated with sub-frames of the input audio signal representation, and/or are associated with sub-frames of the one or more intermediate audio signals, wherein a subframe comprises on or more time slots (e.g. 4 time slots). The audio processor is configured to provide the one or more time-scale modified intermediate audio signals such that a respective frame of the one or more time scale modified intermediate audio signals comprises a different length (e.g. a different number of audio samples) when compared to a corresponding frame of the input audio signal representation and/or when compared to a corresponding frame of one or more intermediate audio signals.

It has been recognized that, in some cases, the metadata which are associated with subframes of the input audio signal representation and/or which are associated with subframes of the one or more intermediate audio signals can still be used with good results, even though the frames of the one or more time scale modified intermediate audio signals comprise a different length when compared to corresponding frames of the input audio signal representation and/or when compared to corresponding frames of the one or more intermediate signals. It has been found that this is particularly true if a temporal granularity of the metadata is smaller, or even significantly smaller, than temporal variations caused by the time scale modification or temporal misalignments caused by the time scale modification. Just as an example, in some cases, the time scale modification causes a temporal misalignment between subframes processed in the second processing and metadata associated with said subframes processed in the second processing, which is smaller or significantly smaller than a temporal granularity of the metadata, there are typically no significant audible artifacts caused by this. Accordingly, a good impression can be achieved with high efficiency by exploiting the different temporal granularities of the processing steps and of the metadata and by exploiting the listener's tolerance for slight temporal variations of the second processing.

In an embodiment, the audio signal processor is configured to provide the one or more time-scale-modified intermediate audio signals such that a length of a respective frame of the one or more time-scale-modified intermediate audio signals (e.g. between 10 ms and 30 ms, e.g. with a granularity of less than 1 ms; e.g. with a single sample temporal granularity) is different from a multiple of a block size (e.g. 1.25 ms or 5 ms) used in the second processing (at least in case the time scale modification is applied). Alternatively or in addition, the audio processor is configured to perform the second processing with (e.g. step-wise) temporal increments (e.g. with step-wise increments of 1.25 ms, which may correspond to 60 samples at a sampling rate of 48 kHz), wherein the audio signal processor is configured to provide the one or more time-scale-modified intermediate audio signals such that a length of a respective frame of the one or more time-scale-modified intermediate audio signals (e.g. between 10 ms and 30 ms; e.g between 480 samples and 1920 samples at a sampling rate of 48 KHz; e.g. with a temporal granularity of less than 1 ms; e.g. with a single sample temporal granularity) is different from a multiple of the temporal increments (e.g. 1.25 ms or 60 samples at a sampling rate of 48 kHz).

It has been recognized that such a choice of the time scale modification, which allows for a fine adjustment of the time scaling without being bound to a granularity of the second processing provides for a high quality time scaling while still allowing for good quality output signals of the second processing.

In an embodiment, the audio signal processor is configured to form a block of samples for the second processing (e.g. a block of samples associated with a current frame; e.g. a block of samples that is processed in the second processing or a block of samples that is input into the second processing as a temporal increment in a processing step of the second processing) on the basis of one or more time domain samples (e.g. between 1 and 59 samples, if the second processing needs a block of 60 samples for a processing or as a time increment) associated with a previous frame of the one or more time-scale-modified intermediate audio signals and on the basis of one or more time domain samples (e.g. between 1 and 59 samples, if the second processing needs a block of 60 samples for a processing or as a time increment) associated with a current frame of the one or more time-scale-modified intermediate audio signals. The audio signal processor is configured to form one or more blocks of samples (e.g. of 60 samples) for the second processing (e.g. a block of samples associated with a current frame) on the basis of a plurality time domain samples associated with a current frame of the one or more time-scale-modified intermediate audio signals (e.g. until there are not enough time domain samples associated with a current frame of the one or more time-scale-modified intermediate audio signals left to form a block of samples for the second processing). Moreover, the audio signal processor is configured to buffer one or more residual (e.g. excessive) time domain samples (which are not sufficient for the formation of a block of samples for the second processing) (e.g. between 1 and 59 samples if the second processing needs a block of 60 samples for a processing or as a time increment) associated with a current frame of the one or more time-scale-modified intermediate audio signals for a (later) formation of a block of samples (e.g. of 60 samples) for the second processing which includes one or more time domain samples associated with a subsequent frame of the one or more time-scale-modified intermediate audio signals (wherein the buffered one or more residual time domain samples may be prepended to a subsequent frame of the one or more time-scale-modified intermediate audio signals).

Using such a formation of blocks of samples for the second processing, which considers, for the formation of a single block of samples, buffered samples associated with a previous frame and samples associated with a current frame, and which considers, for the formation of one or more further blocks of samples for the second processing, only time domain samples associated with the current frame, and is possible to form blocks of samples for the second processing having uniform length even if the time scale modification changes a frame length to be different from an integer multiple of the length of the blocks of frames used for the second processing. This is also supported by the possibility to buffer one or more time domain samples associated with the current frame, which particularly makes sense if the number of buffered frames is smaller than a number of samples required to form a block of samples for the second processing. Accordingly, the buffered samples of the current frame can be used later on, for example when a sufficient number of time domain samples (or frequency domain samples) associated with the subsequent frame are available. Accordingly, the concept allows for an efficient handling of the second processing, wherein blocks of samples of equal length can easily be provided for the second processing. Also, it has been recognized that the concept does not severely degrade the second processing, even if processing parameters are used in the second processing, since the granularity of processing parameters is often smaller (or even significantly smaller) than the length of blocks of samples used for the second processing. Moreover, difficulties in the second processing, which would be caused by usage of blocks of samples of different length for the second processing, can be avoided. Thus, the concept brings along a high processing efficiency and good results.

In an embodiment, the audio processor is configured to use one or more buffered residual (e.g. excessive) time domain samples associated with a previous frame (e.g. all buffered residual (e.g. excessive) time domain samples associated with a previous frame) and a maximum possible number of time domain samples associated with the current frame of the one or more time-scale-modified intermediate audio signals (such that a number of residual time domain samples associated with the current frame of the one or more time-scale-modified intermediate audio signals is smaller than a block size used in the block-wise second processing) for a formation of blocks of (e.g. 60) samples for the second processing associated with the current frame (wherein the maximum possible number of time domain samples may be chosen such that a remaining number of residual time domain sample is smaller than a size of a block of samples processed by the second processing or input into the second processing per temporal increment).

Using such an approach, a number of samples of the current frame, which are buffered for a later formation of blocks of sample for the second processing can be kept reasonably small. Also, using this approach, a latency can be kept as small as possible while using blocks of equal length in the second processing even in the presence of a fine granular time scale modification, which reduces the processing effort. Moreover, an overlap of blocks of time domain samples used in the second processing can be avoided in this manner.

In an embodiment of the audio processor, a temporal resolution of metadata, which is used in the second processing, is smaller (e.g. coarser) than a time resolution of the second processing.

In such a case, variations of the actual borders of blocks of time domain samples which are used in the second processing (which are, for example, caused by the usage of blocks of constant length even in the case of a time scale modification) do not really degrade an audio quality of an output audio representation provided by the second processing. Furthermore, using such a concept, an effort for the encoding of metadata can be kept reasonably small while the temporal resolution of the second processing can still be comparatively high, which in turn allows for a consideration of one or more processing parameters in real time or quasi-real-time.

In an embodiment of the audio processor, the one or more intermediate audio signals are one or more (decoded) transport channel signals (e.g. TC signals], wherein, for example, the one or more transport channel signals may comprise respective frames, wherein the respective frames of the one or more transport channels signals are, for example, shortened or lengthened by the time scale modification, such that the time-scale-modified intermediate signals comprise respective shortened or lengthened frames (e.g. comprising less or more time domain samples per frame than the original frames).

It has been recognized that the application of the time scale modification on one or more decoded transport channel signals is particularly efficient, since the decoding typically operates on relatively long blocks of samples (e.g., on audio frames), while the time scale modification can achieve a relatively fine time scaling. Furthermore, it has been recognized that the decoded transport channels typically comprise time domain samples, which are often subjected to a further processing which is substantially separate from the decoding of the transport channels. In other words, it has been recognized that the decoded transport channels constitute intermediate signals, wherein the further processing (e.g., the second processing) is performed in a different domain (e.g., in a different transform domain, and/or using a different spectral domain representation) when compared to the transport channel decoding that is performed by the first processing. Accordingly, it has been recognized that the time scale modification can be efficiently interposed between the (core) decoding of the transport channels (which is performed in the first processing or as the first processing) and a subsequent post-processing that is performed in the second processing or as the second processing. It has also been recognized that the “post-processing” of the (original or time-scale-modified) transport channels is often sufficiently independent from the decoding of the transport channels such that variations of the frame size by the time scale modification do not significantly harm said post-processing which is performed in the second processing or as the second processing. Accordingly, good audio quality can be achieved by the described solution.

In an embodiment, the audio processor is configured to perform the time scale modification using a quality control mechanism (such that, for example, an actual time scale value is adjusted in dependence on a desired time scale value and taking into account characteristics of the one or more intermediate audio signals; wherein, for example, correlation between different portions of an intermediate audio signal, or of a processed version thereof, is taken into account to adjust a time scaling).

By using such a time scale modification with a quality control mechanism, artifacts of the time scaling can be significantly reduced since the actual time scaling is typically adjusted (or adapted) to the characteristics (e.g., to a length of a pitch cycle) of the (original) intermediate audio signals. Thus, when using the quality control mechanism, the resulting length of the time scale modified intermediate audio signals is not only determined by a desired time scaling but rather the exact time scaling is chosen so as to achieve reasonably small distortions (or even minimal distortions), for example when performing an overlap-and-add operation in the time scaling. Thus, artifacts can be kept low, typically at the cost that a length (e.g., in terms of time domain samples) of the time scale modified intermediate audio signals (or of frames of the time scale modified intermediate audio signals) cannot be predetermined in a signal-independent manner. This, in turn, has the consequence that the length of the time scale modified intermediate audio signals may not exactly fit the “original” requirements of the second processing but it has been recognized that this does not constitute a severe problem. Thus, the concept creates a good compromise between implementation efficiency and audio quality.

In an embodiment, the audio processor is configured to switch between a quality-controlled time scale modification mode and a non-quality-controlled time scale modification mode in dependence on one or more characteristics of the one or more intermediate audio signals and/or in dependence on a side information.

Using such an approach, a high efficiency can be achieved over a wide range of circumstances.

In an embodiment, the audio processor is configured to operate in (e.g. to selectively switch to) a non-quality controlled time scale modification mode (e.g. to selectively switch to the non-quality controlled time scale modification mode).

When operating in the non-quality controlled time scale modification mode, a length of the time scale modified intermediate audio signals may be (accurately) predetermined by a controller, which allows to achieve a frame alignment or to preset how many subframes (or blocks of time domain samples) should be provided to the second processing for a frame of the (original) intermediate audio signals. Consequently, a precise control can be exercised irrespective of details of the audio signal, which may, for example, be helpful for synchronization of frame boundaries or for synchronization between an audio encoder and an audio decoder. Also, this mechanism may reduce an effort for the adaptation of processing parameters, and therefore reduce the processing complexity in some cases.

In an embodiment, the audio processor is configured to selectively switch to a special (silent frame) time scale modification mode (e.g. to a non-quality-controlled time scale modification mode) for frames classified as silent (e.g. for frames having an energy below a threshold level, or for frames for which there is a silent frame signaling). Furthermore, the audio processor is configured to perform the time scale modification in such a manner that no buffering of residual frames is required (e.g. such that a number of time domain samples of a current time-scale modified frame plus a number of buffered time domain samples of a previous time scale modified frame is an integer multiple of a number of time domain samples of a block of time domain samples processed by the second processing, or such that a number of time domain samples of a current time-scale modified frame plus a number of buffered time domain samples of a previous time scale modified frame is an integer multiple of a number of time domain samples input into the second processing to make a temporal increment), when operating in the special (silent frame) time scale modification mode (wherein the time scale modification is adjusted to provide such a number of time scale modified time domain samples that boundaries of subframes used in the second processing are aligned with frame boundaries of subframes used in the second processing).

By switching to a special time scale modification mode for frames classified as silent, a time alignment can be achieved in an efficient manner without significantly compromising the audio quality. Worded differently, by using a special time scale modification mode, it can be achieved that a frame of the time scale modified intermediate audio signals can be fully processed by the second processing (taking into consideration a processing time grid applied by the second processing) without leaving any time domain values or frequency domain values of this (current) frame unprocessed by the second processing. Thus, the detection of a frame which is classified as silent can be used to efficiently arrive at a situation where it is not necessary to buffer any time domain samples or frequency domain samples of a current frame of the time scale modified intermediate audio signals for a later processing (together with samples of a subsequent frame). Accordingly, a state of low latency can be achieved without audio quality issues. For example, the time scale modification can be adjusted in such a manner that the time scale modification provides a desired number of time scale modified time domain samples without being bound to a quality control mechanism, since an audio quality is not significantly degraded in a silent frame condition.

To conclude, the audio processor exploits the detection of the silent frame condition to efficiently achieve time synchronization between the time scale modified audio signals and the second processing.

In an embodiment, the audio processor is configured to adapt a size of subframes, which are used (e.g. processed) in the second processing or which are input into the second processing (e.g. as a block of new time domain samples) to make a temporal increment, to the time scale modification.

By adapting the size of subframes which are processed in the second processing or which are input in the second processing to make a temporal increment to the time scale modification, a synchronization between the time scale modified intermediate audio signals and the second processing can be achieved. For example, adapting a size of subframes (e.g., in terms of time slots or in terms of time domain samples or in terms of frequency domain samples) to the time scale modification may, for example, avoid the need to buffer any values of the time scale modified intermediate audio signals (for a processing together with a subsequent frame). For example, the size of the subframes which are used in a second processing or which are input into the second processing to make a temporal increment can be adjusted in such a manner that all time slots or all time domain samples or all frequency domain samples of a (shortened or lengthened) frame of the time scale modified intermediate audio signals are associated with the subframes of the second processing, wherein, for example, a last subframe of the second processing ends at the end of the respective frame of the time scale modified intermediate audio signals. Consequently, a buffering or a joint processing of time domain samples or frequency domain samples or slots of a current frame and of a subsequent frame are not needed, which makes the processing resource-efficient and which also keeps a processing effort low.

In an embodiment, the audio processor is configured to adapt a number of time slots (e.g. a number of frequency domain slots or frequency domain samples which form a subframe of the one or more time-scale-modified intermediate audio signals, or a number of time domain slots or time domain samples which form a subframe of the one or more time-scale-modified intermediate audio signals; e.g. a size of subframes) which are processed in the second processing, or which are input into the second processing (e.g. as a block of new frequency domain samples) to make a temporal increment, to the time scale modification.

By adapting the number of time slots or a size of subframes which are processed in the second processing, or which are input into the second processing to make a temporal increment, to the time scale modification, it can be achieved that a current frame is fully processed by the second processing before a subsequent frame is available (or before a time scale modification has been applied to the subsequent frame), even if the time scale modification results in a change of a number of time slots in a frame of the time scale modified intermediate audio signal (e.g., when compared to a number of time slots in a frame of the original intermediate audio signals). Consequently, the above mentioned advantages, like a low latency and an efficient processing, can be achieved.

In an embodiment, the audio processor is configured to perform the time scale modification using one or more overlap-and-add operations overlapping different segments (e.g. frames or subframes or slots) of the one or more (original) intermediate audio signals. Furthermore, the audio processor is configured adapt metadata (e.g. metadata associated with frames or subframes or slots of the (original) intermediate audio signals) where overlap-and-add operations are applied to different segments (e.g. frames or subframes or slots) of the one or more intermediate audio signals, to (thereby) obtain adapted metadata associated with frames or subframes of the one or more time-scale-modified intermediate audio signals.

It has been found that the overlap-and-add of different segments of the one or more intermediate audio signals results in a time scale modified intermediate audio signal which comprises different characteristics when compared to the original intermediate audio signal. However, it has also been recognized that an adaptation of the metadata, which are associated with the (original) intermediate audio signals, in particular for temporal portions that are subject to an overlap-and-add operation, can be used to provide metadata that are well-adapted to the signal characteristics of the portion of the time scale modified intermediate audio signals that are obtained by the overlap-and-add operation. Accordingly, the adaptation of the metadata may help to prevent a degradation of the audio quality for time portions obtained using an overlap-and-add operation. For example, the adaptation of the metadata may correspond to the overlap-and-add operation, e.g., in that metadata of different segments that are overlapped-and-added are linearly combined (e.g., in a manner that is similar to the overlap-and-add combination).

In an embodiment, the audio processor is configured to linearly combine metadata associated with frames or subframes of the one or more (original) intermediate audio signals (e.g. unmodified decoded transport channels) which are involved in an overlap-and-add operation, to (thereby) obtain metadata associated with resulting frames or subframes of one or more the time scale modified intermediate audio signals (e.g. frames resulting from an overlap-and-add operation).

It has been found that linearly combining metadata associated with frames or subframes of one or more intermediate audio signals which are involved in an overlap-and-add operation is well-suited to obtain metadata which fit portions of the time scale modified intermediate audio signals obtained using the overlap-and-add operation. In particular, it has been recognized that the overlap-and-add operation and the linear combination of metadata are similar operations, such that the result is a good fit between adapted (processed) metadata and portions of the time scale modified intermediate audio signals obtained by the overlap-and-add operation.

In an embodiment, the audio processor (e.g. the time scale modification; e.g. a WSOLA-based time scale-modification) is configured to identify (e.g. using a cross correlation) a segment (also designated as “identified segment” or “best match”), out of a plurality of candidate segments which are portions of a given audio frame of an intermediate audio signal, for an overlap-and-add with a predetermined portion (e.g. a start portion; e.g. “seg. a”) of the given audio frame, using a determination of a waveform similarity, in order to obtain a shortened version of the given audio frame (which is, for example, a frame of the time scale modified intermediate audio signal).

By identifying a segment, out of a plurality of candidate segments which are portions of a given audio frame of an intermediate audio signal, for an overlap-and-add with the predetermined portion using a determination of wave form similarity helps to keep audible distortions reasonably small. For example, a segment can be identified which is very similar to the predetermined portion of the given audio frame, and consequently an overlap-and-add operation brings along very small audible distortions. Thus, an actual time scaling can be determined by the characteristics of the audio signal, since a time alignment between the portions that are overlapped and added is obtained by the determination of the waveform similarity, i.e., by the characteristics of the actual audio signals. Thus, the time scale modification is well-adapted to the characteristics of the audio signals, which brings along a good audio quality (but which brings along the challenge that the actual amount of the time scale modification is affected by signal characteristics and cannot be determined arbitrarily by a control). Nevertheless it has been recognized that the concept for the time scale modification is well-suited for the present applications.

In an embodiment, the audio processor is configured to include, at an end of the shortened version of the given audio frame, an unmodified portion of the given audio frame (e.g. rem) which follows the identified segment in an original version of the given audio frame (e.g. such that the shortened version of the given audio frame is a concatenation of an overlap-and-add portion, in which the identified segment is overlap-and-add combined (e.g. overlapped and added) with the predetermined portion, and of a remaining unmodified portion (e.g. “rem”) of the given audio frame).

By including, at an end of the shortened version of the given audio frame, an unmodified portion of the given audio frame, it can be achieved that the time scale modification only affects a portion of the one or more intermediate audio signals which are well-suited for a time scale modification. Thus, the overlap-and-add operation, which constitutes the core of the time scale modification, can be applied to such a portion which is well-suited for the overlap-and-add operation, while other portions of the one or more intermediate audio signals can be left unchanged and can, for example, be appended at the end of a frame (e.g., at the end of a shorted version of a given audio frame). Accordingly, the time scale modification can be done with good audio quality and with a reasonable computational effort.

In an embodiment, the audio processor (e.g. the time scale modification; e.g. a WSOLA-based time scale-modification) is configured to identify (e.g. using a cross correlation) a segment (also designated as “identified segment” or “best match”), out of a plurality of candidate segments which are portions (e.g. designated as “candidate”) comprising values of a previous audio frame of an intermediate audio signal preceding a given audio frame (and possibly values of the given, current audio frame of the intermediate audio signal), for an overlap-and-add with a predetermined portion (e.g. a start portion; e.g. “seg. a”) of the given audio frame, using a determination of a waveform similarity, in order to obtain a lengthened version of the given audio frame.

By identifying a segment comprising values of a previous audio frame of an intermediate audio signal preceding a given audio frame for an overlap-and-add with a predetermined portion of the given audio frame, a lengthening of the given audio frame can be achieved. For example, a well-suited portion of the audio frame preceding the given audio frame can be “re-used” in order to achieve a lengthened audio frame, wherein a good hearing impression can is achieved by appropriately choosing the “identified segment” taking into account the similarity between the predetermined portion of the given audio frame and the candidate segments (from which the “identified segment” is selected). Thus, a smooth transition between the predetermined portion of the given audio frame and an audio portion which starts in the preceding audio frame (preceding the given audio frame) and which typically ends at the end of the given audio frame, can be achieved. Accordingly, a total length of the lengthened version of the given audio frame is longer than a length of the given audio frame, since time domain samples or frequency domain samples of the preceding audio frame are also included (by means of the overlap-and-add operation) into the given audio frame. To conclude, a lengthening time scale modification can be achieved in an efficient manner using this concept, where a good audio quality can be obtained with reasonable computational complexity.

In an embodiment, the audio processor is configured to include, at an end of the lengthened version of the given audio frame, an unmodified portion comprising values of the given audio frame (and optionally also values of the previous audio frame) (e.g. “rem”) which follows the identified segment (e.g. designated as “best match”), for example, such that the lengthened version of the given audio frame is a concatenation of an overlap-add-portion, in which the identified segment is overlap-and add combined (e.g. overlapped and added) with the predetermined portion (e.g. with an original segment of the given frame), and of a remaining unmodified portion which is based on a portion which follows the identified segment in an original version of the given audio frame and possibly of the previous audio frame.

By including, at the end of the lengthened version of the audio frame, an unmodified portion comprising values of the given audio frame which follows the identified segment (to which the overlap-and-add is applied), a good hearing impression can be achieved. In particular, it can be achieved that the length of the end portion of an audio frame remains substantially unmodified, wherein the time scale modification is effectively performed at the beginning of the given frame (e.g. using the overlap-and-add operation). However, it has been recognized that such a concept is computationally efficient and brings along a good hearing impression since the overlap-and-add operation is not applied to the whole frame but only to a part of the frame that is recognized to be well-suited for the overlap-and-add operation. Accordingly, the overlap-and-add operation, and also the lengthening time scale modification, can be applied efficiently, even if the one or more intermediate audio signals are not stationary over the full length of an audio frame.

In an embodiment, the audio processor is configured to time-interpolate between one or more processing parameters (e.g. entries of a mixing matrix Mprev or Mk,prev; e.g. metadata values or processing values derived from the metadata values; e.g. entries of a mixing matrix) associated with a previous frame of the one or more intermediate audio signals and one or more processing parameters (e.g. entries of a mixing matrix M or Mk) associated with a current frame of the one or more intermediate audio signals, in order to (e.g thereby) obtain processing parameters associated with different time instances (e.g. designated with time indices n) of a current frame of the one or more time-scale modified intermediate audio signals using an interpolation function (e.g. g [n] or ga [n]) which determines contributions of the one or more processing parameters associated with the previous frame and contributions of one or more processing parameters associated with the current frame in a linear combination of processing parameters.

It has been found that by time-interpolating between one or more processing parameters associated with a previous frame and one or more processing parameters associated with a current frame, the processing parameters can be adapted to the time scaling, to thereby avoid audible distortions. It has also been recognized that the usage of an interpolation function (which may, for example, define an interpolation which deviates from a purely linear interpolation) allows to adapt the interpolation to the actual time scaling, which brings along particularly good results. In particular, usage of such an interpolation function is advantageous in the case that the time scale modification is not performed linearly over a full frame (which is an advantageous situation, as outlined above).

To conclude, it has been recognized that time-interpolating between one or more processing parameters or between one or more sets of processing parameters using an interpolation function brings along good results in terms of audio quality and efficiency.

In an embodiment of the audio processor, the interpolation function is a linear or piecewise linear function mapping a time index (e.g. a sample index; e.g. n) onto a weighting value (e.g. g[n] or ga[n]) that determines contributions of a processing parameter associated with a previous frame and of a processing parameter associated with a current frame to a time-interpolated processing parameter.

By choosing such an interpolation function, which is advantageously a linear or piece-wise linear function, the interpolation of the one or more processing parameters can be performed in an efficient manner, wherein the described shape of the interpolation is well in agreement with the functionality of the time scale modification.

In an embodiment of the audio processor, for a temporally shortened (e.g. current) audio frame, the interpolation function comprises a larger slope (e.g. variation of the value of the interpolation function with the time index) for a portion (e.g. L_{seg}) of the time scale modified current frame which has been obtained using an overlap-add-combination than for a portion (e.g. Lᵣₑₘ) of the time scale modified current frame which is unmodified (e.g. with respect to the (e.g. original) intermediate audio signal; e.g. a “remaining part”). Alternatively or in addition, for a temporally lengthened (e.g. current) audio frame, the interpolation function comprises a smaller slope (e.g. variation of the value of the interpolation function with the time index) for a portion (e.g. L_{seg}) of the time scale modified current frame which has been obtained using an overlap-add-combination than for a portion (e.g. Lᵣₑₘ) of the time scale modified current frame which is unmodified (e.g. with respect to the (e.g. original) intermediate audio signal; e.g. a “remaining part”].

It has been found that such a choice of the interpolation function is, for example, well suited for usage with time scale modification concepts in which a time scaling occurs primarily in a start portion of a given frame, while an end portion of the given frame remains substantially unchanged.

Thus, in the case of a shortening time scale modification, the choice of the interpolation function is, for example, made such that the interpolation function comprises a (comparatively) larger slope in a portion of an audio frame where an actual time compression (shortening) occurs, and comprises a (comparatively) smaller (e.g. “normal”) slope in a portion of an audio frame where no time compression occurs. Accordingly, the interpolation proceeds comparatively fast (e.g., faster than “normal”) in a portion of the frame where the actual shortening occurs, and the interpolation of the parameters proceeds comparatively slow in a portion of the frame where no time compression (shortening) occurs.

In the case of a lengthening time scale modification, the choice of the interpolation function may, for example, be made such that the interpolation function comprises a (comparatively) smaller slope in a portion of an audio frame where an actual time extension (lengthening) occurs, and comprises a (comparatively) larger (e.g. “normal”) slope in a portion of an audio frame where no time extension occurs. Accordingly, the interpolation proceeds comparatively slowly (e.g., slower than “normal”; e.g., slower than if the temporal interpolation is performed over the full frame) in a portion of the frame where the actual lengthening occurs, and the interpolation of the parameters proceeds comparatively faster in a portion of the frame where no time extension (lengthening) occurs.

It has been found that such an interpolation of the processing parameters is well adapted to the time scale modification and results in interpolated processing parameters that are well-adapted to the time scale modified intermediate audio signals.

In an embodiment, the audio processor is configured to obtain interpolated processing parameters Pᵢₙₜₑᵣ[n] associated with time instances having time index n according to

$${P}_{inter} [ n ] = {g}_{a , f} [ n ] P + ( 1 - {g}_{a , f} ) {P}_{prev} ,$$

wherein P is a processing parameter or a set of processing parameters (e.g. a scalar parameter, or a parameter vector or a parameter matrix) associated with a current frame of the one or more intermediate audio signals, wherein Pₚᵣₑᵥ is a processing parameter or a set of processing parameters (e.g. a scalar parameter, or a parameter vector or a parameter matrix) associated with a previous frame of the one or more intermediate audio signals, wherein Pᵢₙₜₑᵣ is a processing parameter or a set of processing parameters (e.g. a scalar parameter, or a parameter vector or a parameter matrix) associated with a time instance n in a current frame of the one or more time scale modified intermediate audio signals, and wherein ga,f is an interpolation function.

It has been found that such a determination of the interpolated processing parameters, which effectively constitutes a linear combination that is controlled by a single scaler interpolation function, and which can also be considered as an (interpolation-function-controlled) panning between different processing parameters or sets of processing parameters, is computationally efficient and brings along good results.

In an embodiment of the audio processor, the interpolation function g_{a,f} is defined as

$${g}_{a , f} [ n ] = max ( 0 , {g}_{a} [ n ] ) ,$$

$$and$$

$$wherein$$

$${g}_{a} [ n ] = \{ \begin{matrix}\frac{n + 1 + ( {L}_{seg} - {L}_{rem} )}{2 {L}_{seg}} , & {L}_{Seg} \leq n < {L}_{f} \\ ( n + 1 ) \frac{2 {L}_{seg} + 1 - {L}_{rem}}{2 {L}_{seg} ( {L}_{seg} + 1 )} , & 0 \leq n < {L}_{seg}\end{matrix}$$

wherein n is a time index, wherein Lᵣₑₘ=L_{f}−L_{seg}, wherein L_{f} is a length of a frame to be processed (e.g. a length of a current frame of the one or more time scale modified intermediate audio signals; e.g. a length which is different from a length of an original frame of the one or more original intermediate audio signals), and wherein L_{seg} is length of a portion in which an overlap-and-add is applied by the time scale modification.

It has been recognized that such a choice of the interpolation function, which brings along different slopes of the interpolation functions in a beginning portion of an audio frame and in an end portion of the audio frame is well-adapted to a time scale modification in which an end portion of a frame is left substantially unmodified, while a time compressing or a time extending overlap-and-add operation is performed in a start portion of a given audio frame. It has been recognized that the piece-wise linear interpolation function having two pieces of different interpolation slopes is well-adapted to an advantageous implementation of the time scale modification and can be implemented with a reasonable effort. Moreover, the interpolation function can be adapted to the actual length of a frame of the time scale modified intermediate audio signals, wherein it should be noted that the length of the frames of the time scale modified intermediate audio signals is typically variable and signal dependent. Thus, it has been found that such a choice of the interpolation function is particularly advantageous.

In an embodiment, the audio processor is configured to perform a processing (e.g. a time domain processing) of values of the one or more time-scale-modified intermediate audio signals (e.g. x[n] or xk[n]) according to

$$y [ n ] = ( {g}_{a , f} [ n ] M + ( 1 - {g}_{a , f} [ n ] ) {M}_{prev} ) x [ n ] , 0 \leq n < {L}_{f}$$

or according to

$${y}_{k} [ n ] = ( {g}_{a , f} [ n ] {M}_{k} + ( 1 - {g}_{a , f} [ n ] ) {M}_{k , prev} ) {x}_{k} [ n ] , 0 \leq n < {L}_{f} ,$$

wherein x[n] and xk[n] are of values or sets of value of the one or more time-scale-modified intermediate audio signals (e.g. time domain values or spectral domain values), wherein M is a processing parameter or a set of processing parameters (e.g. a scalar parameter, or a parameter vector or a parameter matrix) associated with a current frame of the one or more intermediate audio signals, wherein Mprev is a processing parameter or a set of processing parameters (e.g. a scalar parameter, or a parameter vector or a parameter matrix) associated with a previous frame of the one or more intermediate audio signals, wherein n is a time index, wherein L_{f} is a length of a frame to be processed (e.g. a length of a current frame of the one or more time scale modified intermediate audio signals; e.g. a length which is different from a length of an original frame of the one or more original intermediate audio signals), and wherein g_{a,f} is an interpolation function.

It has been recognized that such a processing of values of the one or more time scale modified audio signals, to derive one or more output signals y [n] or yₖ[n] brings along particularly good processing results. In particular, the effects of the time scale modification can be efficiently taken into account by such a processing, wherein, for example, the time scaling function mentioned above can be applied efficiently. For example, the interpolation between the processing parameters (or sets of processing parameters, or matrices of processing parameters) associated with the previous frame and with the current frame can be done with a very high temporal resolution, i.e., per processing step, wherein a processing step may be a matrix-vector modification between a vector of time scale modified intermediate audio signals x or xₖ and a processing matrix (e.g., a mixing matrix or a rendering matrix) obtained by the parameter interpolation.

It has been found that such a concept can be efficiently used for different processing operations, like an upmixing, a rendering or the like which uses some processing parameters that are, for example, associated with frames or subframes of the original intermediate audio signals.

To conclude, it has been recognized that this concept is efficient and allows for a provision of high quality output audio signals even in the presence of a time scale modification.

In an embodiment, the audio processor is configured to perform the second processing (e.g. a rendering or an upmixing of the time scale modified intermediate audio signals) using processing parameters (e.g. sets of metadata) associated (e.g. individually associated) with subframes of an audio frame (e.g. such that there are several sets of metadata per frame; e.g. such that there is a set of metadata per subframe), wherein, for example, a rendering rule or a rendering matrix or a mixing rule or a mixing matrix is derived from the processing parameters, or wherein, for example, the processing parameters define a rendering rule or a rendering matrix or a mixing rule or a mixing matrix.

By using processing parameters associated with subframes of an audio frame in the second processing, a high temporal resolution can be achieved. For example, there may be one processing parameter per subframe or there may be one set of processing parameters per subframe. Thus, the second processing can react to changes of the audio content rapidly, at a subframe temporal resolution.

Accordingly, a good reproduction or rendering of an audio content can be achieved by the second processing.

In an embodiment, the audio processor is configured to obtain a processing rule for the second processing using processing parameters associated with a given subframe (e.g. of the one or more time scale modified intermediate audio signals), and optionally using signal characteristics of the one or more time scale modified intermediate audio signals in the given subframe (e.g. using a combined energy of the one or more time scale modified intermediate audio signals).

By obtaining a processing rule for the second processing using processing parameters associated with a given subframe, a fine temporal granularity can be achieved, which brings along a good quality reproduction or rendering of an audio content. Moreover, by taking into account signal characteristics of the one or more time scale modified intermediate audio signals in the given subframe when determining the processing rule, signal characteristics can be considered in the determination of the processing rule, such that an amount of metadata (or side information) can be kept reasonably small. For example, a combined energy of the one or more time scale modified intermediate audio signals may be used to adjust the processing rule for the second processing, which typically results in a processing that is well-adapted to the actual signal characteristics without requiring a high bit rate.

In an embodiment, the audio processor is configured to determine a mapping vector defining an association between time slots (e.g. of the one or more time scale modified intermediate audio signals) and subframe indices (e.g. of subframes of the one or more original intermediate audio signals) in dependence on the time scale modification, for example, such that the mapping describes which processing parameters are allocated with (or best fit to) which time slot of the time scale modified intermediate audio signals.

It has been found that such a concept, in which an association between time slots and subframe indices is determined in the dependence on a time scale modification, is helpful to determine processing parameters with good temporal resolution. For example, it can be determined on which subframe of the original intermediate audio signals a certain slot of the time scale modified intermediate audio signals is based (or mainly based), and this association can be reflected in the mapping vector. Thus, each slot of the time scale modified intermediate audio signals may be associated with one subframe of the original intermediate audio signals in the mapping vector, and this association may be used for the determination of processing parameters (or metadata) for frames or subframes of the time scale modified intermediate audio signals. In this respect, it should be noted that an association of time slots to subframes may be different for the time scale modified intermediate audio signals when compared to the original intermediate audio signals. However, by having one (original) subframe (and consequently a certain metadata) associated with each time slot of the scale modified intermediate audio signal, a determination of processing parameters (or of metadata) associated with a subframe of the time scale modified intermediate audio signals is easily possible.

In an embodiment, the audio processor is configured to determine the mapping vector according to

$${m}_{sf} [ n ] = modulo ( {n}_{offset} + max ( 0 , \frac{⌊ ( 2 {L}_{seg} - 1 ) {g}_{a , map} [ n ] ⌉}{{L}_{sf}} ) , {L}_{md} )$$

or according to

$${m}_{sf} [ n ] = max ( 0 , \frac{⌊ ( 2 {L}_{seg} - 1 ) {g}_{a , map} [ n ] ⌉}{{L}_{sf}} )$$

wherein m_{sf}[n] is an element of the mapping vector,
wherein n is a time slot index;
wherein n_{offset} is an offset value;
wherein L_{seg} is a half of a length of a frame of the one or more original intermediate audio signals in time slots;
wherein 2L_{seg} is a length of a frame of the one or more original intermediate audio signals in time slots;
wherein Lsf is a length of a subframe in time slots;
wherein L_{md} is a length of a metadata buffer;
wherein n_{offset} is; and
wherein g_{a,map}[n] is an interpolation function;
wherein └ ┐ denotes a rounding to a nearest integer;
wherein modulo is a modulo operation; and
wherein a division is an integer division.

It has been found that such a determination of the mapping vector is particularly efficient. In particular, the time scale modification can be taken into account by considering the interpolation function gₐ. However, it has been recognized that such a mapping vector is well-suited for the derivation of processing parameters (or metadata) associated with time slots or subframes of the time scale modified intermediate audio signal.

In an embodiment,

$${g}_{a , map} [ n ] = \{ \begin{matrix}\frac{n + ( {L}_{seg} - {L}_{rem} )}{2 {L}_{seg} - 1} , {L}_{Seg} \leq n < {L}_{f} \\ n \frac{2 {L}_{Seg} - {L}_{rem}}{{L}_{seg} ( 2 {L}_{seg} - 1 )} , 0 \leq n < {L}_{seg}\end{matrix}$$

wherein L_{f} is a length of a frame to be processed in time slots; and
wherein Lᵣₑₘ=L_{f}−L_{seg}.

In an embodiment, the audio processor is configured to determine a mapping vector defining an association between time slots of the one or more time scale modified intermediate audio signals and time slots of the one or more original intermediate audio signals in dependence on the time scale modification (wherein, for example, a buffer stores metadata, e.g. transmitted metadata, in a slot-wise manner (even if the metadata are provided per subframe, wherein a subframe comprises a plurality of slots)).

In an embodiment, the audio processor is configured to determine the mapping vector according to

$${m}_{ts} [ n ] = max ( 0 , ⌊ ( 2 {L}_{seg} - 1 ) {g}_{a , map} [ n ] ⌉ )$$

wherein n is a time slot index,
wherein 2Lseg is a length of a frame of the one or more original intermediate audio signals in time slots; and
wherein g_{a,map}[n] is an interpolation function (e.g. as described above).

In an embodiment, the audio processor is configured to determine a mapping vector defining an association between time slots of the one or more time scale modified intermediate audio signals and time slots of one or more original intermediate audio signals in dependence on the time scale modification, for example, such that the mapping vector describes which processing parameters are allocated with (or best fit to) which time slot of the time scale modified intermediate audio signals, (e.g. in case that processing parameters are available on a per-time-slot basis, e.g. in the input audio representation (e.g. in an encoded form) or as a result of an analysis performed in the first processing).

By defining such an association between time slots of the one or more time scale modified intermediate audio signals and time slots of the one or more original intermediate audio signals, a particularly high temporal resolution can be achieved. For example, the temporal resolution may be significantly finer than a subframe (wherein, for example, a subframe may comprise a plurality of time slots). Accordingly, by using the mapping vector which indicates which processing parameters (like metadata) are available (or should be used) with a very high temporal resolution, e.g., on a per-time slot-basis, an efficient and accurate determination of processing parameters on the time scale of the time scale modified intermediate audio signals can be achieved. For example, the mapping vector may define, e.g., for each time slot of the time scale modified intermediate audio signals, to which time slot of the original intermediate audio signals, the time slot of the time scale modified intermediate audio signals is most closely associated. Thus, the mapping vector can be efficiently derived on the basis of a knowledge of the time scale modification. Consequently, the mapping vector may determine which processing parameters (e.g., metadata) (which are typically defined in an association with time slots of the original intermediate audio signals) best fit the different time slots of the time scale modified intermediate audio signals. Thus, the mapping vector defining the association between time slots of the one or more time scale modified intermediate audio signals and time slots of the one or more original intermediate audio signals is well-usable in a derivation of processing parameters for the second processing.

In an embodiment, the audio processor is configured to determine processing parameters associated with a given subframe of the one or more time scale modified intermediate audio signals using processing parameters (e.g. metadata) associated (e.g. in accordance with the mapping vector, which may be a metadata mapping vector) with time slots making up the given subframe of the one or more time scale modified intermediate audio signals (e.g. using an averaging of processing parameters associated with time slots making up the given subframe). The audio processor may, for example, be configured to obtain metadata associated with the given subframe using an averaging of metadata associated with time slots making up the given subframe, or the audio processor may be configured to obtain rendering rules or upmixing rules or intermediate parameters per slot using processing parameters associated with respective slots (e.g. using metadata for the slot) (and optionally also using signal characteristics of the one or more original intermediate audio signals or of the one or more time scale modified intermediate audio signals; e.g. using transport channel signal characteristics), and to obtain a rendering rule or an upmixing rule or intermediate parameters associated with a subframe using an averaging of the rendering rules or upmixing rules or intermediate parameters associated with the slots making up the subframe.

It has been found that, in the presence of high temporal resolution metadata or high temporal resolution processing parameters, the determination of processing parameters (or metadata) associated with a given subframe of the one or more time scale modified intermediate audio signals can be performed, in a reliable manner, taking into account processing parameters (or metadata) associated with time slots making up the given subframe. It has been found that, in some situations, it is possible to associate the time slots of the time scale modified intermediate audio signals with corresponding time slots of the original intermediate audio signals. Accordingly, it is often possible to determine processing parameters (e.g., metadata) associated with the time slots of the time scale modified intermediate audio signals. Consequently, it is also efficiently possible to determine processing parameters (e.g., metadata) associated with a subframe of the time scale modified intermediate audio signals on the basis of processing parameters (e.g., metadata) associated with those time slots (of the time scale modified intermediate audio signals) which make up the subframe (of the time scale modified intermediate audio signals). Thus, even though it is typically not possible to have a clear association between a subframe of the time scale modified intermediate audio signals and a subframe of the original intermediate audio signals (because of the time scale modification), a temporal granularity of the time slots may be fine enough to make such an allocation in a meaningful manner. Accordingly, using processing parameters associated with time slots as an intermediate quantity for determining processing parameters associated with a subframe brings along reliable results in an efficient manner.

In an embodiment, the audio processor is configured to adapt an interpolation (e.g. of processing parameters, like parameters defining a mixing rule) between slots of a subframe to a size of a subframe obtained by the time scale modification (e.g. in case a size in time slots of a subframe is changed as a result of the time scale modification).

By adapting the interpolation between time slots of a subframe to the size of the subframe obtained by the time scale modification, it is possible to efficiently handle situations in which the size of the subframes varies in dependence on the time scale modification. Thus, processing parameters (e.g., metadata) associated with a subframe can be obtained in a reliable and efficient manner in dependence on the actual size of the subframe (e.g., measured in terms of time slots).

In an embodiment, the audio processor is configured to modify (e.g. shift) a subframe grid of subframes of the one or more time scale modified intermediate audio signals in dependence on a time scale modification of a current frame (and optionally also in dependence on time scale modifications of one or more previous frames), wherein, for example, lengths of subframes of the one or more time scale modified intermediate audio signals may be left unchanged.

By shifting a subframe grid of subframes of the one or more time scale modified intermediate audio signals in dependence on the time scale modification, it is possible to have subframes of equal lengths, e.g., in terms of a number of time slots, even though there is a time scale modification. For example, the subframe grid may be varied such that an allocation of time slots to subframes is changed. However, the subframe grid may even change with a resolution that is finer than a length of a time slot. Consequently, time domain values or frequency domain values of the time scale modified intermediate audio signals may be used efficiently and a subframe-based operation of the second processing may remain unchanged even in the presence of a time scale modification. For example, an overlap of subframes may be avoided and the subframe grid may possibly be adjusted in such a manner that a buffering effort is kept small or that a buffering could even be avoided. Thus, the modification of the subframe grid has shown to be an efficient solution for the further processing of the time scale modified intermediate audio signals.

In an embodiment of the audio processor, the first processing is an audio decoding (wherein, for example, the audio processor comprises an audio decoder to perform the first processing).

It has been recognized that it is advantageous to perform the time scale modification only after an audio decoding since it is often not possible to perform a time scale modification with a reasonably fine temporal granularity before the audio decoding since the audio decoding typically operates on comparatively large data blocks to have a reasonable coding efficiency. However, it has been recognized that an implementation of the time scale modification between an audio decoding and a subsequent further processing (second processing) is typically a very efficient solution, since the further processing typically increases the amount of audio information and therefore makes a time scale modification after the second processing more challenging.

To conclude, it has been found that a usage of the time scale modification after a first processing which is a decoding constitutes an efficient solution, in particular if there is a further processing (second processing) that follows the decoding and that is performed on the basis of the time scale modified intermediate audio signals.

In an embodiment of the audio processor, the first processing comprises at least one out of a decoding, a rendering, a reconstruction, and an encoding, and/or the second processing comprises at least one out of a decoding, a rendering, a reconstruction, and an encoding.

It has been recognized that the introduction of the time scale modification between such processing functionalities is efficient and can result in a good audio quality, wherein it should be noted that an adaption of processing parameters, which may be required in the second processing following the time scale modification, can typically be performed with moderate effort. Furthermore, it should be noted that the “second” processing may, for example, comprise a plurality of combined or separate processing steps. In other words, it has been recognized that, in many cases, it is sufficient to have the time scale modification in the middle of a multi-step processing chain which can comprise two or more processing functionalities.

In an embodiment, the audio processor is configured to receive the input audio signal representation from an input buffer (wherein the input buffer may or may not be part of the audio processor).

It has been recognized that the usage of an input buffer, which may be arranged in a processing order before the first processing, is helpful to deal with jitter (e.g., packet jitter of packets including a representation of the input audio signals). For example, such a jitter buffer may be helpful to compensate large packet delays in a comparatively fast manner. However, the presence of the time scale modification in the audio processor may allow to keep the size of the input buffer reasonably small since the time scale modification can adapt to relatively large time jitter provided that the large time jitter occurs on a reasonably long time scale. Accordingly, it should be noted that the combination of an input buffer (which may be a jitter buffer) and which may, for example, store a plurality of packets comprising an encoded representation of the input audio signals, and of a time scale modification allows to deal with short term jitter and also with long term jitter. To conclude, it has been found that the structure to have an input buffer, a first processing and a time scale modification following the first processing, as well as a second processing that is performed after the time scale modification, is advantageous in many situations.

In an embodiment, the audio processor is configured to receive the input audio signal representation from a jitter buffer (wherein the jitter buffer may or may not be part of the audio processor), and the audio processor comprises a time scaling control to adjust the time scale modification. The time scaling control is a jitter buffer control (which may, for example, adjust the time scale modification in dependence on fullness of the jitter buffer and/or in dependence on characteristics of a packet jitter of packets comprising the input audio representation, and/or in dependence on a user setting).

As outlined above, it has been found that usage of a jitter buffer is advantageous since it can be helpful to compensate packet jitter. Moreover, it has been recognized that usage of a time scaling control, which is a jitter buffer control, is particularly advantageous since this allows to adapt the time scale modification to a fullness of the jitter buffer or to a change of the fullness of the jitter buffer. Accordingly, the time scale modification can be used, under the control of the time scaling control, to avoid an underrun or an overrun of the jitter buffer. It has further been recognized that the placement of the time scale modification after the first processing (which may, for example, be a decoding of an encoded audio representation that is stored, e.g., in a packetized form, in the jitter buffer) constitutes a computationally efficient solution which provides a good audio quality.

In an embodiment of the audio processor, the first processing comprises a decoding of encoded transport channels (wherein, for example, the audio processor comprises a decoder, and wherein, for example, an encoded representation of the one or more transport channels may make up the input audio representation, and wherein, for example, a decoded representation of the one or more transport channels may make up the (original) intermediate audio signals). Moreover, the second processing comprises a rendering (e.g. a renderer) configured to reconstruct an encoded or intermediate audio format on the basis of time scale modified transport channels and associated metadata and to render the encoded or intermediate audio format to an output format (wherein the time scale modified transport channels may be the time scale modified intermediate audio signals).

This concept is based on the finding that decoded transport channels are typically well-suited for the application of the time scale modification, since decoded transport channels are typically represented with a sufficiently fine temporal granularity, e.g., in the form of time domain samples or in the form of frequency domain samples, such that a time scale modification is efficiently possible. Moreover, the decoded transport channels typically comprise a comparatively small data volume, since decoded transport channels often constitute a basis for an upmixing/rendering in which a number of audio signals is increased, and since the decoded transport channels also sometimes constitute the basis for a bandwidth extension that increases the amount of data. Thus, it has been recognized that it is more advantageous to apply the time scale modification to the decoded transport channels than to output signals that are derived from the decoded transport channels in the second processing.

In an embodiment of the audio processor, the rendering (e.g. a renderer) is configured to reconstruct the encoded audio format or the intermediate audio format and to render the encoded audio format or the intermediate audio format to the output format in two consecutive (e.g. separate) processing steps.

It has been found that such a multi-step procedure is computationally efficient, since the reconstruction of the encoded audio format or of the intermediate audio format and the rendering of the encoded audio format or of the intermediate audio format to the output format can be executed as separate processing steps, e.g., using separate processing parameters. Such a processing may, for example, allow for an easy implementation of systems in which different types of output format can be handled.

In an embodiment of the audio processor, the functionalities of the audio processor are distributed to two or more devices, with an interface in between.

Such an implementation may, for example, be advantageous if a main processing functionality is performed in a device having a higher computational power, while some processing functionality is performed by a device having a lower computational power. For example, the interface can be inserted at a point of a processing chain where the amount of data to be transmitted is transferable across the interface while a processing effort at a device having a lower processing power is kept reasonably small. For example, in some embodiments it may be advantageous to forward the time scale modified intermediate audio signals to another device via an interface, since the time scale modified intermediate audio signals typically have a comparatively low data rate (e.g., when compared to the output audio signals) while the computationally challenging decoding and the time scale modification may be performed in a powerful device having a large processing capability.

Thus, the concept to distribute the functionalities of the audio processor to two or more devices can be advantageous in many situations.

In an embodiment, the audio processor comprises an interface configured to provide the time scale modified intermediate audio signals (e.g. time scale modified decoded transport channels) and associated metadata (e.g. metadata associated with the time scale modified decoded transport channels, which may be adapted to the time scale modification or in dependence on the time scale modification) for a subsequent rendering.

It has been recognized that the time scale modified intermediate audio signals and the associated metadata can be efficiently transmitted over an interface (e.g., between different and possibly spatially separate devices). Thus, it is possible to distribute the functionalities in an advantageous manner making best use of the respective processing power and interface capabilities.

In an embodiment of the audio processor, the second processing is a rendering, wherein the rendering (e.g. a renderer) is configured to process a reconstruction of an encoded audio format and/or of an intermediate audio format and a rendering of the reconstructed encoded audio format and/or of the intermediate audio format in a combined processing step.

It has been found that, in some cases, it may be advantageous to process a reconstruction of the encoded audio format and/or of an intermediate audio format and a rendering of the reconstructed encoded format and/or of the intermediate audio format in a combined processing step. For example, it has been recognized that a single matrix mixing operation may be used to perform the processing, which may, for example, reduce the complexity and eliminate the need to store (or buffer) intermediate signals. Thus, the concept described here is efficient in some processing scenarios.

In an embodiment of the audio processor, the one or more intermediate audio signals are time domain signals, and the audio processor is configured to perform the time scale modification on the time domain intermediate audio signals (e.g. in a time domain).

It has been recognized that time domain signals are efficient in many cases. For example, it has been recognized that the time scale modification can be efficiently performed on the basis of time domain signals, since a correlation, which is helpful for a high quality time scale modification, can easily be performed in the time domain. Furthermore, it has also been recognized that time domain signals are well-suited for a transition between different transform domains (e.g., different spectral domains or frequency domains). Thus, it has been found that the usage of one or more time domain signals as one or more intermediate audio signals is an advantageous solution.

In an embodiment, the audio processor (e.g. a time scaler of the audio processor) is configured to synchronize a time scaling operation over a plurality of intermediate audio signals (e.g. using a multi-channel time scaling which gives a same number of time domain samples for each time-scale-modified intermediate audio signal).

It has been recognized that a synchronization of the time scaling operation of a plurality of intermediate audio signals helps to reduce audible artefacts in the case of multiple intermediate audio signals. For example, the synchronization of the time scaling operation over a plurality of intermediate audio signals may perform multiple correlations to determine an appropriate common time shift which allows for a good quality overlap-and-add operation for all intermediate audio signals. Accordingly, audible artefacts can be reduced down to a tolerable level.

In an embodiment, the audio processor is configured to modify a transient position information in dependence on the time scale modification.

In an embodiment, the audio processor is configured to obtain an adapted transient position according to

$${n}_{T , a} = max ( 0 , {n}_{T} + ( {L}_{f} - 2 {L}_{seg} ) )$$

wherein n_{T} is an original transient position value,
wherein L_{f} is a length of a frame of the one or more time scale modified intermediate audio signals; and
wherein 2L_{seg} is a length of a frame of the one or more original intermediate audio signals.

It should be noted that n_{T}, Lf and Lsg should advantageously be expressed with the same time resolution, e.g. with the time resolution of the transient position value (e.g. with a time resolution of one sample, or with a time resolution of a given number of samples, or with a time resolution of one time slot, or with a time resolution of one subframe, or with a time resolution of two time slots).

An embodiment according to the invention creates an audio processing system (e.g. an audio decoder) for providing a processed (e.g. decoded and rendered) audio signal representation (e.g. in the form of a plurality of rendered time domain audio signals) on the basis of an input audio signal representation (e.g. an encoded representation of a multi-channel audio content). The audio processing system is configured to perform a plurality of processing steps (e.g. separate processing functionalities; e.g. a first processing and a second processing), in order to provide the processed audio signal representation on the basis of the input audio signal representation. The audio processing system is configured to perform a time scale modification (e.g. a modification of a length of an audio signal portion, e.g. an audio frame, provided by the first processing) on one or more intermediate audio signals, which are provided by a first processing (e.g. a first processing step), in order to obtain one or more time-scale-modified intermediate audio signals. Moreover, the audio processing system is configured to perform a second processing (e.g. a second processing step; e.g. an upmix and/or a rendering), which follows the first processing (e.g. the first processing step), on the basis of the one or more time-scale-modified intermediate audio signals or on the basis of signals derived from the one or more time scale modified intermediate audio signals. Functionalities of the audio processing system are distributed to two or more devices.

It should be noted that this audio processing system is based on the same configurations like the above mentioned audio processor. However, it should be noted that the different functionalities of the audio processing system can be distributed to different physical entities, e.g., to physically separate devices. However, it has been recognized that a distribution of the functionalities to two or more devices brings along advantages in several situations, for example, in situations in which the processing should be distributed between devices having different processing power, wherein interface capabilities also need to be considered. To conclude, the audio processing system allows for an adaptation of the concept disclosed herein to distributed applications.

Furthermore, it should be noted that the audio processing system may optionally be supplemented by any of the features, functionalities and details disclosed herein, e.g. with respect to the audio processor, both individually and taken in combination.

In an embodiment, the audio processing system comprises an interface for providing the time scale modified intermediate audio signals (e.g. time scale modified decoded transport channels) and associated adapted metadata to a second processing (e.g. a rendering) which takes place in a different device than the first processing.

This implementation is based on the finding that the time scale modified intermediate audio signals and the associated meta data can typically be transferred from one device to another device in an efficient manner, since this information typically comprises a sufficiently small bit rate to be suited for an efficient exchange via an interface. In addition, reference is made to the above discussion of distributed implementations of the audio processor.

An embodiment according to the invention creates an audio decoder for providing a decoded audio representation on the basis of an encoded audio representation. The audio decoder comprises an audio processor as disclosed herein. For example, the first processing comprises a decoding of one or more encoded transport channels, wherein, for example, the one or more intermediate audio signals are one or more decoded transport channels. For example, the second processing comprises a rendering or an upmix of the one or more time scale modified intermediate audio signals, wherein, for example, rendered or upmixed audio channels make up the processed audio representation.

It has been recognized that the audio processor disclosed herein is well-suited for usage in an audio decoder. In particular, the audio processor disclosed herein is well-usable in an audio decoder comprising multiple processing stages or processing steps, wherein one or more of these steps can be performed as the first processing and one or more other of the processing steps can be performed as the second processing. In other words, it has been recognized that the audio processor (and the concept to perform a time scale modification on an intermediate audio signal) is well-applicable in an audio decoder.

An embodiment according to the invention creates a method for providing a processed (e.g. decoded and rendered) audio signal representation (e.g. in the form of a plurality of rendered time domain audio signals) on the basis of an input audio signal representation (e.g. an encoded representation of a multi-channel audio content). The method comprises performing a plurality of processing steps (e.g. separate processing functionalities; e.g. a first processing and a second processing), in order to provide the processed audio signal representation on the basis of the input audio signal representation. The method comprises performing a time scale modification (e.g. a modification of a length of an audio signal portion, e.g. an audio frame, provided by the first processing) on one or more intermediate audio signals, which are provided by a first processing (e.g. a first processing step), in order to obtain one or more time-scale-modified intermediate audio signals, and the method comprises performing a second processing (e.g. a second processing step; e.g. an upmix and/or a rendering), which follows the first processing (e.g. the first processing step), on the basis of the one or more time-scale-modified intermediate audio signals.

The method is based on the same considerations like the audio processor disclosed herein. Accordingly, the method may optionally be supplemented by any of the features, functionalities and details disclosed herein with respect to the audio processor, both individually and taken in combination.

An embodiment according to the invention creates a computer program for performing the method of as disclosed herein when the computer program runs on a computer.

### BRIEF DESCRIPTION OF THE DRAWINGS

Embodiments of the present invention will be detailed subsequently referring to the appended drawings, in which:

FIG. 1 shows a block schematic diagram of an audio processor, according to an embodiment of the present invention;

FIG. 2 shows a block schematic diagram of an audio processing system, according to an embodiment of the present invention;

FIG. 3 shows a block schematic diagram of an audio decoder, according to an embodiment of the present invention;

FIG. 4 shows a flowchart of a method, according to an embodiment of the invention;

FIG. 5a shows a block schematic diagram of modules of the EVS jitter buffer management solution (FIG. 2 of [2]);

FIG. 5b shows a block schematic diagram of a receiver output buffer (FIG. 7 of [2]);

FIG. 5c shows a schematic representation of a shortening of an input frame (FIG. 5 of [2]), which can optionally be used in the time scale modification of embodiments according to the invention;

FIG. 5d shows a schematic representation of a lengthening of an input frame (FIG. 6 of [2]), which can optionally be used in the time scale modification in embodiments according to the invention;

FIG. 5e shows a schematic representation of a frequency domain rendering with subframes;

FIG. 6 shows a generic block diagram of IVAS with parametric reconstruction;

FIG. 7 shows a block schematic diagram of a generic multi-stage audio processor, according to an embodiment of the invention;

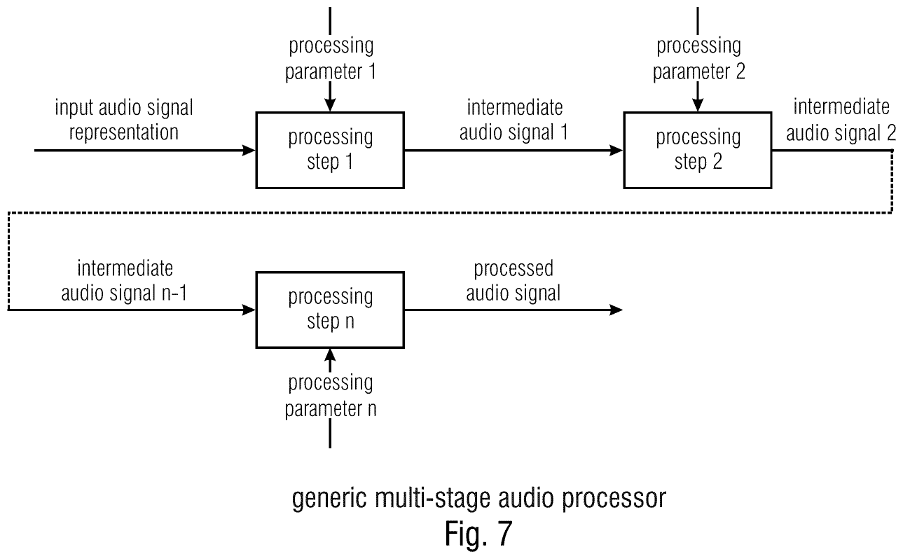

FIG. 8 shows a block schematic diagram of IVAS JBM (IVAS jitter buffer management) with TSM (time scale modification) on the output channels, according to an embodiment of the invention;

FIG. 9 shows a block schematic diagram of an audio processor TSM (time scale modification) on an intermediate audio signal, according to an embodiment of the invention;

FIG. 10 shows a block schematic diagram of an audio processor with parameters and TSM (time scale modification) on an intermediate audio signal, according to an embodiment of the invention;

FIG. 11 shows a block schematic diagram of an audio processor with TSM on an intermediate audio signal and time scaling processor, according to an embodiment of the invention;

FIG. 12 shows a block schematic diagram of an audio processor with TSM on an intermediate audio signal, processing parameter adapters, and a time scaling controller, according to an embodiment of the invention;

FIG. 13 shows a block schematic diagram of a playout speech control, according to an embodiment of the invention;

FIG. 14 shows a block schematic diagram of an IVAS JBM (jitter buffer management), according to an embodiment of the invention;

FIG. 15a shows a schematic representation of a receiver buffer for the IVAS JBM (jitter buffer management), according to an embodiment of the invention;

FIG. 15b shows a schematic representation of a receiver buffer for the IVAS JBM (jitter buffer management), according to another embodiment of the invention;

FIG. 16 shows a schematic representation of a TC (transport channel) frame buffering for FD rendering, according to an embodiment of the invention;

FIG. 17 shows a schematic representation of a FD (frequency domain) rendering with adapted subframe size, according to an embodiment of the invention;

FIG. 18 shows a schematic representation of a rendering with constant subframe size and adapting the metadata, according to an embodiment of the invention; and

FIG. 19 shows a graphic representation of a concept for adapting interpolation functions, according to an embodiment of the invention.

### DETAILED DESCRIPTION OF THE INVENTION

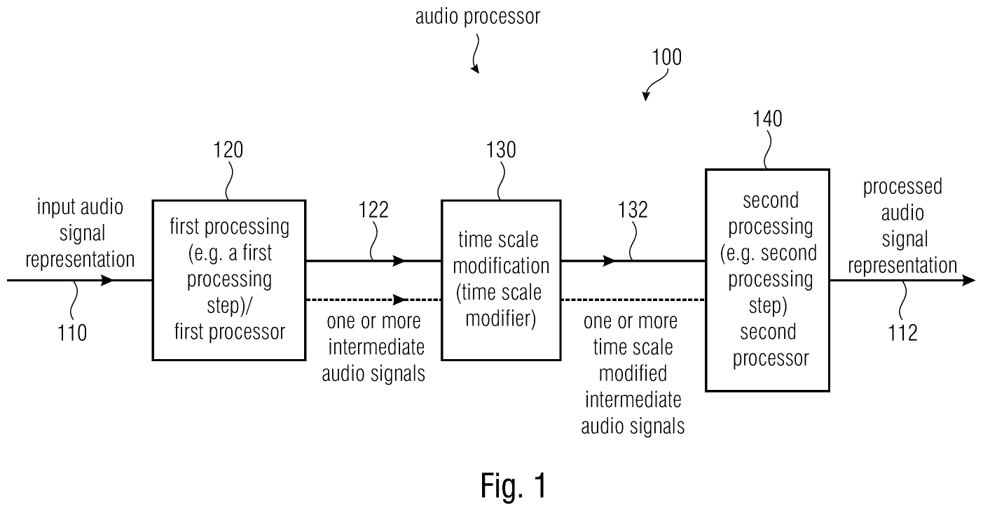

### 1. Audio Processor According to FIG. 1

FIG. 1 shows a block schematic diagram of an audio processor 100, according to an embodiment of the invention. The audio processor 100 is configured to receive an input audio signal representation 110 and to provide, on the basis thereof, a processed audio signal representation 112, which may also be considered as an output audio signal representation. The audio processor 100 is configured to perform a plurality of processing steps, in order to provide the processed audio signal representation 112 on the basis of the input audio signal representation. In particular, the audio processor 100 comprises a first processing 120, which receives the input audio signal representation 110 and provides, on the basis thereof, one or more intermediate audio signals 122. For example, the first processing 120 may comprise a first processing step, but optionally, the first processing 120 may comprise a plurality of processing steps.

The audio processor 100 is further configured to perform a time scale modification on the one or more (original) intermediate audio signals 122, which are provided by the first processing 120, in order to obtain one or more time scale modified intermediate audio signals 132. In other words, the time scale modification 130 receives the one or more intermediate audio signals 122, performs a time scale modification, and provides, as a result of the time scale modification, the one or more time scale modified intermediate audio signals 132. The audio processor 100 is further configured to perform a second processing, which follows the first processing, on the basis of the one or more time scaled modified intermediate audio signals. For example, the audio processor 100 may comprise a second processing 140 which receives the one or more time scale modified intermediate audio signals 132, processes the one or more time scale modified intermediate audio signals and provides, as a result of the processing, the processed audio signal representation 112. For example, the second processing 142 may comprise a second processing step. However, the second processing may optionally comprise a plurality of processing steps to derive the processed audio signal representation 112 on the basis of the one or more time scale modified intermediate audio signals 132.

The audio processor 100 is based on the finding that it is advantageous to perform the time scale modification on the basis of one or more intermediate signals, i.e., between a first processing, which is performed before the time scale modification and a second processing, which is performed after the time scale modification and using the one or more time scale modified intermediate audio signals provided by the time scale modification. In particular, it has been recognized that a time scale modification in between different processing steps, which provide a processed audio signal representation 112 (e.g., a decoded and rendered audio signal representation or a decoded and reconstructed audio signal representation) on the basis of an input audio signal representation is often more efficient than the application of a time scale modification onto the final output signals provided at the end of a processing chain. For example, a number of channels at the output of the first processing 120 may be smaller than a number of channels of the processed audio signal representation 112, such that the application of the time scale modification 130 to the one or more intermediate audio signals 122 requires less effort (e.g., computational resources) than a possible application of a time scale modification to the final processed audio signal representation 112. For example, it has been found to be advantageous to apply the time scale modification 130 before a second processing step, which increases a number of channels and/or which increases a bandwidth of audio channels, since the application of a time scale modification to a smaller number of audio channels is easier than the application of the time scale modification to an increased number of (e.g., rendered or upmixed or bandwidth extended) channels of the processed audio signal representation 112, which is derived by a further processing (e.g., the second processing 140) on the basis of the one or more intermediate audio signals 122. However, it has also been recognized that, in many situations, it is easier to apply the time scale modification 130 on the one or more intermediate signals when compared to a time scale modification that would be applied to the input audio signal representation. For example, if the input audio signal representation 110 is in an encoded form, a time scale modification would be very complicated. In contrast, the application of the time scale modification after a decoding (which may be performed as a part of the first processing or which may be performed as the first processing) has been found to be efficient.

To conclude, the audio processor 100 brings along a good tradeoff between computational complexity and an achievable audio quality, wherein the application of the time scale modification to one or more intermediate signals, i.e., between two processing steps, has been found to be very advantageous.

Moreover, it should be noted that the audio processor 100 may optionally be supplemented by any of the features, functionalities, and the details disclosed herein, both individually and taken in combination.

For example, the second processing may optionally comprise two or more processing functions (or processing steps) which may be substantially separate or which may be performed in a combined manner.

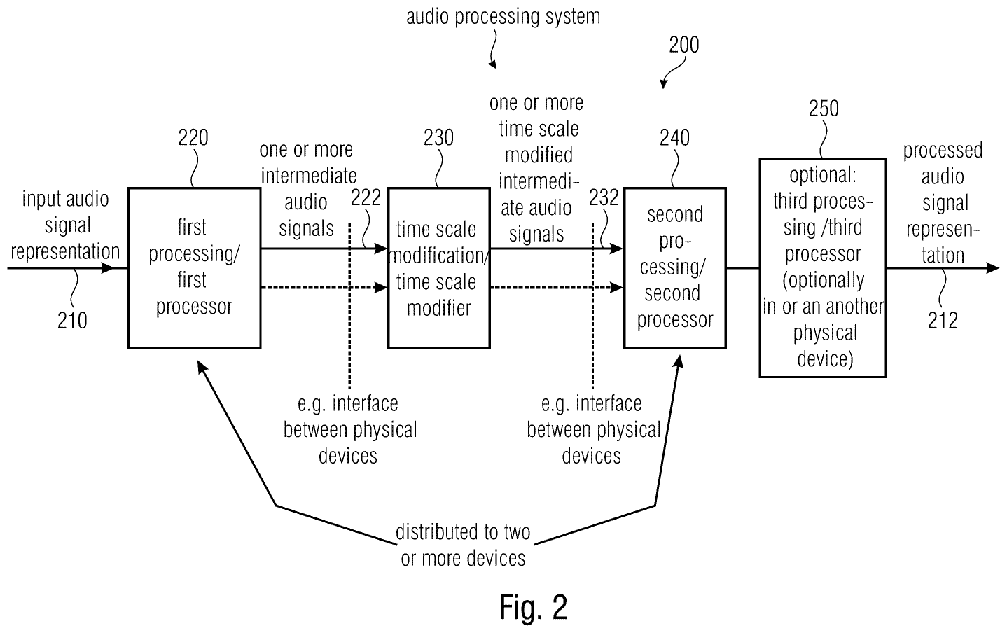

### 2. Audio Processing System According to FIG. 2

FIG. 2 shows a block schematic diagram of an audio processing system, according to an embodiment of the present invention. The audio processing system 200 according to FIG. 2 is configured to receive an input audio signal representation 210 and to provide, on the basis thereof, a processed audio signal representation 212. The audio processing system 200 comprises a first processing or a first processor 220, which receives the input audio signal representation 210 and provides, on the basis thereof, one or more intermediate audio signals 222. The audio processing system 200 further comprises a time scale modification or a time scale modifier 230, which receives the one or more intermediate audio signals 222 and applies the time scale modification. Accordingly, the time scale modification/time scale modifier 230 provides, as a result, one or more time-scale-modified intermediate audio signals 232 to a second processing or to a second processor 240. The second processing/second processor 240 applies a further processing to the one or more time scale modified intermediate audio signals, or to signals derived from the time scale modified intermediate audio signals, and provides, as a result of the processing, the processed audio signal representation 212. For example, there may be an interface between the first processing 220 and the time scale modification 230. Alternatively or in addition, there may be an interface between the time scale modification/time scale modifier 230 and the second processing/second processor 240. For example, the first processing/first processor 220 and the second processing/second processor 240 may be distributed to two or more devices, e.g., to two or more separate hardware devices which may, for example, be coupled using a wired link or using a wireless link. For example, the first processing/first processor 220 and the second processing/second processor 240 may be part of physically separate apparatuses which together form the audio processing system 200. The time scale modification 230 may, for example, be included in the apparatus comprising the first processing/first processor 220 or may be included in the apparatus comprising the second processing/second processor 240.

To conclude, the audio processing system may be adapted for providing a processed audio signal representation 212 on the basis of the input audio signal representation 210. The audio processing system is configured to perform a plurality of processing steps, in order to provide the processed audio signal representation 212 on the basis of the input audio signal representation 210. The separate processing steps may, for example, be performed by the first processing/first processor 220 and by the second processing/second processor 240. The audio processing system is configured to perform a time scale modification 230 on one or more intermediate audio signals 222 which are provided by the first processing 230, in order to obtain the one or more time scale modified intermediate audio signals 232. Moreover, the audio processing system is configured to perform a second processing 240, which follows the first processing 220, on the basis of the one or more time scale modified intermediate audio signals 232. In particular, functionalities of the audio processing system are distributed to two or more devices, wherein, for example, the first processing 220 and the second processing 240 may be included in separate devices.

However, it should be noted that the audio processing system 200 may optionally comprise a third processing/third processor 250, which may follow the second processing/second processor 240. For example, the third processing/third processor 250 may perform one or more further processing functionalities which result in a (final) processed audio signal (e.g. in an audio signal which can be output to a user).

It should be noted that, optionally, the third processing may be performed in a different (physical) device than the first processing. For example, the third processing may be performed in the same device like the second processing. As another alternative, the third processing may be performed in a different (physical) device than the second processing (e.g. with a wired or wireless interface between the second processing and the third processing).

For example, a split rendering may be implemented (i.e. transport channel (TC) decoding, binaural rendering to three different head positions, sending to an edge device with metadata, completing the rendering in the edge device in accordance with the actual head position).For example, the transport channel decoding, a time scale modification and the binaural rendering (or pre-rendering) to three different head positions may be performed in a first device or even in two devices, the result of the pre-rendering and metadata (e.g. adapted metadata) may be transmitted to an edge device (e.g. via a wired or wireless interface), and the completion of the rendering in accordance with the actual head position may be performed in the edge device. However a different distribution of the functionalities to two or more hardware devices or hardware apparatuses is also possible.

However, it should be noted that the audio processing system 200 comprises similar advantages like the audio processor 100.

Moreover, it should be noted that the audio processing system 200 may optionally be supplemented by any of the features, functionalities and the details disclosed herein. In particular, the audio processing system 200 may optionally be supplemented by any of the features, functionalities and the details disclosed with respect to the audio processor 100, both individually and taken in combination.

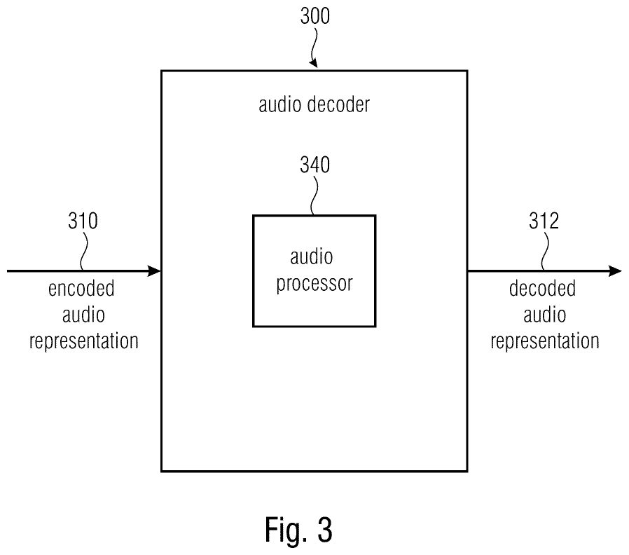

### 3. Audio Decoder According to FIG. 3

FIG. 3 shows a block schematic diagram of an audio decoder 300, according to an embodiment of the present invention. The audio decoder 300 is configured to receive an encoded audio representation 310 and to provide, on the basis thereof, a decoded audio representation 312. In particular, the audio decoder 300 comprises an audio processor 340, wherein the audio processor 340 may, for example, correspond to the audio processor 100 according to FIG. 1. For example, the first processing performed by the audio processor 340 may comprise a decoding of one or more encoded transport channels, which may, for example, be represented by the encoded audio representation. Accordingly, the one or more intermediate audio signals may be one or more decoded transport channels. For example, the second processing comprises a rendering or an upmix of the one or more time scale modified intermediate audio signals, wherein, for example, the rendered or upmixed audio channels make up the processed audio representation (and may form the decoded audio representation 312). In other words, different functionalities of the audio decoder 300, like, for example, a transport channel decoding and a rendering/upmixing may be performed by the audio processor 340, for example as the first processing 120 and as the second processing 140. Thus, the time scale modification may be performed in between different functionalities which are performed by the audio decoder 300. Insofar, the audio decoder 300 comprises the same advantages like the audio processor 100.

Moreover, it should be noted that the audio decoder 300 may optionally be supplemented by any of the features, functionalities and the details disclosed herein, for example, with respect to the audio processor.

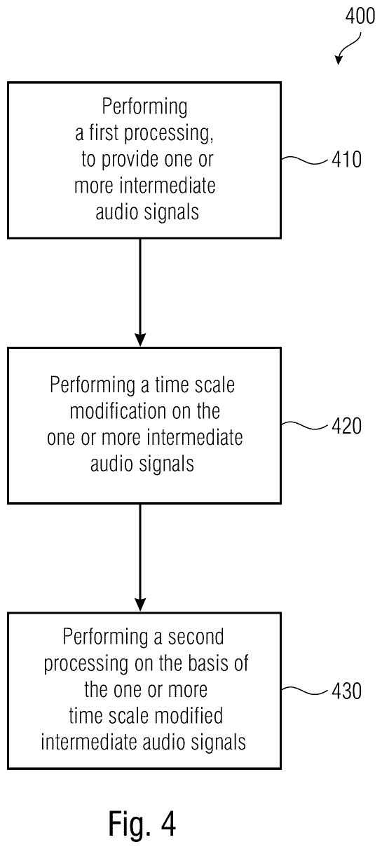

### 4. Method According to FIG. 4

FIG. 4 shows a flowchart of a method 400 for providing a processed audio signal representation on the basis of an input audio signal representation. The method 400 comprises performing 410 a first processing, to provide one or more intermediate audio signals. The method 400 further comprises performing 420 a time scale modification on the one or more intermediate audio signals. The method 400 further comprises performing 430 a second processing on the basis of the one or more time scale modified intermediate audio signals. Accordingly, the method may, for example, comprise (or perform) the functionality of the audio processor 100 or of the audio processing system 200 or of the audio processor 340. Thus, the method 400 may bring along the same advantages like the audio processor 100 discussed above.

Moreover, it should be noted that the method 400 may optionally be supplemented by any of the features, functionalities and the details disclosed herein, for example, with respect to the audio processor, with respect to the audio processing system and with respect to the audio decoder, both individually and taken in combination.

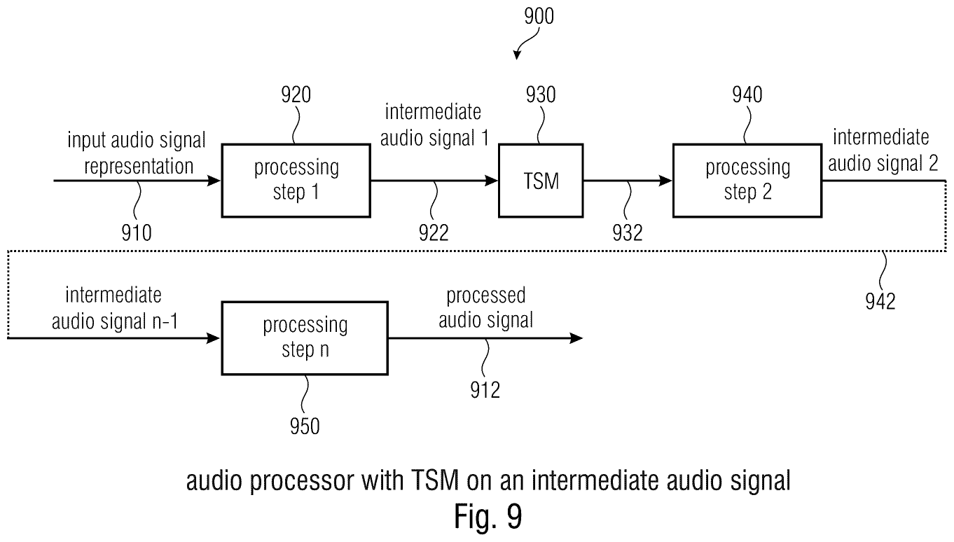

### 5. Audio Processing According to FIG. 9

FIG. 9 shows a block schematic diagram of an audio processor/audio processing 900, according to an embodiment of the present invention. The audio processor according to FIG. 9 is configured to receive an input audio signal representation 910 and to provide, on the basis thereof, a processed audio signal 912 (or a plurality of processed audio signals). The audio processor 900 comprises a first processing step (or a first processing) 920, which receives the input audio signal representation 910 and provides, on the basis thereof, an intermediate audio signal 1, which is designated with 922. The audio processor 900 further comprises a time scale modification (TSM) 930, which receives the intermediate audio signal 1 (designated with 922) and provides, on the basis thereof, a time scale modified intermediate audio signal 1, which is designated with 932. However, it should be noted that the intermediate audio signal 1 may optionally be replaced by a plurality of intermediate audio signals, and that the time scale modified intermediate audio signal 1 (932) may optionally be replaced by a plurality of time scale modified intermediate audio signals (wherein it should be noted that one or more intermediate audio signals may be used in any of the embodiments). The time scale modified intermediate audio signal 1 (932) is input into a second processing step 940, which provides an intermediate audio signal 2 (designated with 942) on the basis of the time scale modified intermediate audio signal 1. Optionally, the audio processor 100 may comprise one or more further processing steps, e.g., up to a processing step n (or processing n, or processor n), which is designated with 950 which further processes the intermediate audio signal 2 (designated with 942) or yet another intermediate audio signal derived from the intermediate audio signal 2. For example, each processing step (or each processing, or each processor) may provide a new intermediate audio signal, which is then fed into the subsequent processing step (or processing or processor). Accordingly, the processing step n 950 may receive an intermediate audio signal n−1. However, the last processing step in the chain (in the present example, the processing step n, designated with 950) provides the processed audio signal 912.

In this regard, it should be noted that in total there may two processing steps (e.g., processing step 1, designated with 920, and processing step 2, designated with 940). However, it should be noted that, optionally, there may be two or more processing steps before the time scale modification 930 and that, optionally, there may be two or more processing steps after the time scale modification 930.

To conclude, FIG. 9 shows an audio processor with a time scale modification on an intermediate audio signal. Accordingly, the time scale modification is applied to an intermediate audio signal, which is provided by a processing step preceding the time scale modification, and the time scale modification provides a time scale modified intermediate audio signal to a subsequent processing step.

However, it should be noted that the audio processor 900 may comprise the same advantages that have already been discussed with respect to the audio processor 100. Furthermore, the audio processor 900 may optionally be supplemented by any of the features, functionalities and details described herein both individually and taken in combination.

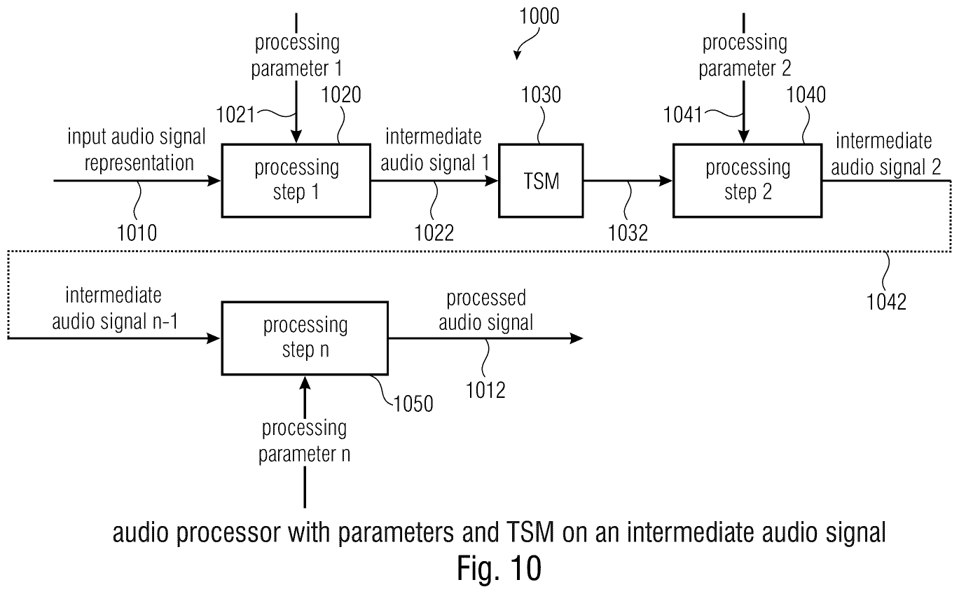

### 6. Audio Processor According to FIG. 10

FIG. 10 shows a block schematic diagram of an audio processor with parameters and time scale modification (TSM) on an intermediate audio signal.

The audio processor 1000 according to FIG. 10 is similar to the audio processor 900 according to FIG. 9, such that identical features, functionalities and details will not be discussed here again. Rather, reference is made to the discussion of the audio processor 900 according to FIG. 9.

However, the audio processor 1000 is configured to receive an input audio signal representation 1010 which corresponds to the input audio signal representation 910. The audio processor 1000 is configured to provide a processed audio signal 1012 on the basis of the input audio signal representation 1010. The audio processor 1000 comprises a first processing step 1020 which, in principle, corresponds to the first processing step 920. However, the first processing step 1020 of the audio processor 1000 is configured to use one or more processing parameters 1021 to adjust the processing performed by the first processing step 1020. The first processing step 1020 is configured to provide an intermediate audio signal 1, which is designated with 1022, on the basis of the input audio signal representation 1010, wherein the first processing step 1020 is controlled or adjusted using the one or more processing parameters 1021. Regarding this issue, it should be noted that reference is made to a “processing parameter 1” in FIG. 10. However, alternatively, a plurality of first processing parameters may be used by the first processing step 1020. Moreover, it should be noted that FIG. 10 shows that the first processing step provides an “intermediate audio signal 1”. However, alternatively, the first processing step 1020 may provide a plurality of intermediate audio signals.

The audio processor 1000 comprises a time scale modification 1030, which corresponds to the time scale modification 930. The time scale modification 1030 provides a time scale modified intermediate audio signal 1, which is designated with 1032. Alternatively, however, the time scale modification 1030 may provide a plurality of time scale modified intermediate audio signals.

The audio processor 1000 also comprises a second processing step 1040, which receives the time scale modified intermediate audio signal 1 (or a plurality of time scale modified first intermediate audio signals). The second processing step 1040 may correspond, in principle, to the second processing step 940. However, the second processing step 1040 uses a processing parameter 2, also designated with 1041, in order to control or adjust the second processing step 1040. Alternatively, however, the second processing step 1040 may receive and use a plurality of processing parameters. Accordingly, the second processing step 1040 provides an intermediate audio signal 2, which is designated with 1042. However, alternatively, the second processing step 1040 may provide a plurality of intermediate audio signals.

It should be noted that the first processing 1020 may provide any number of intermediate audio signals to the time scale modification 1030, wherein the time scale modification 1030 typically provides the same number of time scale modified intermediate audio signals (1032). In other words, the time scale modification 1030 typically does not change the number of intermediate audio signals. However, the second processing step 1040 may, for example, receive a first number of time scale modified intermediate audio signals from the time scale modification 1030 and provide a second number of intermediate audio signals or processed audio signals as an output. Worded differently, the second processing step 1040 may, for example, perform an upmixing or a downmixing, wherein an upmixing would be advantageous.

Furthermore, the audio processor 1000 may optionally comprise one or more additional processing steps, for example, a n-th processing step 1050. The one or more optional additional processing steps (e.g., the n-th processing step 1050) may or may not use one or more processing parameters. Accordingly, the audio processor 1000 obtains the processed audio signal 1012 as an output of a last processing step (wherein, in some embodiments, the second processing step 1040 may be the last processing step). Moreover, it should be noted that in some cases it may be sufficient that only a single processing step (e.g., out of the processing steps 1020, 1040, 1050) uses one or more processing parameters.

However, it is advantageous that the second processing step 1040 uses one or more processing parameters to adjust the processing performed by the second processing step. The processing parameters may, for example, be parameters defining a rendering operation performed by the second processing step 1040 or an upmixing operation performed by the second processing step 1040 or parameters controlling a bandwidth extension functionality performed by the second processing step, or any other processing parameters that adjust the processing performed by the second processing step 1040.

To conclude, the functionality of the audio processor 1000 is similar to the functionality of the audio processor 900, wherein, however, one or more of the processing steps use one or more processing parameters, and wherein it should be noted that different processing steps may use different processing parameters, and that the number of processing parameters used by the different processing steps may vary, and wherein, for example, each of the processing steps may use 0, 1 or more processing parameters. Moreover, it should be noted that a temporal granularity of the processing parameters may also vary over a wide range. For example, a processing parameter, or a set of processing parameters, may be provided per time domain sample, or per frequency domain sample, or per time slot, or per subframe or per frame or even per block of frames.

However, it should be noted that the audio processor 1000 according to FIG. 10 comprises similar advantages like the audio processor 100 according to FIG. 1. In particular, by using the time scale modification 1030 in between different (e.g., separate) processing steps, a good efficiency of the processing can be achieved and a good audio quality may also be achieved.

Moreover, it should be noted that the audio processor 1000 according to FIG. 10 may optionally be supplemented by any of the features, functionalities and details disclosed herein, both individually and taken in combination.

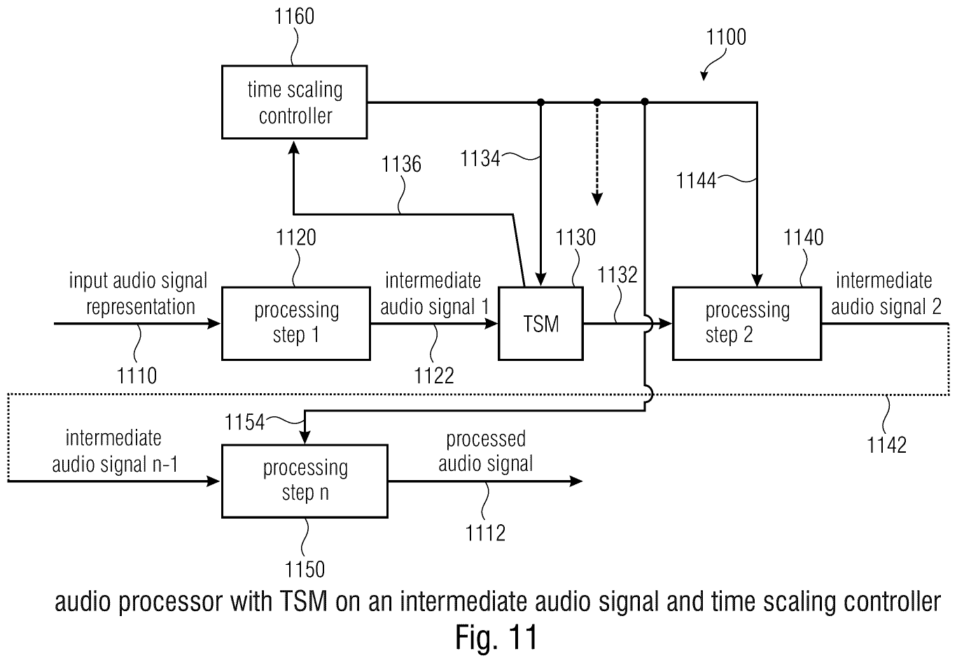

### 7. Audio Processor According to FIG. 11

FIG. 11 shows a block schematic diagram of an audio processor 1100 with time scale modification (TSM) on an intermediate audio signal and time scale controller, according to embodiments of the present invention.

The audio processor 1100 is similar to the audio processor 100 and similar to the audio processor 1000.

In particular, the audio processor 1100 is configured to receive an input audio signal representation 1110 and to provide, on the basis thereof, a processed audio signal representation 1112. The audio processor 1100 comprises a first processing step 1120 which may correspond to the first processing step 920 or to the first processing step 1020. The first processing step 1120 provides an intermediate audio signal 1 (designated with 1122) and may alternatively provide a plurality of first intermediate audio signals. The audio processor 1100 comprises a time scale modification 1130 which may, for example, correspond to the time scale modification 930 or to the time scale modification 1030. However, the time scale modification 1130 may receive a control signal 1134 from a time scaling controller 1160 and may provide a time scaling information 1136 to the time scaling controller 1160. Moreover, the time scale modification 1130 may be configured to provide a time scale modified intermediate audio signal 1, which designated with 1132 to a second processing step 1140. The time scale modified intermediate audio signal 1, which is designated with 1132, may be based on the intermediate audio signal 1, which is designated with 1122, and may be derived from the intermediate audio signal 1 (1122) using a time scale modification. However, it should be noted that both the intermediate audio signal 1 and the time scale modified intermediate audio signal 1 may optionally comprise a plurality of channels. The second processing step 1140 may, for example, correspond to the second processing step 940 and to the second processing step 1040, and may provide an intermediate audio signal 2, which is designated with 1142, on the basis of the time scale modified intermediate audio signal 1132. However, the “intermediate audio signal 2” may, for example, comprise a higher number of channel signals, wherein the number of channel signals of the intermediate audio signal 2 may be equal to or different from a number of channels of the time scale modified intermediate audio signal 1, which is input into the second processing 1140. However, in addition to the functionalities of the second processing 940, 1040, the second processing 1140 may receive a control signal 1144 from the time scaling controller 1160.

Furthermore, the audio processor 1100 comprises one or more further processing steps, e.g., a processing step n which is also designated with 1150. Accordingly, the processed audio signal 1012 may be provided as an output of the processing step n, or alternatively may be provided as an output signal of the processing step 2 (1140) in case there are no further processing steps in addition to the first processing step 1120 and the second processing step 1140.

However, generally speaking, any of the explanations applied above with respect to the audio processor 900 and with respect to the audio processor 1000 are applicable, except for the fact that the time scale modification 1130 receives the control signal 1134 from the time scaling controller 1160, that the time scale modification 1130 provides a time scaling information 1136 to the time scaling controller 1160, and that one or more of the processing steps following the time scale modification (e.g., the second processing step 1140 and/or the n-th processing step 1150) receive respective control signals 1144, 1154 from the time scaling controller 1160.

The time scaling controller 1160 may, for example, control the time scale modification 1130 using the control signal 1134. Thus, the time scaling controller 1160 may, for example, receive an information about a desired amount of a time scaling (e.g., from a jitter buffer management) and may provide the control information 1134 to the time scale modification 1130 to thereby adjust the time scale modification. Moreover, the time scaling controller 1160 may receive the time scaling information 1136 from the time scale modification 1130. Regarding this issue, it should be noted that the time scale modification 1130 may determine an actual amount of the time scale modification on the basis of the control signal 1134 but also independence on signal characteristics of the intermediate audio signal 1 (1122). In other words, the amount of time scale modification may be adapted in accordance with characteristics of the intermediate audio signal 1, to thereby reduce artifacts. Accordingly, the actual amount of time scale modification indicated by the time scaling information 1136 may deviate from a desired time scale modification indicated by the control signal 1134.

However, the time scaling controller 1160 may, for example, adapt the desired time scale modification in dependence on the time scaling information 1136, e.g., in an iterative manner, (e.g., for a subsequent frame). Moreover, the time scaling controller 1160 may provide control information 1144, 1154 to one or more of the processing steps 1140, 1150 following the time scale modification. For example, the time scaling controller 1160 may provide control information 1144, 1154 for the processing steps in dependence on the time scaling information 1136 (and possibly in dependence on further information received by the time scaling controller 1160). Accordingly, the time scaling controller 1160 may provide the control signals 1144, 1154 to the processing steps 1140, 115 following the time scale modification to thereby adapt said processing steps to the time scale modification (e.g., to a desired time scale modification and/or to an actual time scale modification). For example, the control signals 1144, 1154 may be used to adapt a frame grid or a subframe grid for a determination of processing blocks by the processing steps 1140, 1150. However, the control signals 1144, 1154 may also adjust any other processing characteristics of the processing steps 1140, 1150.

To conclude, the audio processor 1100 comprises a time scale modification in between a plurality of processing steps, such that the time scale modification operates on an intermediate audio signal 1122. Furthermore, the time scale modification 1130 is controlled by the time scaling controller 1160, and the processing steps 1140, 1150 following the time scale modification are also adapted to the actual time scale modification. Thus, the audio processor 1100 brings along the advantages described above with respect to the audio processor 100 and additionally provides for an improved audio quality due to the adaptation of the processing steps 1140 and 1150 to the time scale modification.

Moreover, it should be noted that the audio processor 1100 may optionally be supplemented by any of the features, functionalities and the details described herein.

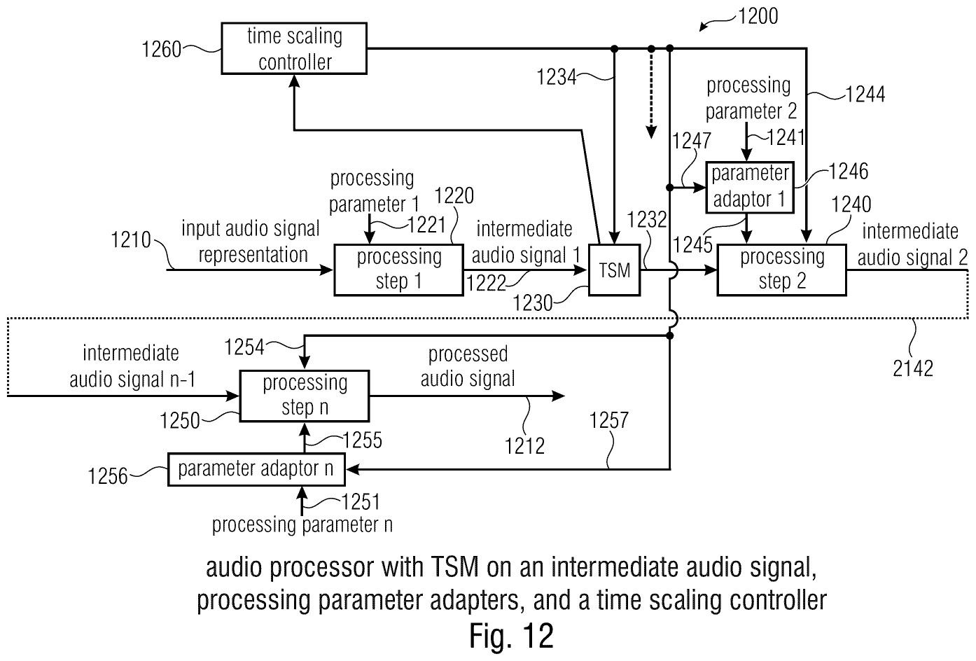

### 8. Audio Processor According to FIG. 12

FIG. 12 shows a block schematic diagram of an audio processor 1200 with time scale modification (TSM) on an intermediate audio signal, processing parameter adaptors and a time scaling controller, according to an embodiment of the invention.

It should be noted that the audio processor 1200 according to FIG. 12 is very similar to the audio processor 1100 according to FIG. 11. Accordingly, those features, functionalities and details which were already described with respect to the audio processor 1100 will not be explained in detail again. Rather, reference is made to the above discussion of the audio processor 1100.

The audio processor 1200 is configured to receive an input audio signal representation 1210, which corresponds to the input audio signal representation 1110, and provides, on the basis thereof, a processed audio signal 1212 which corresponds to the processed audio signal 1112.

The audio processor 1200 comprises a first processing step 1220, which correspond to the first processing step 1120, wherein it should be noted that the first processing step 1220 may, for example, use a processing parameter 1, which is designated with 1221 (or alternatively, a plurality of first processing parameters). The first processing step 1220 provides an intermediate audio signal 1, which is designated with 1222, on the basis of the input audio signal representation 1210, wherein the first processing step 1220 is controlled by the processing parameter 1 (1221). The audio processor 1200 comprises a time scale modification 1230, which receives the intermediate audio signal 1 (1222) and provides, on the basis thereof, a time scale modified intermediate audio signal 1, which is designated with 1232. The time scale modification 1230 receives a control signal (or control information) 1234, which corresponds to the control signal 1134, and provides a time scaling information 1236, which corresponds to the time scaling information 1136.

The audio processor 1200 comprises a second processing step 1240, which receives the time scale modified intermediate audio signal 1 (1332) and provides, on the basis thereof, an intermediate audio signal 2, which is designated with 1242. The second processing step 1240 may, for example, combine the functionalities of the second processing step 1040 (e.g., in that the second processing step 1240 uses a processing parameter) and of the second processing step 1140 (e.g., in that the second processing step 1240 receives a control signal). For example, the second processing step 1240 receives a control signal 1244 (e.g., from a time scale controller 1260) and further receives an adapted processing parameter 2, which is designated with 1245 from a first parameter adaptor 1246. For example, the first parameter adaptor 1246 receives a processing parameter 2, which is designated with 1241 and provides, on the basis thereof, the adapted processing parameter 2 (designated with 1245). The adaptation of the processing parameter 2 (1241) by the parameter adaptor 1246 is, for example, adjusted in dependence on a control signal 1247 which is provided by the time scaling controller 1260.

Accordingly, the time scale controller 1260 may, for example, control the adaptation of the one or more processing parameters 1241 used by the second processing 1240 (which follows the time scale modification 1230) and may also control a further adaptation of the processing 1240 using the control signal 1244. Accordingly, the time scaling controller 1260 may, for example, have a double impact on the processing performed by the second processing (or second processing step) 1240.

Similarly, optional further processing steps (e.g., an optional further n-th processing step 1250) may be similar to the second processing step 1240. For example, the n-th processing step 1250 may receive a control signal 1251a from the time scaling controller 1260, wherein an effect of the control signal 1251a may be similar to an effect of the control signal 1154. Moreover, the n-th processing step 1250 may receive one or more adapted processing parameters 1255 from a parameter adaptor 1256. For example, the parameter adaptor 1256 (e.g., a parameter adaptor n) may receive one or more processing parameters n which are also designated with 1251. Furthermore, the parameter adaptor 1256 receives a control signal 1257 from the time scaling controller 1260. Accordingly, the parameter adaptor 1256 may adapt the one or more processing parameters 1251 in dependence on the control signal 1257 provided by the time scaling controller 1260, to thereby obtain the one or more adapted processed parameters 1255 for the n-th processing step 1250. Moreover, it should be noted that the n-th processing step 1250 may also receive a control signal 1254 from the time scaling controller 1260, wherein the control signal 1254 may, for example, adapt a processing performed by the n-th processing step 1250 to the time scale modification.

The time scaling controller 1260 may, for example, receive an information indicating a desired time scale modification and provide the control signal 1234 to the time scale modification 1230. Thus, the time scaling controller 1260 may signal to the time scale modification 1230 which time scale modification is desired. However, the time scale modification 1230 may provide the time scaling information 1236 to the time scaling controller 1260, wherein the time scaling information 1236 may, for example, indicate an actual time scale modification, which may be different from the desired time scale modification due to the signal characteristics of the one or more intermediate audio signals 1222. The time scaling controller may, for example, provide the control signals 1244, 1254 for the processing steps 1240, 1250 following the time scale modification 1230 in dependence on the time scaling information 1236. Furthermore, the time scaling controller 1260 may, for example, provide the control signals 1247, 1257 controlling the adaptation of the respective processing parameters 1241, 1251 in dependence on the time scaling information 1236. Accordingly, the time scaling controller may control the adaptation of the respective processing parameters (or sets of processing parameters) to the time scale modification and may also control an adaptation of a processing functionality of the processing steps 1240, 1250 to the time scale modification.

However, it should be noted that it is not necessary to have all the functionalities shown in FIG. 12. For example, it should be noted that any of the further processing steps following the second processing step 1240 may be considered as being optional. Moreover, both the parameter adaptors 1246, 1256 and the usage of the control signals 1244, 1254 may be considered as being optional. For example, it is not required that all of these functionalities are present in some embodiments.

To conclude, the audio processor 1200 comprises a time scale modification 1230 which is in between a preceeding processing step 1220 and a subsequent processing step 1240. The audio processor 1200 also comprises a time scaling controller 1260 which is configured to control an adaptation of one or more processing parameters for the processing 1240 in dependence on the time scale modification, and/or to adopt the processing 1240.

However, it should be noted that the audio processor 1200 comprises the advantage described herein with respect to the audio processor 1000 and with respect to the audio processor 1100.

Moreover, it should be noted that the audio processor 1200 may optionally be supplemented by any of the features, functionalities and the details disclosed herein, both individually and taken in combination.

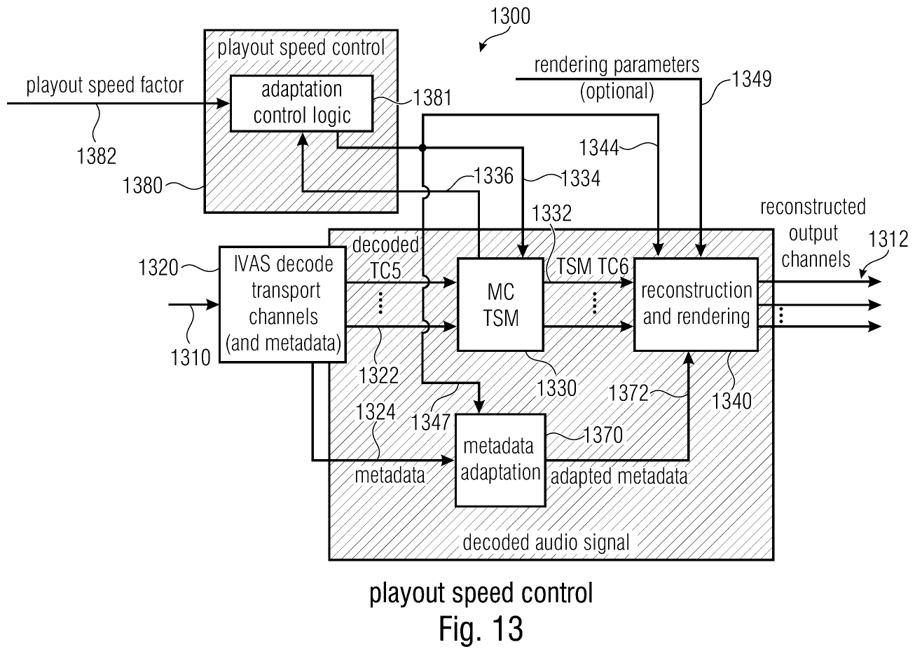

### 9. Audio Processor According to FIG. 13

FIG. 13 shows a block schematic diagram of an audio processor 1300 comprising a playout speech control, according to an embodiment of the invention. The audio processor 1300 is configured to receive an input audio representation 1310 and to provide, on the basis thereof, a plurality of reconstructed audio channels which are designated with 1312 and which may, for example, be considered as a processed audio signal representation. The audio processor 1300 (which may also be considered as an audio decoder) comprises a decoding (or decoder) 1320, which may, for example, perform an IVAS decoding of transport channels (and optionally, metadata). Thus, the decoding 1320 may provide one or more decoded transport channels 1322 and may also provide decoded metadata 1324. The audio processor 1300 also comprises a multi-channel time scale modification 1330 which may, for example, receive the decoded transport channels 1322 and provide one or more time scale modified (decoded) transport channels 1332. Moreover, the audio processor 1300 comprises a reconstruction and a rendering 1340, which receives the time scale modified transport channels 1332 and provides, on the basis thereof, the reconstructed audio channels 1312. Moreover, the audio decoder comprises a metadata adaptation 1370, which receives the decoded metadata 1324 and which provides, on the basis thereof, adapted metadata 1372 to the reconstruction and rendering 1340. Moreover, the audio processor 1300 comprises a playout speed control 1380, which receives a playout speed information 1382 (e.g., a playout speed factor) and provides, on the basis thereof, a plurality of control signals 1334, 1344, 1347. For example, the playout speed control may also receive a time scaling information 1336, which may, for example, describe an actual time scaling performed by the multi-channel time scale modification 1330. The playout speed control 1380 may comprise adaptation control logic 1381, which may process the playout speed information 1382 and the time scaling information 1336 and provide, on the basis thereof, the control signals 1334, 1344, 1347. Thus, the playout speed control 1380 may control the time scaling, which is performed by the multi-channel time scale modification 1330, in dependence on the playout speed information 1382, e.g., in order to modify a playout speed (which may, for example, be useful to facilitate an understanding of an audio content or which may, for example, be useful to obtain a synchronization between an audio encoder and an audio decoder running at different rates or at different clocks).

It should be noted that the multi-channel time scale modification 1330 may be configured to apply the time scale modification to a plurality of decoded transport channels (e.g., in parallel), for example, in a synchronized manner. Moreover, it should be noted that the rendering and reconstruction 1340 may, for example, be controlled by the control signal 1344 that is provided by the playout speed control 1380. However, the reconstruction and rendering 1340 may, for example, also receive rendering parameters 1349 which may, for example, describe a (desired) rendering of audio contents represented by the time scale modified transport channels 1332, to reconstructed output channels 1312. It should be noted that the reconstruction rendering 1340 may, for example, include an upmixing, such that, for example, a number of reconstructed output channels 1312 is larger than the number of time scale modified transport channels 1332. A rendering parameter 1349 may, for example, be provided by a user interaction (e.g., using a user interface) or may, for example, be derived from an encoded audio representation.

Moreover, the metadata adaptation 1370 may adapt the metadata 1324 to the time scale modification, to thereby obtain adapted metadata 1372. The adapted metadata 1372 may, for example, be used in the reconstruction and rendering 1340. Just as an example, the metadata 1324 or the adapted metadata 1372 may, for example, describe a mixing that is to be performed by the reconstruction and/or rendering 1340. For example, the adapted metadata 1372 may be entries of a mixing matrix, or may be parameters which describe entries of a mixing matrix that is used in the reconstruction and rendering 1340 to derive the reconstructed output channels 1312 on the basis of the time scale modified transport channels 1332. However, different types of metadata could also be used.

To conclude, in the audio processor 1300, the multi-channel time scale modification 1330 may be performed between a decoding 1320 and a reconstruction and rendering 1340, wherein the time scale modification may be multi-channel time scale modification that operates (e.g., in a synchronized manner) on a plurality of decoded transport channels. The playout speed control 1380 controls the multi-channel time scale modification 1330 using a control signal 1334 and also controls the reconstruction rendering 1340 using a control signal 1344 and also controls the metadata adaptation 1370 using a control signal 1347. Thus, the adapted metadata 1372 may be provided such that they are adapted to the time scale modification, which brings along a good result of the reconstruction and rendering 1340.

However, it should be noted that the audio processor 1300 may comprise any of the advantages of the other audio processors disclosed herein.

Moreover, it should be noted that the audio processor 1300 may optionally be supplemented by any of the features, functionalities and the details disclosed herein, both individually and taken in combination.

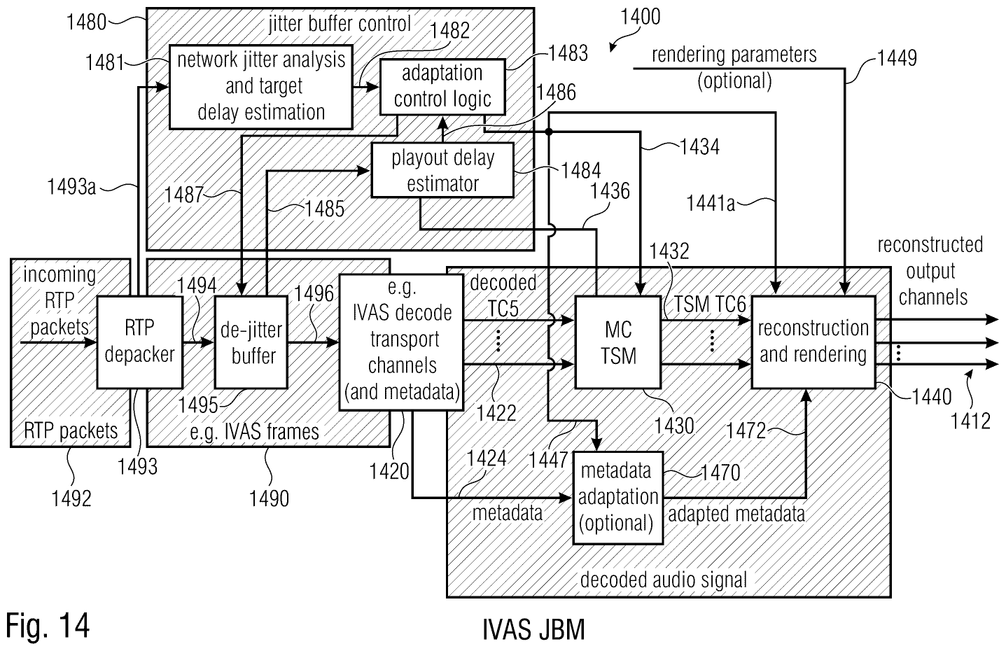

### 10. Audio Processor According to FIG. 14

FIG. 14 shows a block schematic diagram of an audio processor 1400, according to an embodiment of the invention. In particular, the audio processor 1400 may be combined with a IVAS jitter buffer management (IVAS JBM). However, it should be noted that the core functionality of the audio processor 1400 may be similar to a core functionality of the audio processor 1300. In particular, the audio signal processor 1400 comprises a decoding 1420, which may be configured to perform an IVAS decoding of transport channels (and optionally also of metadata). The decoding 1420 may correspond to the decoding 1320. Thus, the decoding 1420 provides one or more decoded transport channels 1422 (advantageously a plurality of decoded transport channels 1422). Moreover, the audio processor comprises a multi-channel time scale modification 1430 which may substantially correspond to the multi-channel time scale modification 1330. The multi-channel time scale modification 1430 receives the one or more decoded transport channels 1422 and also receives a control signal 1434. The multi-channel time scale modification 1430 provides one or more time scale modified transport channels 1432, which may substantially correspond to the time scale modified transport channels 1332. In addition, the multi-channel time scale modification 1430 provides a time scaling information 1436 which may substantially correspond to the time scaling information 1336. Moreover, the audio processor 1400 also comprises a reconstruction and rendering 1440 which may substantially correspond to the reconstruction and rendering 1340. The reconstruction and rendering 1440 receives the time scale modified transport channels 1432 and also receives a control signal 1444. The reconstruction and rendering 1440 also receives one or more rendering parameters 1449 and further receives adapted metadata 1472. For example, the control signal 1444 may correspond to the control signal 1341a, and the one or more rendering parameters 1449 may correspond to the one or more rendering parameters 1349. The adapted metadata 1472 may correspond to the adapted metadata 1372. The reconstruction and rendering 1340 provides, on the basis of the time scale modified transport channels 1432, the reconstructed output channels 1412. The reconstruction and rendering 1440 may use the control signal 1444, the one or more rendering parameters 1449 and the adapted metadata 1472 to provide the reconstructed output channels 1412 on the basis of the time scale modified transport channels 1432. For example, the reconstruction and rendering 1440 may perform an upmixing and/or a rendering, wherein entries of an upmixing matrix or of a rendering matrix may, for example, be determined by the adapted metadata 1472. In addition, the control signal 1444 and/or the rendering parameters 1449 may further have an impact on the reconstruction and rendering 1440, and may, for example, vary entries of matrixes used by the reconstruction and rendering.

The audio processor 1400 also comprises a metadata adaptation 1470, which may, for example, correspond to the metadata adaptation 1370. Thus, the metadata adaption 1470 may, for example, adapt metadata 1424 provided by the decoding 1420 in dependence on the time scale modification (e.g., in dependence on a control signal 1447), to thereby obtain the adapted metadata 1472. Accordingly, the metadata may fit the time scaled modified transport channels 1432, such that the reconstruction and rendering 1440 provides reconstructed (and/or rendered) output channels 1412 with good audio quality.

However, in contrast to the audio processor 1300, the audio processor 1300 does not comprise a playout speed control, but rather comprises a jitter buffer control 1480. Moreover, the audio processor 1400 may further comprise a packet handling 1490. In the following, the functionality of the packet handling 1490 and of the jitter buffer control 1480 will be described. It should be noted that the audio processor 1400 may receive incoming real-time transport protocol packets (RTP packets) 1492. The incoming real time transport protocol packets 1492 may, for example, be obtained from a storage medium or may, for example, be provided to the audio processor 1400 via a wired or wireless data connection, like a TCP/IP network (or any other data communication network). For example, the incoming RTP packets may be subject to a timing jitter, which may be caused, for example, by variations in a delay of a communication network via which the RTP packets are transported to the audio processor 1400. The audio processor 1400 comprises a real time transport protocol depacker 1493, which receives the real time transport protocol packets and extracts a packet payload from the real time pay load packets. The real time transport depacker 1493 therefore receives the incoming RTP packets 1492 and provides, on the basis thereof, a packet payload 1494. The packet payload 1494 may, for example, comprise IVAS frames, for example, an encoded representation of frames according to the IVAS standard. The audio processor 1400 also comprises a de-jitter buffer 1495 which receives the payload information and which is capable to buffer the (depacketized) payload information (e.g., IVAS frames). Thus, the de-jitter buffer 1495 provides buffered payload information 1496 to the decoding 1420. For example, the de-jitter buffer 1495 may be configured to receive payload information 1494 at a rate at which the payload is de-packetized and may provide buffered payload information 1496 to the decoding 1420 at a rate that is required (or can be processed) by the decoding 1420. Thus, the de-jitter buffer 1495 may receive an IVAS frame when the IVAS frame is de-packetized from the RTP packet, and may provide this IVAS frame to the decoding 1420 when said IVAS frame can be processed (or should be processed) by the decoding 1420.

The jitter buffer control 1480 may control the de-jitter buffer 1495, the multi-channel time scale modification 1430 and may also control the reconstruction and rendering 1440, as well as a parameter adaptation 1470. For example, the jitter buffer control 1480 may comprise a network jitter analysis and target delay estimation 1481, which may, for example, receive a timing information 1493a from the RTP depacker. For example, the timing information 1493a may describe when RTP packets arrive at the depacker 1493 and/or when different payload information (e.g., different IVAS frames) arrive at the RTP depacker (or when said payload information can be output to the de-jitter buffer 1495). In other words, the information 1493a may be any information which is usable for obtaining an information about a network jitter and which may be helpful to estimate a target delay. Thus, the jitter buffer analysis 1481 may, for example, determine a network jitter and may, for example, obtain an information about an (desired) average de-jitter buffer fullness (i.e., information indicating how many units of payload information should be buffered in the de-jitter buffer 1495 on average).

For example, the jitter buffer control 1480 may comprise an adaptation control logic 1483, which receives a network jitter analysis result 1482 from the network jitter analysis 1481. Moreover, the jitter buffer control 1480 may comprise a playout delay estimator 1484 which may receive a buffer fullness information 1485 from de-jitter buffer 1495 and which may also receive the time scaling information 1436 from the multi-channel time scale modification 1430.

Accordingly, the playout delay estimator 1484 may, for example, determine or estimate a playout delay and provide a playout delay information 1486 to the adaptation control logic 1483. The adaptation control logic 1483 may, for example, receive the network jitter analysis result information 1482 from the network jitter analysis 1481 and the playout delay information 1486 from the playout delay estimator 1484 and provide the control signals 1434, 1444 and 1447 for the multi-channel time scale modification 1430, for the reconstruction and rendering 1440 and for the metadata adaptation 1470. In addition, the adaptation control logic 1483 may provide a control signal 1487 to the de-jitter buffer 1495.

Accordingly, the jitter buffer control 1480 may receive an information about a network jitter, an information about a de-jitter buffer fullness, an information about an actual time scale modification and possibly additional information. On the basis of this information, the jitter buffer control 1480 may be able to determine a playout delay and may also be able to determine how many payload units (e.g. IVAS frames) should advantageously be stored in the de-jitter buffer 1495 to allow for an uninterrupted provision of the reconstructed output channels 1412 even in view of an expected network jitter. For example, the jitter buffer control 1480 may be able to effect a compensation of short-time jitter by appropriately controlling the de-jitter buffer 1495. However, the jitter buffer control 1480 may also be configured to adapt the time scale modification, e.g. in order to handle jitter on a longer time scale. Furthermore, the jitter buffer control 1480 may control the metadata adaptation and the reconstruction and rendering to be well-adapted to possible time scale modifications.

However, it should be noted that details regarding the functionality of the jitter buffer control may deviate from the above-described functionalities.

To conclude, the audio processor 1400 allows for a compensation of network jitter using a de-jitter buffer 1495 and also using a multi-channel time scale modification 1430. The jitter buffer control 1480 may be configured to control both the de-jitter buffer 1495 and the multi-channel time scale modification 1430 to adapt a speed at which reconstructed output channels 1412 are provided to the network jitter. The de-jitter buffer 1495 may be used to compensate for short-term network jitter, and the multi-channel time scale modification 1430 may be used to compensate for variations of the network delay on a longer time scale and it may possibly also be used in case that an encoder provides incoming RTP packets 1492 at a different rate than they are required by the audio processor 1400. In particular, the fact that the multi-channel time scale modification 1430 is in between the decoding 1420 and the reconstruction rendering 1440 allows for an efficient time scale modification without introducing significant and audible artifacts.

Moreover, it should be noted that any of the advantages discussed herein with respect to the other audio processors also apply to the audio processor 1400.

It should also be noted that the audio processor 1400 may optionally be supplemented by any of the features, functionalities and details disclosed herein, both in individual and technical combination.

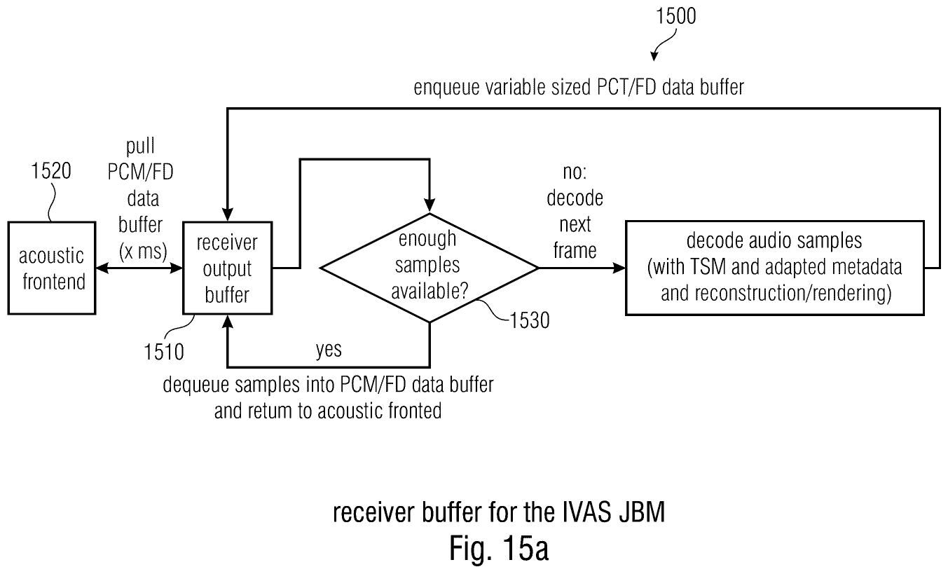

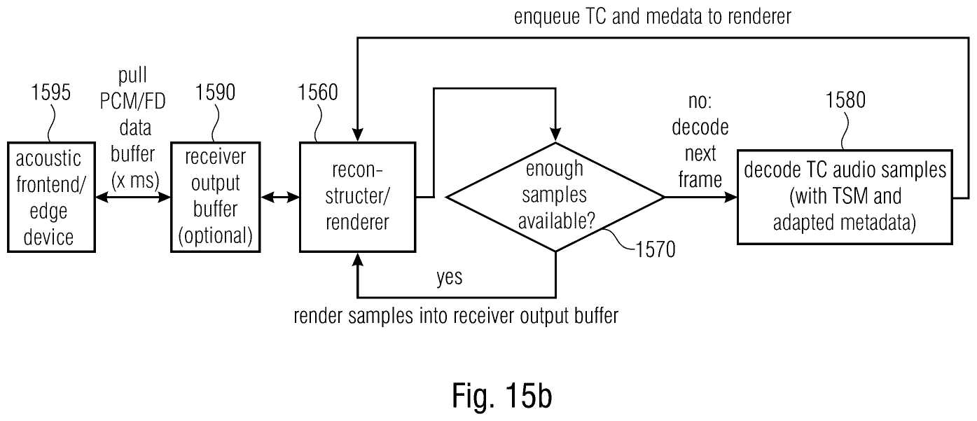

### 11. Receiver Buffer According to FIGS. 15a and 15b

FIG. 15a shows a schematic representation of an operation of a receiver buffer for the IVAS JBM (IVAS jitter buffer management). It should be noted that the jitter buffer management according to FIG. 15a may optionally be used in any of the embodiments according to the invention disclosed herein.

It should be noted that the jitter buffer management may be configured to control a receiver output buffer 1510, as well as a decoding, a time scale modification and the data exchange between the receiver output buffer 1510 and the acoustic frontend 1520. For example, the control may comprise checking 1530 whether enough samples are available (e.g. whether enough samples are included in the receiver output buffer to transfer a block of samples (e.g. sample values associated with an audio frame) to the acoustic frontend 1520). If it is found that enough samples are available, the control comprises dequeuing samples into a PCM/FD data buffer and returning (e.g. the samples) to the acoustic frontend. For example, if it is found that there are enough samples available in the receiver output buffer 1510, these samples may be transferred into a transmission data buffer (e.g. a PCM/FD data buffer) for a transmission to the acoustic frontend 1520. For example, the acoustic frontend 1520 may then pull PCM/FD data from said PCM/FD data buffer. For example, the acoustic frontend 1520 may pull time domain values or frequency domain values of a (processed) frame or subframe from the PCM/FD data buffer for a further processing (and advantageously for an output of an audio content to a user).

However, if it is found, in the check 1530, that there are not enough samples available (e.g. in the receiver output buffer), the control initiates a decoding of a next frame (for example, a next frame from the jitter buffer). For example, the decoding may comprise a decoding of audio samples (with time scale modification and adapted metadata and reconstruction/rendering). Accordingly, variable-sized PCM/FD data (or, alternatively, fixed size PCM/FD data) may be enqueued in a data buffer (e.g. in the receiver output buffer). Thus, for example, if the enqueued (e.g. variable sized) PCM/FD data comprise enough samples, the samples may be transferred to the acoustic frontend 1520 (e.g. via the PCM/FD data buffer).

To conclude, the provision of samples in the receiver output buffer and/or in the PCM/FD data buffer may comprise a decoding and may also comprise a time scale modification. Optionally, the processing may also comprise an adaptation of metadata and a reconstruction/rendering.

Moreover, it should be noted that the mechanism according to FIG. 15a may optionally be introduced into any of the embodiments disclosed herein.

FIG. 15b shows a schematic representation of an operation of a jitter buffer management or of a control mechanism, according to another embodiment of the present invention. The jitter buffer management (or control mechanism) described here can, for example, be used in combination with a buffer for the IVAS JBM (IVAS jitter buffer management).

It should be noted that the operation of the jitter buffer management (or of the control mechanism) is based on the assumption that there is a decoding of transport channels and a time scale modification of the decoded transport channels. It is further assumed that a reconstructer/renderer 1560 follows the time scale modification, and that the reconstructer/renderer comprises an input buffer which buffers, for example, time scale modified transport channels, or that there is a buffer in between the time scale modification and the reconstructer/renderer to buffer time scale modified intermediate audio signals.

For example, the jitter buffer management (or the control mechanism) comprises checking 1570 whether enough samples are available to perform a reconstruction/rendering (wherein the reconstruction/rendering may, for example, operate in a block-wise manner and therefore may require blocks (e.g. frames or subframes) of time scale modified transport channels. The checking 1570 may, for example, be performed at a time when it is desirable to provide new reconstructed/rendered values, e.g. for an output (or transmission) to an acoustic frontend and/or an edge device. If it is found that there are enough samples available (e.g. in an input buffer of the reconstructer/renderer, or in a buffer in between the time scale modification and the reconstructer/renderer), a reconstruction/rendering is performed (e.g. triggered by the control mechanism), which provides samples that may be entered into an optional receiver output buffer 1590, or that may be provided directly (e.g. without a buffering) to an acoustic frontend or to an edge device (e.g. via an interface) 1595.

If, however, it is found, in the check 1570, that there are not enough samples available to perform a (e.g. block-wise) reconstruction and/or rendering (e.g. by the reconstructer/renderer 1560), the jitter buffer management (or the control mechanism) may, for example, trigger a decoding of a next frame, e.g. a decoding 1580 of transport channel audio samples (e.g. together with or followed by a time scale modification, e.g. of the decoded transport channels, and a determination of adapted metadata). As a result of the decoding 1580 and the following time scale modification, samples of one or more time scale modified transport channels are available and are entered into an input buffer of the reconstructer/renderer or into a buffer that is arranged between the time scale modification and the reconstructer/renderer. Moreover, adapted metadata may also be provided, if such adapted metadata are required. Accordingly, the reconstructer/renderer 1560 can perform a reconstruction and/or rendering on the basis of the buffered samples and taking into account the adapted metadata (if required), to thereby provide one or more reconstructed and/or rendered audio signals that can be entered into the (optional) receiver output buffer 1590, or that can be provided (directly, without a buffering) to the acoustic frontend or edge device 1595. For example, in the presence of the receiver output buffer 1590, the acoustic frontend 1595 may then pull PCM/FD data from said receiver output buffer. For example, the acoustic frontend 1595 may pull time domain values or frequency domain values of a (processed) frame or subframe from the receiver output buffer for a further processing (and advantageously for an output of an audio content to a user). However, in the absence of the receiver output buffer, the reconstructer/renderer may provide (e.g. transmit or push) the processed frame or subframe to the acoustic frontend/edge device 1595.

To conclude, the reconstructer/renderer can provide the reconstructed and/or rendered audio signals when they are needed by the acoustic frontend or by the edge device. Since the time scale modification is performed before the reconstruction/rendering, the time scale modification does not cause a variable delay between the reconstruction/rendering and the playout of the reconstructed and/or rendered audio signals. Accordingly, in the case that motion parameters are considered by the reconstruction/rendering, a variable motion-to-audio delay can be avoided. Also, the receiver output buffer may optionally be omitted, since (in the presence of a sufficient frame buffer, e.g. before the decoding), it is possible to request a provision of (time scale modified) decoded transport channels whenever needed.

To conclude, the control mechanism of FIG. 15b is an advantageous solution.

Moreover, it should be noted that the mechanism according to FIG. 15b may optionally be introduced into any of the embodiments disclosed herein.

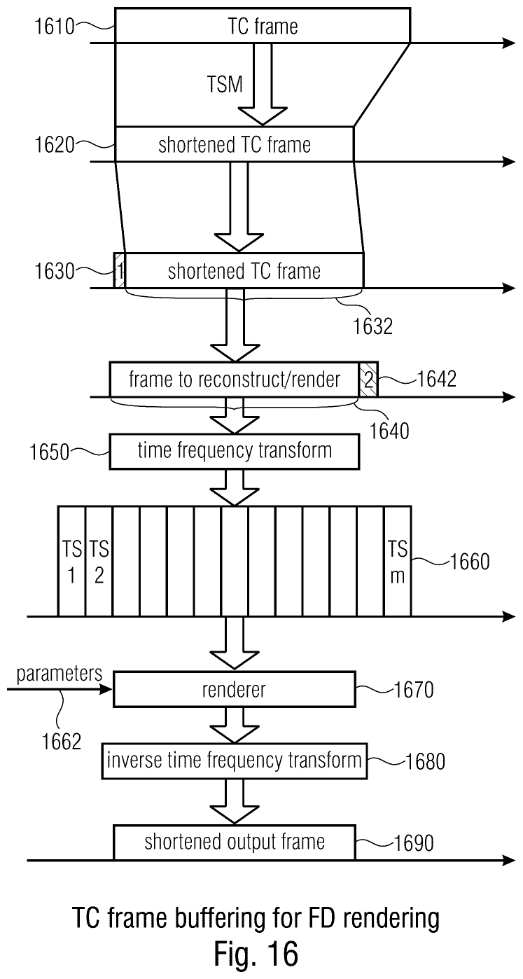

### 12. Transport Channel Frame Buffering for FD Rendering According to FIG. 16

FIG. 16 shows a schematic representation of a transport channel frame buffering for FD rendering, according to an embodiment of the invention.

An original transport channel frame, which may be provided by a decoding (e.g. by the decoding 1320 or by the decoding 1420) is shown at reference numeral 1610. A time scale modification is applied to the original transport channel frame (which may be considered as an intermediate audio signal). For example, the time scale modification 1330 or the time scale modification 1430 may be applied. Accordingly, a shortened transport channel frame 1620 is obtained. For example, the shortened transport channel frame 1620 may be considered as a time scale modified intermediate audio signal.

Assuming that one or more time domain samples of the previous frame (associated with the previous frame) had not been processed before (e.g. because they did not fit into the frame grid or subframe grid of the reconstruction and rendering 1340, 1440), these one or more samples of the previous frame, which are designated with 1640, are appended at the beginning of the shortened transport channel frame 1620, thereby resulting in a portion 1632 of samples (which may be time domain samples or frequency domain samples). In other words, the portion 1632 comprises the one or more buffered samples 1630 of the previous frame and the samples of the current shortened (time scale modified) transport channel frame 1620. Now, a frame of samples 1640 is selected from the portion 1632 of samples. For example, a length of the frame 1640 is determined by a size of a processing frame of the second processing following the time scale modification or as an integer multiple of a size of a subframe of the second processing. For example, the length of the frame 1640 (also designated as “frame to reconstruct/render”) may be determined by the number of samples required (or processed) in a processing step of the reconstruction and rendering 1340, 1440, and may, for example, be an integer multiple of this number of samples.

However, if the portion 1632 of samples comprises more samples than the frame 1640, which is input into the reconstruction and rendering 1340, 1440, one or more samples 1642 are buffered for a later processing together with samples of the subsequent frame (and insofar correspond to the buffered samples 1630). Accordingly, by using the one or more buffered samples 1630, and by setting the size of the frame 1640 in accordance with the requirements of the reconstruction and rendering 1340, 1440, a reconstruction and rendering can be performed efficiently even in the presence of a time scale modification. For example, a time frequency transform (or time-domain-to-frequency-domain transform) (shown at reference numeral 1650) may be applied to the frame 1640, and may provide a frequency domain representation of the frame 1640, for example for a number of time slots which are shown at reference numeral 1660. For example, the frequency domain representation shown at reference numeral 1660 may be input into a renderer 1670, which may also receive one or more rendering parameters or other parameters 1620. The renderer may, for example, provide a frequency domain representation of reconstructed output channels. An inverse time frequency transform (e.g. frequency-domain-to-time-domain transform) 1680 may be applied to the frequency domain representation (e.g. of reconstructed output channels or of rendered output channels) provided by the renderer 1670 to thereby obtain a time domain representation of a “shortened” output frame, which is shown at reference numeral 1690.

To conclude, in the processing shown in FIG. 16, a frame 1640 (e.g. of time domain samples) may be obtained, which may be input into a time-frequency-transform 1650. The length of the frame 1640 may, for example, fit a processing grid of the time-frequency-transform 1650, such that the time-frequency-transform 1650 can provide an appropriate frequency domain representation 1660 of the frame 1640. This frequency domain representation 1660 may be input into a renderer, which performs a rendering in the frequency domain. A result of the rendering 1670, which is performed in the frequency domain, will then be transformed back to the time domain, to obtain a time domain representation of the rendered (and/or reconstructed) output channels.

However, it should be noted that the buffering and the selection of time domain samples for the time-frequency-transform 1650 may, for example, be performed by a stage which may be arranged between the time scale modification and the actual reconstruction/rendering. Worded differently, the concept as explained with respect to FIG. 16 may optionally be performed by any of the audio processors disclosed herein.

It should be noted that, in the processing of FIG. 16, a length of the frame 1640 is advantageously chosen such that the frame length fits to an original processing grid (e.g. subframe grid) of the subsequent processing (e.g. of the time-frequency-transform 1650 and/or of the renderer 1670). Thus, the length of the frame 1640 may be chosen such that the number of time slots, which are provided to the time-frequency-transform 1650, is an integer multiple of a subframe size in terms of time slots. Consequently, the time-frequency-transform 1650 may, for example, run with a predetermined (e.g. fixed) transform length. However, by adapting the length of the frame 1640 in such a manner that the time-frequency-transform 1650 results in a number of time slots that are an integer multiple of a predetermined subframe length (time slot), it may happen that a relatively large number of samples 1642 should be buffered for a later processing. Nevertheless, the possibility to perform the time-frequency-transform and the subsequent rendering with predetermined (e.g. fixed) framing (e.g. in terms of subframe size) may compensate for this issue.

Moreover, the processing shown in FIG. 16 may optionally be supplemented by any of the features, functionalities and details disclosed herein, both in an individual and technical combination.

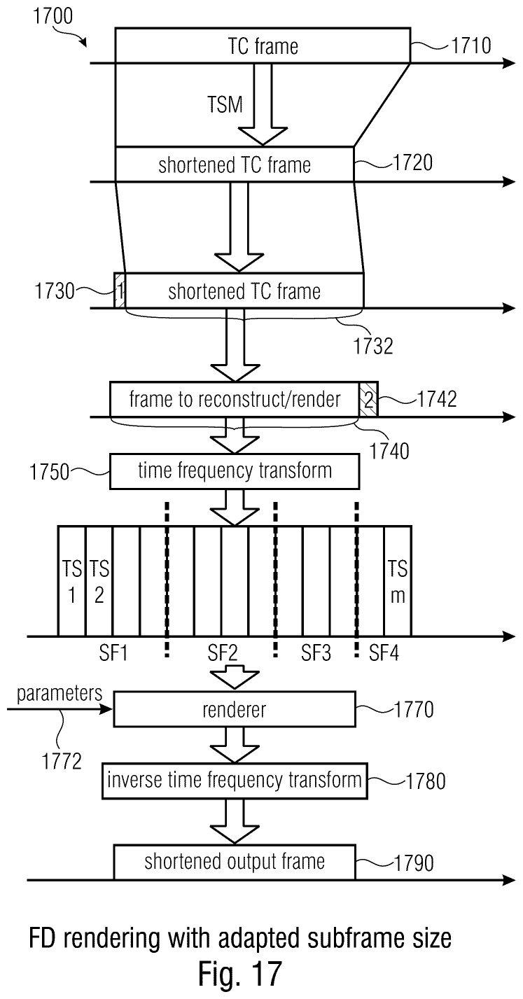

### 13. FD Rendering with Adapted Subframe Size According to FIG. 17

FIG. 17 shows a schematic representation of a frequency domain rendering with adapted subframe size, according to an embodiment of the invention. It should be noted that the processing shown in FIG. 17 may optionally be used in any of the audio processors disclosed herein.

The processing receives the transport channel frame 1710, which may, for example, be provided by a decoding. A time scale modification (e.g. as disclosed herein) provides a shortened transport channel frame 1720 on the basis of the (original) transport channel frame 1710, as described herein. The portion of sample values, which is designated with 1732, may comprise one or more buffered samples 1730 of a previous frame (e.g. associated with a previous frame) and the samples of the shortened transport channel frame 1720. A frame 1740 may be chosen from the portion 1732, wherein a length of the frame 1740 may, for example, can be chosen such that a time frequency transform 1750 can provide an integer number of time slots on the basis of the selected frame 1740. However, it should be noted that, in the processing 1700, the selection of the frame 1740 may not be bound to a predetermined frame grid or subframe grid of the subsequent processing (e.g. of the time-domain-to-frequency-domain transform). Thus, a number of samples of the frame 1740 may deviate from a number of samples required to operate using a “fixed” predetermined frame grid or subframe grid. Accordingly, a number of time slots for which the time frequency transform 1750 provides samples (or sets of samples) on the basis of the frame 1740 may be different from an integer multiple of an advantageous subframe length (in terms of time slots). However, the processing may adjust or subdivide the time portions, for which the time frequency transform 1750 provides transformed samples (or transformed sets of samples) to/into subframes of different lengths. For example, a first subframe SF1 may comprise four time slots, a second subframe SF2 may also comprise four time slots, a third subframe SF3 may comprise three time slots and a fourth subframe SF4 may comprise two time slots. Thus, the time-frequency-transform 1750 and/or the subsequent allocation of time slots to subframes can operate such that subframes of varying lengths are provided for the further processing. The subframes of varying lengths (e.g. SF1, SF2, SF3, SF4) may, for example, be input into a renderer 1770, which may, for example, receive one or more parameters 1772 and provide, on the basis of the subframes and the one or more parameters 1772, a frequency domain representation of rendered and/or reconstructed output channels. An inverse time-frequency-transform (e.g. a frequency-domain-to-time-domain transform) 1780 may be applied to the frequency domain representation of the rendered and/or reconstructed output channels provided by the renderer 1770, to thereby obtain time domain representations of the rendered or reconstructed output channels, which are shown at reference numeral 1790. For example, the time domain representation of the rendered and/or reconstructed output channels may be provided in the form of a shortened output frame.

To conclude, the time scale modification may result in a shortened transport channel frame which, for example, may be combined with one or more buffered samples of a previous frame. This portion of samples comprising the one or more buffered samples associated with a previous frame and the samples of the (current) shortened transport channel frame may then be used to provide subframes of varying lengths, wherein the usage of varying lengths of the subframes may allow to process a large number of the samples of the portion 1740 (while only a small number of samples 1742 need to be buffered for a later processing). The subframes of varying lengths (e.g. subframes SF1, SF2, SF3 and SF4 obtained by the time frequency transform 1750) may then be processed by the renderer 1770, and the result of the rendering, which is performed in the frequency domain, may then be transformed back to the time domain, to thereby yield rendered or reconstructed output channels (e.g. in the form of a shortened output frame 1790). Thus, the usage of subframes SF1, SF2, SF3, SF4 of varying lengths allows for a particularly good efficiency of the processing and also helps to keep latencies small. However, the processing is naturally somewhat more complicated when compared to a using fixed subframe lengths.

It should be noted that the processing as described with respect to FIG. 17 may optionally be used in any of the audio processors disclosed herein. It may also be noted that the processing of FIG. 17 may optionally be supplemented by any of the features, functionalities and details disclosed herein.

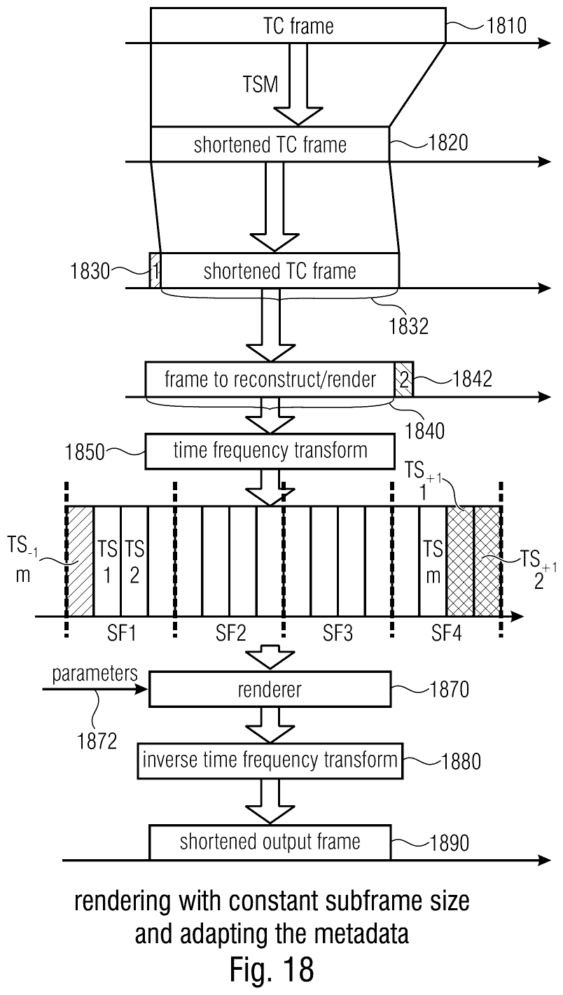

### 14. Rendering with Constant Subframe Size and Adapting the Metadata, According to FIG. 18

FIG. 18 shows a schematic representation of a rendering with constant subframe size and adapting the metadata. The processing is based on a transport channel frame 1810 and applies a time scale modification to the transport channel frame 1810 to obtain a shortened transport channel frame 1820. A portion of samples is obtained by combining one or more buffered samples 1830 associated with a previous frame with the samples of the shortened transport channel frame 1820. The portion obtained by this combination is designated with 1832. A frame 1840 is selected on the basis of this portion 1832, wherein the frame size of the frame 1840 may be chosen such that a time-frequency-transform 1850 provides an integer number of time slots on the basis of the frame 1840. Samples of the portion 1830, which are not included into the frame 1840, and which are designated with 1842, may be buffered for a subsequent processing, e.g. in combination with samples associated with the subsequent frame.

The time-frequency-transform 1850 provides a set of time slots on the basis of the selected frame 1840, for example, time slots TS1 to TSm. However, if the number of time slots is not equal to an integer multiple of a subframe size (in terms of time slots), one or more time slots of a previous frame (e.g. TS₋₁,m) and/or one or more time slots of a subsequent frame (e.g. times slots TS₊₁1 and TS₊₁2) are used to obtain subframes of equal length. For example, in the embodiment of FIG. 18, all subframes SF1, SF2, SF3 and SF4 may comprise four time slots each (wherein, for example, the first subframe comprises time slots TS₋₁,m, TS1, and TS2 and TS3, and wherein, for example, the last subframe may comprise samples TSm−1, TSm, TS₊₁1 and TS₊₁2). Thus, a corresponding (equal) subframe size may be obtained by using one or more time slots of a previous frame and/or one or more time slots of a subsequent frame to obtain the subframes.

The subframes may then be processed by a renderer 1870, wherein the renderer 1870 may, for example, use one or more parameters 1872. Moreover, an inverse time-frequency-transform (e.g. a frequency-domain-to-time-domain transform) 1880 may be applied to the frequency domain representation of reconstructed and/or rendered audio channels provided by the renderer 1870. Accordingly, a time domain representation of the reconstructed and/or rendered output channels may be obtained, which is designated with 1890.

Thus, a shortened output frame of reconstructed or rendered output channels may be obtained.

However, it should be noted that metadata, which are, for example, used by the renderer 1870, may be adapted to the time scale modification, as disclosed herein. Accordingly, a good hearing impression may be achieved, since the adapted metadata may well fit the frequency domain representation which is input into the renderer 1870 (wherein, for example, the metadata may fit to the subframes that are processed by the renderer 1870).

To conclude, the processing as shown in FIG. 18 may provide reconstructed and/or rendered output channels in an efficient manner, wherein the rendering is performed with a constant subframe size due to the above-mentioned composition of the subframes. A good hearing impression may be obtained by the adaptation of the metadata to the subframes.

However, it should be noted that the processing disclosed with respect to FIG. 18 may optionally be used in any of the audio processors or audio processing systems disclosed herein.

It should also be noted that the processing of FIG. 18 may optionally be supplemented by any of the features, functionalities and details disclosed herein.

### 15. Adaptation of the Interpolation Functions

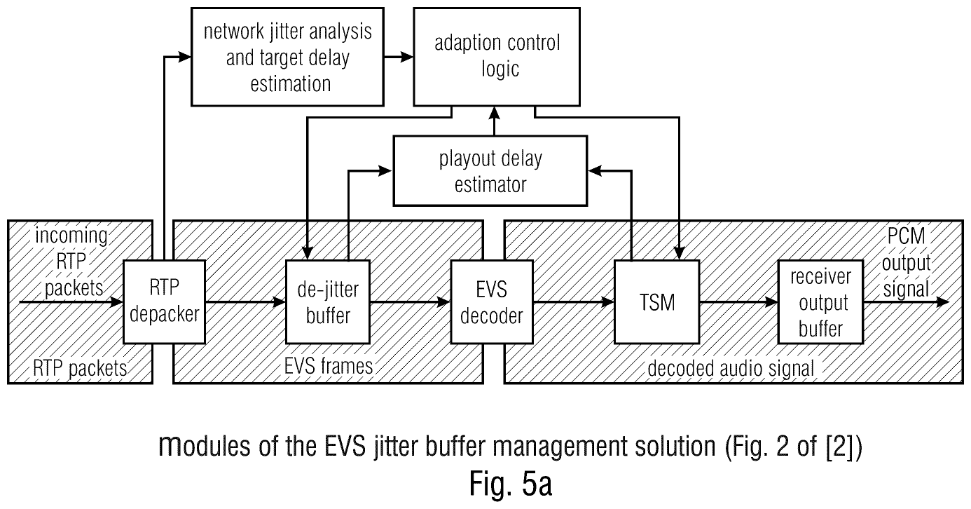

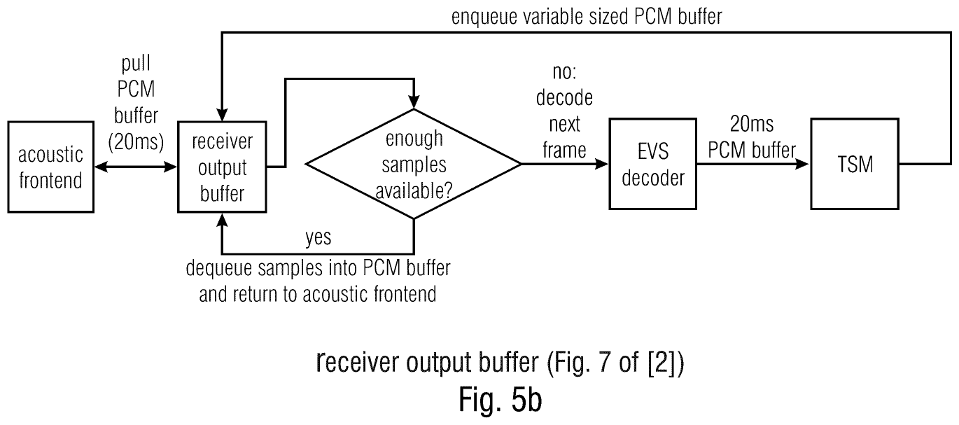

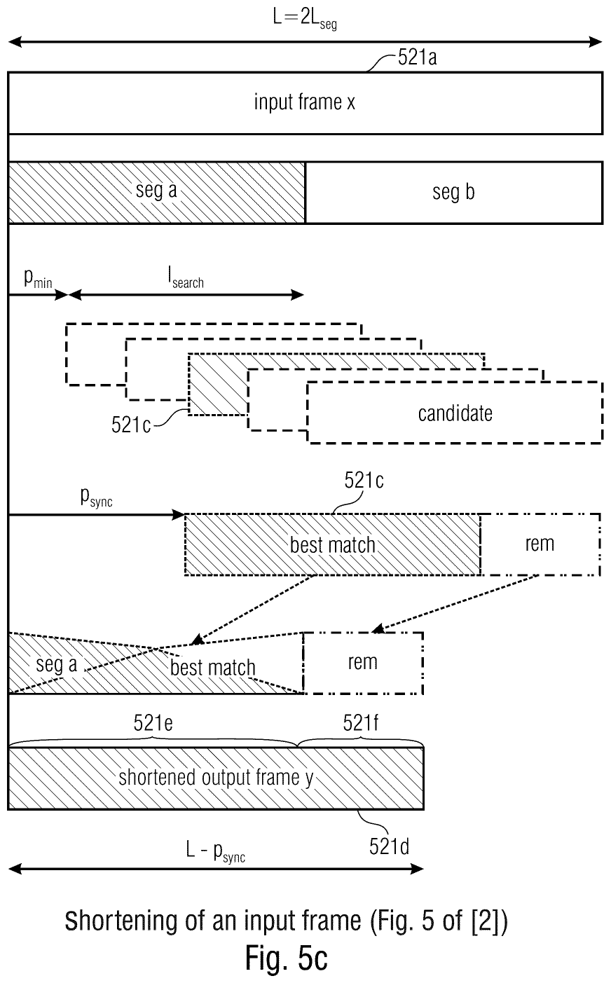

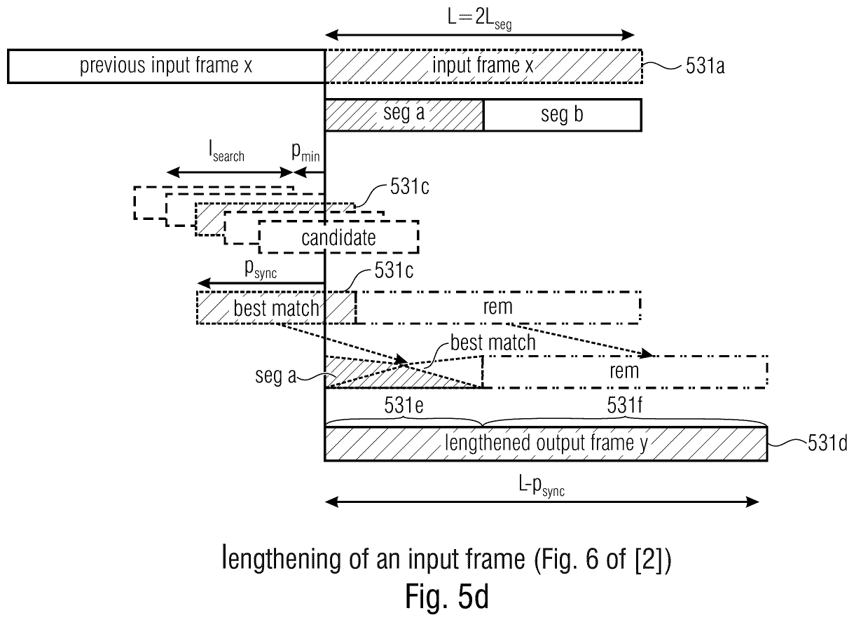

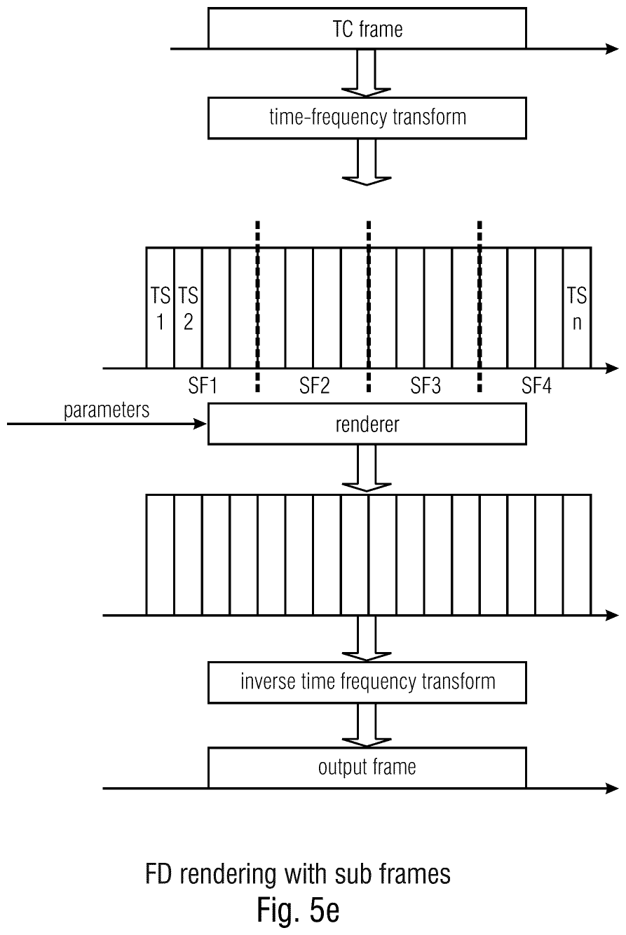

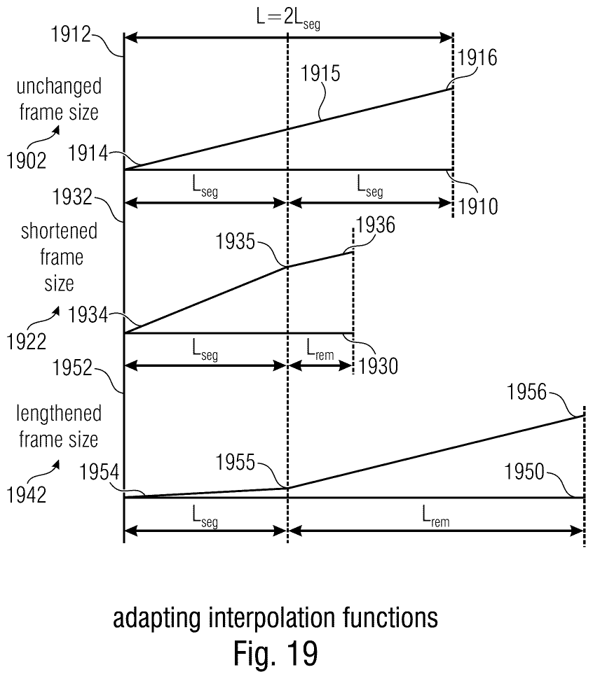

An adaption of the interpolation functions is illustrated in FIG. 19. Regarding this issue, it should be noted that the adaption of the interpolation functions, which is shown in FIG. 19, and which can be used in any of the embodiments disclosed herein, should be understood in combination with the concept for the shortening of a frame that is shown in FIG. 5c and also in combination with the concept for the lengthening of an input frame which is shown in FIG. 5d (wherein these concepts for shortening an input frame and for lengthening an input frame may optionally be used in the time scale modification described herein).

Taking reference now to FIG. 5c, it can be seen that an input frame may have a length of 2L_{seg}. The input frame (which may, for example, be a frame of the (original) intermediate audio signal) may be subdivided (at least logically) in a first portion (SEG A) and a second portion (SEG B). However, starting from a positional pₘᵢₙ within the input frame, a search may be performed to identify a portion of the input frame which can be best overlapped-and-added with the portion SEG A. In this search, a plurality of candidate portions may be considered, and a cross-correlation between a respective candidate portation and the portion SEG A may be used as a criterion the identify a portion which can be best overlapped and added. A portion that has been identified to have a sufficiently good (or best) overlap-and-add with the portion SEG A, which is designated with 521c, and the rest of the input frame 521a, which is designated with “REM”, are used to obtain the output frame 521d. For example, the identified portion 521c (which is also designated with “best match”) will be overlapped-and-added with the portion “SEG A” of the input frame 521a. Thus, a start portion 521e of the shortened output frame 521d will be formed by an overlap-and-add of the portion “SEGA” and of the identified “best match” portion 521c. An end portion 521f of the shortened output frame 521d may be formed by the remaining portion “REM” which follows the identified portion 521c. Thus, the shortened output frame 521d is a concatenation of a start portion 521e, which is obtained by an overlap-and-add operation (of portions SEGA and 521c), and of an end portion 521f (REM), which is an unmodified (end) portion of the input frame 521a. For example, it may be assumed that the portions “SEG A” and “SEG B” may both have a same length of L_{seg}. It is further assumed that the remaining portion “REM” has a length of Lᵣₑₘ. It can therefore be assumed that the shortened output frame 521d has a length of L_{seg}+Lᵣₑₘ, wherein the start portion of length L_{seg} is formed using an overlapped-and-add operation which effectively causes a shortening, while the end portion of length Lᵣₑₘ remains unchanged.

Taking now reference to FIG. 5d, a lengthening of an input frame will be described. It should be noted that an input frame 531a is assumed to have a length of 2 L_{seg}. The input frame 531a is, for example, (at least logically) divided in a first segment “SEG A” and a second segment “SEG B”. Now, a plurality of candidate portions are selected, which comprise one or more samples of a previous input frame preceding the current input frame 531a and which are consequently partly or fully located in the previous input frame. Accordingly, a “best match” portion 531c is selected, which is judged to give a best possible (or at least sufficiently good) overlap-and-add with the first portion “SEG A” of the input frame 531a. Accordingly, a remaining portion “REM” extends from an end of the identified portion 531c up to the end of the current input frame 531a. Thus, the remaining portion may, in some cases, even be longer than the input frame 531a, but may also be shorter than the input frame 531a. However, the remaining portion will typically be longer than Lseg.

Accordingly, a start portion of the lengthened output frame 531d is obtained using an overlap-and-add of the portion “SEG A” of the input frame 531a and of the identified “best match” portion 531c. Furthermore, the remaining portion “REM” is appended after the overlap-and-add region, to thereby obtain the lengthened output frame 531d. Accordingly, the lengthened output frame 531d is a concatenation of an overlap region, in which the portion “SEG A” and the identified portion 531c are overlapped-and-added, and of the remaining portion “REM”. Thus, a length of the shortened output frame 531d is equal to a sum of a length L_{seg} (which is the length of the overlap-and-add portion) and a length Lᵣₑₘ, which is the length of the remaining portion. Since the length of the remaining portion is typically longer than L_{seg} in the case of the lengthening of an input frame, the total length is typically larger than 2 L_{seg}. Accordingly, the lengthened output frame 531d is longer than the input frame 531a, wherein a good quality of the lengthened output frame 531d is achieved by selecting the identified portion 531c or for example, in dependence on a cross-correlation between a plurality of candidate portions and the segment “SEG A”.

To conclude, a start portion 531e of length L_{seg} is obtained using an overlap-and-add operation, and an end portion 531f of the lengthened output frame 531d remains unchanged.

Regarding the concept of FIGS. 5c and 5d, it should be noted that the length of the remaining portion, Lᵣₑₘ, is determined by characteristics of the audio signal and is therefore not a quality that can exactly be predetermined by a control providing an information but a desired time scale modification.

Taking reference now to FIG. 19, interpolation function which may be used for the determination of the adapted parameters, will be described. For the case of an unchanged frame size, the frame may have a length of 2 L_{seg}, wherein the temporal extension of the frame is show in an abscissa 1910. An ordinate 1912 describes a value of the interpolation function. It can be seen that in the case of an unchanged frame size, which is shown at reference numeral 1902, interpolation function extends linearly from a value of 0 (show as reference numeral 1914) to 1, (as shown at reference number 1916). It should be noted that the interpolation function is a straight linear function, which is shown at reference numeral 1915.

However, in the case of a shortened frame size, which can be obtained using the concept of FIG. 5c, a frame length is equal to L_{seg}+Lᵣₑₘ, and is shorter than 2 L_{seg}. This situation is shown at reference numeral 1922. An abscissa 1930 describes the temporal extension of the shortened frame. An ordinate 1932 describes a value of the interpolation function. However, it can be seen that the interpolation function increases from 0, which is shown as reference numeral 1934, to a first value which is smaller than 1, and in which is shown at reference numeral 1935, during the start portion of length L_{seg} of the shortened frame. Moreover, the interpolation function increases from the first value (shown at reference numeral 1935) to an end value of 1, which is shown at reference numeral 1936, during the end portion of length Lᵣₑₘ of the shortened frame. It becomes apparent that a slope of the interpolation function is larger in the start portion of the shortened frame (e.g., in the start portion 521e of the shortened frame of length Lseg) when compared to the slope in the end portion (e.g., in the end portion 521f) of the shortened frame of lengths Lᵣₑₘ. It becomes apparent that the slope (of the interpolation function) is larger in the start portion 521e in which the overlap-and-add operation is performed when compared to the end portion 521f of the shortened frame.

A different situation appears for the case of a lengthened frame size. The case of the lengthened frame size is shown at reference numeral 1942. The lengthened frame comprises a length of L_{seg}+Lᵣₑₘ, wherein Lᵣₑₘ is larger than L_{seg}, and wherein a length of the lengthened frame is larger than 2 L_{seg}. A temporal extension of the lengthened frame is shown at an abscissa 1950. A value of the interpolation function is shown in an ordinate 1952. It can be seen that in the start portion (e.g., in the start portion 531e) of the lengthened output frame, in which the overlap-and-add is performed, the slope of the interpolation function is smaller than in the end portion of the lengthened output frame (e.g., in the end portion 531f). For example, the interpolation function may start at a value of zero, which is shown at reference numeral 1954, and increase up to a first value, which is shown at reference numeral 1955 during the start portion of length Lseg. The interpolation function may then increase up to an end value of one, which is shown in reference numeral 1956, during the end portion (of length Lren) of the lengthened output frame. In other words, the slope of the interpolation function is small in the portion in which the overlap-and-add, which effects the lengthening, is performed, and the slope of the interpolation function is larger in the remaining portion, which is unmodified. However, it has been found that such an adaption of the interpolation function brings along a good interpolation of processing parameters, that results in a good audio quality.

### 16. Further Aspects and Embodiments

In the following, further aspects and embodiments according to the invention will be described, which can be used individually and taken in combination with the other features, functionalities and details described herein.

In other words, it should be noted that the embodiments described in the following may be used individually, or may be supplemented by any of the features, functionalities and details discloses herein.

On the other hand, any of the embodiments disclosed herein may optionally be supplemented by any of the features, functionalities and details disclosed in this section.

### Top Level

According to an aspect of the invention, the main idea of the invention is shown in FIG. 9, where an audio processor with multiple processing stages has a time scale modification performed on one of the intermediate audio signals.

In an embodiment (FIG. 10), processing parameter are used in each processing step.

In another embodiment (FIG. 11), a common time scaling controller is present, that controls the time scaling modification itself, and based on the outcome of the time scaling, adapts the processing steps to the time scaling modification.

In another embodiment (FIG. 12), the time scaling controller also controls the adaptation of the processing parameters of each processing step.

### Audio Coded Playout Speed Control

FIG. 13 shows a block diagram of a playout speed control based on the invention. Communication Codec JBM

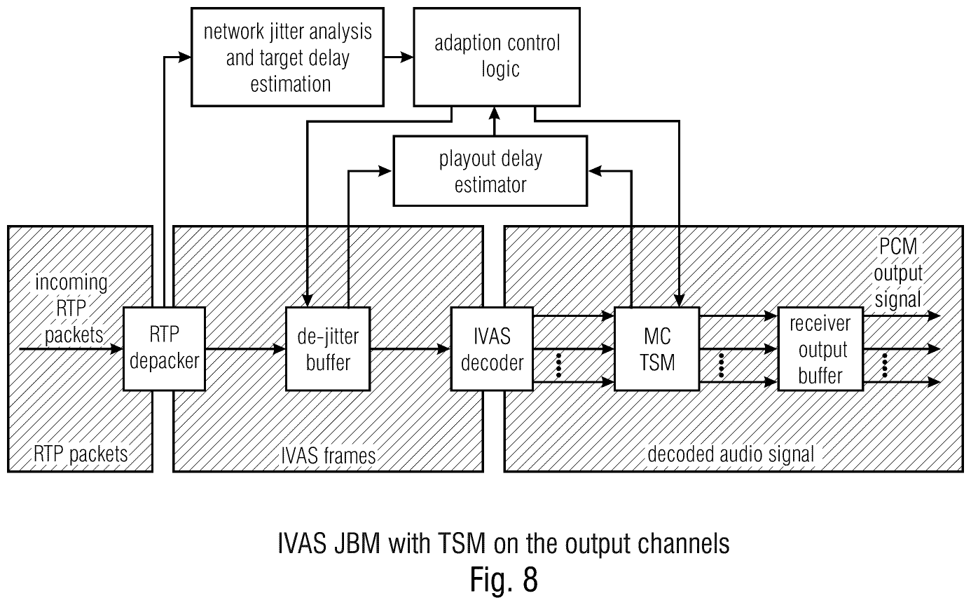

FIG. 14 shows a block diagram of a JBM for a communication codec based on the invention. For example, among other features, the difference and inventive step compared to the methods depicted in FIG. 2 and FIG. 8 lie within the Decoded Audio Signal block and in the way the adaption control logic steers the processing blocks. The adaption control logic is, for example, an embodiment of the time scaling controller mentioned previously. As mentioned in the conventional technology overview a communication codec like IVAS the decoded audio signal is reconstruction (or reconstructed) by decoding transport channels and associated metadata and reconstructing the output channels in a reconstructing/rendering stage which uses the transport channels, the associated metadata and optionally additional rendering parameters from outside.

According to an aspect, the invention, instead of applying the TSM controlled by the jitter buffer control on the reconstructed output channels applies it on the decoded transport channels. For example, depending on the Jitter Buffer control the decoded frames of the transport channels can be shortened or lengthened or kept as is. For example, if the number of transport channels is larger than one, the TSM is configured to apply the same time scale modification on all transport channels in a synchronized manner, for example, to ensure that the length of the resulting time scaled modified transport channels put into the renderer have the same duration in time and the same modification over time.

Additionally, for example, the Jitter Buffer Control also controls the Metadata adaption in such a way that optional metadata associated with the transport channels is adapted to the changed duration of the time scale modified transport channels.

According to an aspect, for some possible transported formats there is no metadata needed to reconstruct the encoded format, in this case the transport channels already represent the encoded format. If, in this case, the desired output format is, for example, also equivalent to the encoded format, the renderer will not be needed and the transport channels already represent the output channels, and the renderer block is skipped or can be seen as simple pass-through block.

FIG. 15a shows a possible (optional) Receiver buffer handling for the invention. The receiver output buffer, compared to FIG. 2 should be able (or, in some cases, even needs to be able) to hold a plurality of output channels. A use case for such a codec is, for example, a split processing of the decoded signal, i.e., part of the decoding and rendering is done on one device and the remaining part on another linked device, e.g., a handheld device as first device and a so-called edge device as the second device, where the final rendering and acoustic frontend are situated (e.g., glasses for augmented/virtual reality). In this case, the Receiver output buffer can, for example, be configured to provide either PCM samples or samples of the frequency domain representation of the requested output format (e.g., as samples in the CLDFB domain). Also, the duration of the segments requested from the receiver output buffer may, for example, not be the duration of the decoded frames but an integer fraction of this duration.

FIG. 15b shows an alternative implementation of the buffer handling. For details, reference is made to the above description.

### Buffering of TSM Transport Channels Lor FD Reconstruction/Rendering

For example, the renderer can be either a time-domain based renderer or a renderer applied on a time-frequency transformed representation of the transport channel, e.g., employing a Complex Low Delay Filter Bank (CLDFB). Time frequency transforms typically (but not necessarily) have a time resolution that is smaller than the time resolution of the time domain signal, i.e., the time signal is, for example, divided into slots of finite duration where, for example, each slot is transformed into the frequency representation of this slot using the time frequency transform.

The TSM module can, for example, produce a duration of the modified (e.g. time scale modified) frame that is not an integer multiple of the slot size of the TF-Transform (e.g. time-frequency transform). Therefore, is advantageous to just pass the number of samples to the FD renderer (e.g. frequency-domain renderer) that represent the largest possible number of slots. For example, any excessive samples are buffered and prepended to the TSM modified transport channels of the following frame. In other words, the time domain samples put into the FD renderer comprise the buffered samples of the transport channels from the preceding frame, the samples of the TSM transport channels of the current frame, shortened to the largest possible number of FD slots based on the sum of the length of the buffered samples and the length of the TSM transport channel samples of the current frame. In overall this results in possible a small mismatch with the associated metadata, but since the time resolution of the metadata is typically smaller than the time resolution of the TF transform, i.e., for example, one set of metadata parameters is associated to several slots of the FD representation of the transport channels the impact on the quality of the reconstructed and rendered output channels is minimal.

FIG. 16 shows, for example, the process flow for this embodiment, the example is for a shortened frame, for a lengthened TC frame the processing is done analogously. The TC frame is, for example, processed by the TSM, resulting in a shortened TC frame. The complete available time domain samples for the current frame are now, for example, constructed taking the buffered TC samples from the previous frame (1) and appending the shortened TC frame. The frame to be constructed is now, for example, taken as the portion on samples fitting in the largest possible number of TS (e.g. time slots) for the time-frequency transform and the possible remaining samples of the available samples (2) are, for example, buffered for use in the next frame. The remaining processing is then, for example, done in the already described way on the time-frequency domain transformed frame to reconstruct/render.

Note that, for example, for a renderer processing the decoded transport channel in the time domain, such a buffering is not necessary, and the complete time scale modified decoded transport channels frame can, for example, be rendered in the current frame.

The TSM operation in [2] contains a special mode (section 5.4.3.4) where for very silent frames the time scale modification does not operate in a quality-controlled manner but a maximum stretching or shrinking is performed. In an embodiment of the invention in the frames classified as silent the signal is, for example, not stretched or shortened to the maximum allowed values, but, for example, in such a manner that no samples of the transport channels need to be buffered in case of a FD renderer, i.e. the TSM (e.g. time-scale-modified) transport channels together with the buffered samples form a frame to be rendered that has a length that is an integer multiple of the time slot size of the time-frequency transform without excessive samples that need to be buffered. This results in an advantageous synchronization of the TSM transport channels with the frame border.

### Adapting the Reconstruction/Rendering

As stated in the reconstruction, the Metadata associated with the decoded transport channels might, for example, comprise several metadata sets, for example, each associated with a subframe of the decoded transport channels frame. In this case it will, for example, be advantageous to adapt the rendering and/or metadata accordingly to the time scale modification of the decoded transport channels. It is, for example, also advantageous to adapt certain internal parameters of a renderer to the applied TSM, e.g., interpolation steps.

### Rendering: Adapting the Sub Frame Size

In an embodiment, the size of the subframes, i.e., for example, the number of FD slots in the case of FD domain processing or the number of time domain samples in the case of time domain processing in the renderer comprising each one of the subframes within a frame, is adapted based on the time scale modification of the transport channels.

FIG. 17 shows an example of such an embodiment (in this case with FD/slot processing and the TSM leading to a shortened time scale modified transport channels frame). The parameters in the simplest case can be the unmodified parameters associated to the subframes of the decoded transport channels frame before the TSM. Since TSM typically (but not necessarily) involves overlap-and-add of different segments of the unmodified decoded transport channels in another embodiment it is, for example, advantageous to also adapt the metadata for subframes where overlap-and-add operations were done, e.g., by a linear combination of the metadata associated to the subframes of the unmodified decoded transport channels that are involved in the overlap-and-add process.

### Rendering: Keep Subframe Size Constant, Adapt Metadata

The proposed system may, for example, be asked to provide portions of the signal that are shorter in duration than the duration of one decoded frame (FIG. 15) and/or provide external parameters for the rendering (FIG. 14). The time resolution of dynamic external parameters, e.g., a listener orientation typically would, for example, have a time resolution equal to the subframes of the rendering. For these cases, also in the view of a motion-to-sound delay that is as small as possible, rendering with constant subframe size is advantageous.

FIG. 10 (or FIG. 16 or FIG. 18) shows an example of an embodiment that achieves this (the example is again for FD processing in the renderer with subframes). Differently to the previous embodiments with adapted subframe size the subframe size is, for example, not altered from the un-adapted case but, for example, the subframe grid is shifted, for example, according to previous time scale modifications and the time scale modification in the current frame.

In the Figure in the rendering step some slots from the first subframe were for example, already processed in the previous frame (indicated by hashed filling and time slots indicated by TS₋₁) and the first subframe is, for example, shortened by that number or in other words is the number of slots that still are needed to be processed to conclude this subframe. For example, the following subframes have the constant size. The last subframe in the frame can, for example, exceed the frame size to process, so, for example, only the number of slots fitting within the frames are processed and the number of slots of this subframe that still need to be processed is buffered for the next frame.

For example, in general, the number of subframes can now differ from the number of subframes for a frame where no TSM was applied. Therefore, it is, for example, advantageous to adapt the metadata to the different number of subframes and/or the applied time scale modification, e.g. by a linear combination for subframes where overlap-and-add processing was applied in the TSM and/or a linear interpolation of parameter set over the new number of subframes. A further advantage is the embodiment is that, for example, the optional external parameters for the renderer that have the same time resolution as the subframe processing do not need to be adapted and can be used directly.

Note that for all examples for embodiments showing FD reconstruction/rendering and shortening TC frames with TSM, examples with frame lengthening and/or time domain rendering follow straightforward.

### Processing Parameter and Metadata Adaption Implement Tails for the IVAS JBM

### Adapting Interpolation Functions for Full Frames

Some IVAS technologies (e.g. Parametric Multichannel, Object Based Audio Coding) only have one set of metadata per frame, so in this cases an adaption of the metadata itself to the time scale modification is not necessary. In the reconstruction and rendering those formats typically (but not necessarily) generate a mixing rule (e.g. a reconstruction/rendering rule or matrix) (e.g. a mixing matrix) M for the current frame and together with the mixing matrix Mₚᵣₑᵥ generate the rendered output signal by using linear interpolation between the current and previous mixing rule. For example, the mixing matrices can either be a single broad band mixing rule for time domain processing or a band dependent rule for processing in the frequency domain. So for a frame with unchanged length the time domain output signal in case of a time domain processing is:

$$y [ n ] = ( g [ n ] M + ( 1 - g [ n ] ) {M}_{prev} ) x [ n ] , 0 \leq n < ( 2 {L}_{seg} - 1 )$$

Where x[n] are the transport channel samples at sample instance n (and possibly decorrelated versions of the transport channels), g[n] is the interpolator function and y[n] are the resulting output channel samples at sample instance n, and L_{seg} is half the length of the frame in samples.

Similar for frequency domain processing of an unchanged frame:

$${y}_{k} [ n ] = ( g [ n ] {M}_{k} + ( 1 - g [ n ] ) {M}_{k , prev} ) {x}_{k} [ n ] , 0 \leq n < ( 2 {L}_{seg} - 1 )$$

Where k denotes the band index of the used frequency representation and L_{seg} is half the number of frequency domain time slots in an unchanged frame and n the time slot index to process.

Generally the linear interpolator in this cases takes the form:

$$g [ n ] = \frac{n + 1}{2 {L}_{seg}}$$

Using the time scale modification from [2] we can see that, in some cases, we have a remaining part (rem in FIG. 3 and FIG. 4) is unchanged and the first part of length L_{seg} is an overlap-added version that is either generated with parts from the previous frame or a shortened of the current frame.

According to an aspect, it is therefore a favourable adaption of the interpolation function to keep the slope of the unadapted interpolator in the remaining part and adapt the section with overlap add (the first L_{seg} long part). Again here, if we employ, for example, the buffering of transport channels for keeping a certain time resolution we assume that the influence on the quality is small if we assume Lᵣₑₘ as:

$${L}_{rem} = {L}_{f} - {L}_{seg}$$

Where L_{f} is the length of the frame to be processed (and Lᵣₑₘ is, for example, no longer the real length of the remaining part of the transport channels after time scale modification)

This principle of adapting the interpolator is depicted in FIG. 19.

So in general, for example, the adapted interpolation function now has the form:

$${g}_{a} [ n ] = \{ \begin{matrix}\frac{n + 1 + ( {L}_{seg} - {L}_{rem} )}{2 {L}_{seg}} , {L}_{Seg} \leq n < {L}_{f} \\ ( n + 1 ) \frac{2 {L}_{Seg} + 1 - {L}_{rem}}{2 {L}_{seg} ( {L}_{seg} + 1 )} , 0 \leq n < {L}_{seg}\end{matrix}$$

Generally is, for example, favourable to restrict gₐ[n] to values ≥0:

$${g}_{a \cdot f} [ n ] = max ( 0 , {g}_{a} [ n ] )$$

So now the processing for the adapted frame for time domain processing is, for example:

$$y [ n ] = ( {g}_{a , f} [ n ] M + ( 1 - {g}_{a , f} [ n ] ) {M}_{prev} ) x [ n ] , 0 \leq n < {L}_{f}$$

And for frequency domain processing, for example:

$${y}_{k} [ n ] = ( {g}_{a , f} [ n ] {M}_{k} + ( 1 - {g}_{a , f} [ n ] ) {M}_{k , prev} ) {x}_{k} [ n ] , 0 \leq n < {L}_{f}$$

For example, a pseudocode loop based implementation of the adapted interpolator function is (with C-style array indexing, i.e. the first entry in the array has index zero (0)):

### Algorithm 1: Pseudocode for Generating the Adapted Interpolator

gₐ = get_interpolator(L_{Seg}, L_{f})

| | |
|---|---|
| 1 | begin |
| 2 | float dec = 1/(2*L_{Seg}) |
| 3 | gₐ[L_{f} − 1]=1 |
| 4 | for (n= L_{f}−2 ; n >= L_{Seg} ; n = n−1) |
| 5 | begin |
| 6 | gₐ[n] = max(0, gₐ[n+1]−dec) |
| 7 | end |
| 8 | if (gₐ[L_{Seg}] > 0 ) |
| 9 | begin |
| 10 | dec = gₐ[L_{Seg}]/ L_{Seg} |
| 11 | for ( n = L_{Seg} −1 ; n >= 0 ; n=n−1 ) |
| 12 | gₐ[n] = max(0, gₐ[n+1]−dec) |
| 13 | end |
| 14 | else |
| 15 | for ( n = L_{Seg} −1 ; n >= 0 ; n=n−1 ) |
| 16 | gₐ[n] = 0 |
| 17 | end |
| 18 | end |
| 19 | return gₐ |
| 20 | end |

### Adapting Subframe Metadata by Mapping

Other IVAS technologies (DirAC, MASA, McMASA), mainly those based on scene based audio (SBA) where the audio to encode typically is presented in the Ambisonics, employ, for example, several sets of metadata per frame, i.e. they have a set of metadata per subframe. In this case, processing is, for example, done per subframe, for example, based on the metadata for that particular subframe. Typically (but not necessarily) a mixing rule is generated from the metadata and optionally based on some signal characteristic, e.g. the combined energy of the transport channels, the so called reference energy. Also the rendering itself is, for example, done by linear interpolating between the mixing rule from the previous subframe with an interpolator like gₐ[n] where 2L_{seg} is now, for example, the length (in time slots) of the subframe.

For example, generally here we also like to follow the idea presented in the full frame adaption of interpolators, i.e. for remaining part representing unchanged portions of the transport channels also use the metadata as unchanged as possible and only adapt it in the parts where signals were overlap-added in the time scale modification.

The metadata is typically (but not necessarily) stored in a buffer where, for example, for each subframe is stored in a buffer slot, the index of this slot being the subframe index.

For example, for certain combination of technologies that share common metadata a delay compensation is necessary for the metadata (e.g. when using DirAC metadata for SPAR processing). In this case the metadata can, for example, be stored in a ring (modulo) buffer that contains more metadata slots than needed for an unchanged frame, usually the number of slots needed for an unchanged frame and the number of metadata slots needed for delay compensation, the length of the metadata buffer being L_{md}. For example, to access to correct metadata for processing in a certain technology an offset n_{offset} into the metadata is determined, for example, for each frame to be processed.

For example, for the metadata adaption now a mapping vector m_{sf}[n] is created, where, for example, for each slot the best suiting subframe index is stored. This can be done, for example, using the rule g_{a,map}[n], g_{a,map}[n] being an interpolator with the same characteristic as gₐ[n] but suited for generating mapping indices for a system where indices into arrays or vectors start with a zero, for systems with indices starting with 1 a similar interpolator can be derived straightforward from the following one by adding one to the resulting map:

$${g}_{a , map} [ n ] = \{ \begin{matrix}\frac{n + ( {L}_{seg} - {L}_{rem} )}{2 {L}_{seg} - 1} , {L}_{Seg} \leq n < {L}_{f} \\ n \frac{2 {L}_{Seg} - {L}_{rem}}{{L}_{seg} ( 2 {L}_{seg} - 1 )} , 0 \leq n < {L}_{seg}\end{matrix}$$

$${m}_{sf} [ n ] = modulo ( {n}_{offset} + max ( 0 , \frac{⌊ ( 2 {L}_{seg} - 1 ) {g}_{a , map} [ n ] ⌉}{{L}_{sf}} , {L}_{md} )$$

where └ ┐ denotes rounding to the nearest integer, L_{sf} is the length of a subframe and the division in the formula for m_{sf}[n] is an integer division (i.e. an Euclidian division yielding an integer and a, in this case unused, remainder), and modulo is the modulo operation with divisor L_{md} (i.e. a function that returns the remainder of an integer division).

The following pseudocode algorithm is a possible way to implement this mapping:

### Algorithm 2: Generating a Metadata Map

m_{sf}= get_map(L_{Seg}, L_{f}, L_{sf} , L_{md}, n_{offset})

| 1 | begin | |
|---|---|---|
| 2 | int src_idx, src_idx_map | |
| 3 | float src_idx_f | |
| 4 | int src_idx = 2*L_{Seg}−1 | |
| 5 | float dec | |
| 6 | for (n= L_{f}−1 ; n >= L_{Seg} ; n = n−1) | |
| 7 | begin | |
| 8 | src_idx_map = max(0,src_idx/L_{sf}) | # integer division |
| 9 | m_{sf}[n] = modulo(src_idx_map + n_{offset}),L_{md} ) | |
| 10 | src_idx = src_idx − 1 | |
| 12 | end | |
| 13 | if ( src_idx > 0 ) | |
| 14 | begin | |
| 15 | dec = (src_idx + 1) / L_{seg} | # float division |
| 16 | src_idx_f = (src_idx + 1) − dec | |
| 17 | for ( n = L_{Seg} −1 ; n >= 0 ; n=n−1 ) | |
| 18 | src_idx = max(0, └src_idx_f┐/L_{sf} ) | # integer division |

| | |
|---|---|
| 19 | m_{sf}[n] = modulo(src_idx + n_{offset}), L_{md} ) |
| 20 | src_idx_f = src_idx_f − dec |
| 21 | end |
| 22 | else |
| 23 | for ( n = L_{Seg} −1 ; n >= 0 ; n=n−1 ) |
| 24 | m_{sf}[n] = n_{offset} |
| 25 | end |
| 26 | end |
| 27 | return m_{sf} |
| 28 | end |

In the processing itself, for the generation of the mixing rule in case of not being dependent on one or more transport channel signal properties, it can be generated, for example, by using the average of the metadata over the subframe, which can be seen as a linear interpolation of the metadata based on the (frame) interpolator characteristic. Another possibility (example) is to generate a mixing rule or an intermediate set of parameter per slot based on the metadata for the slot indicated by the metadata mapping vector and average the mixing rules or the intermediate parameter. The choice of which domain to average depends, for example, which is best suited for averaging. For the case of the mixing rule also takes transport channel signal properties into account, it is in many cases favourable to do the averaging in the intermediate or mixing rule domain, i.e. in the case of e.g. the reference power being the signal characteristic this can be seen as a (transport channel) signal energy weighted interpolation of the metadata.

Some modes (SBA, DirAC) [7] not only comprise encoded and transmitted metadata for several subframes, but, for example, also apply a metadata analysis on the transport channels in the decoder's reconstruction/rendering stage with higher time resolution than the transported metadata, e.g one per time slot for bands where no metadata was transmitted.

In this case the internal buffer already also stores the transmitted metadata in a slot manner so the mapping vector mₜₛ[n] in this case is, for example:

$${m}_{ts} [ n ] = max ( 0 , ⌊ ( 2 {L}_{seg} - 1 ) {g}_{a , map} [ n ] ⌉ )$$

This can, for example, be implemented using Algorithm 2 and setting L_{sf}=1.

Typically (but not necessarily) the decoder metadata analysis also stores the estimated metadata in the same internal buffer. For the adapted subframe processing, since the map can for a number consecutive slots to process point to the same slot of the internal metadata buffer, it is favourable to copy the metadata for a subframe to a local buffer before subframe processing to avoid to overwrite metadata estimated at the decoder for the same (source) slot in the processing.

The mapping vector mₜₛ[n] can, for example, also be employed for IVAS modes where mixing rules are not dependent on signal properties, and are calculated and stored based on the assumption of a frame to be processed with unchanged length. The final mixing rule for a slot is then determined based on the (unchanged) slot index. In the case of a length adapted frame mₜₛ[n] can be used to map the slot index of the slot to be processed in the length adapted frame to the unchanged slot index for determining the mixing rule for this slot.

### Adapting a Trans Position Indicator

Some IVAS technologies (e.g. ParamMC[6]) have metadata indicating a transient position n_{T}. The TSM can, for example, shift the position of the transient in the frame to be processed, so the transient position can, for example, be adapted in the following way:

$${n}_{T , a} = max ( 0 , {n}_{T} + ( {L}_{f} - 2 {L}_{seg} ) )$$

Where n_{T,a} is the adapted transient position and L_{f} and L_{seg} are the length of the frame to be processed and the TSM segment length expressed in the time resolution of the transient position metadata, e.g. the time resolution of the transient position is 2 CLDFB time slots (ParamMC).

### Adapting Subframe Processing Interpolation

In the proposed system, the size in time slots of a subframe to process might, for example, be smaller than the default subframe size of the subframe processing. When an interpolator (for e.g. interpolating mixing rules of the current subframe and the previous subframe) is used in the processing, here the interpolation can, for example, be simply adapted to the shorter subframe size by scaling it linear to the subframe size to be processed. So e.g. if a linear interpolator like g[n] is used, there simply the interpolator length 2L_{seg} is adapted to the size if the subframe to be processed.

### 17. Implementation Alternatives

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

### 19. Further Embodiments

In the following further embodiments and aspects of the invention will be describes.

It should be noted that the aspects described in the following can be used individually or in combination.

It should also be noted that the aspects described in the following can optionally be supplemented by any of the features, functionalities and details disclosed herein.

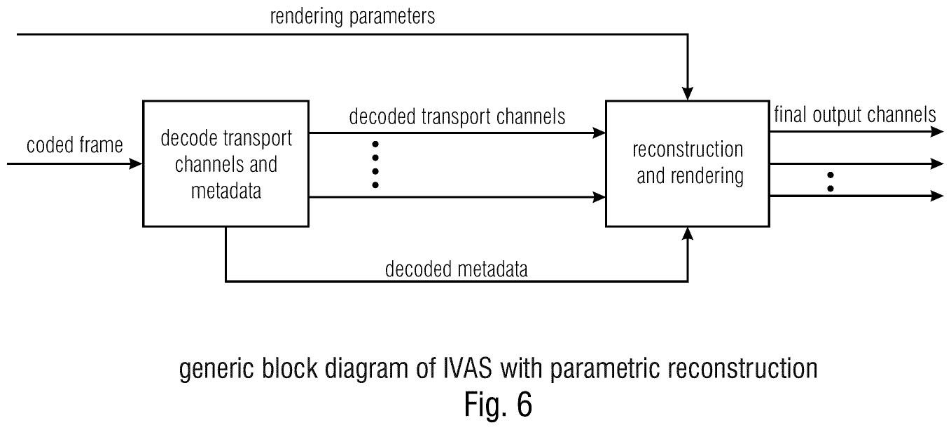

Moreover, any of the aspects disclosed in the following may optionally be introduced into any of the other embodiments disclosed herein, both individually and taken in combination.
1. An audio processor for providing a time-scaled audio content, where the audio processor has multiple processing steps and intermediate audio signals where the time-scaling is done on an intermediate audio signal. (FIG. 9)
2. The audio processor with parameters for the processing steps (FIG. 10, parameters are e.g., the decoded metadata or rendering parameters according to FIG. 6 that are applied sequentially)
3. The audio processor where the time scaling is controlled by a time scaling controller (FIG. 11)
4. The audio processor with parameter adapters (FIG. 12)
5. The audio processor according to aspect 2 where the parameter for a processing step is metadata (e.g. spatial meta data describing how to upmix)
6. The audio processor of aspect 5 where metadata is associated to the intermediate audio signal (e.g. spatial metadata with subframes synchronized to the TD signal)
7. The audio processor according to aspects 4-6 where the metadata adapter is configured to adapt metadata associated to transport channel audio samples (i.e. the metadata adapter follows the time-scaling ratio of the TSM of the TD signal)
8. The audio processor according to the preceding aspects where the intermediate audio signal is a time domain signal and the time-scaling is done on the time domain signal
9. The audio processor according to the preceding aspects where the time scaler is configured to synchronize the time scaling operation over a plurality of audio channels (e.g. multi-channel TSM that gives the same number of samples for each channel)
10. (Canceled)
11. Dependent aspect for buffering TSM transport channel samples to keep a FD time resolution (FIG. 16, see description)
12. Dependent aspect for adapting the subframe size and/or metadata for the renderer for each subframe associated based on the applied TSM on the TCs (FIG. 17, see description)
13. Dependent aspect for adapting metadata and initial offset of subframes for rendering with constant subframe size (FIG. 18, see description)
14. Dependent aspect on the adapted TSM in silent frames (no fig, see description)
15. Dependent aspect where a decoder is described that contains the audio processor and also another view that the decoder is one of the processing steps
16. Dependent aspect that the processing steps can be decoding, rendering, reconstruction, encoding (in case this is another interface e.g. in the edge)
17. An audio processor according to preceding aspects where the audio input signal representation comes from an input buffer
18. An audio processor according to preceding aspects where the input buffer to the decoder is a jitter buffer and the time-scaling control is a jitter buffer control (see e.g. [2] or [3])
19. An audio processor according to preceding aspects, comprising
   a decoder for generating transport channels,
   a renderer for reconstructing an encoded or intermediate audio format from transport channels and associated metadata and rendering it to an output format; (Renderer is a single box in the figures, but is in fact two steps)
20. (The audio processor according to preceding aspects where the transport channels already represent the output channels and the renderer is just a pass-through block)
21. The audio processor according to aspect 19 where the renderer is configured to reconstruct the encoded audio format or an intermediate format and to render the encoded audio format or intermediate audio format to an output format in two consecutive processing steps
22. An audio processor according to preceding aspects, comprising an interface for providing time-scaled transport channels and associated adapted metadata for subsequent rendering; (see description, e.g. split of renderer in end device from decoder in edge device, connected in the FD plus parameters domain)
23. The audio processor according to one of the previous aspects where the renderer is configured to process the reconstruction of the encoded and intermediate output format and the rendering to the output format in one combined processing step (see most Figs where rendering and reconstruction are a single block)

### 20. Conclusions

To conclude, embodiments according to the invention are related to a novel multi-stage audio processing system with intermediate audio signals where a time scale modification is applied to one of the intermediate audio signals. Furthermore, embodiments according to the invention show ways of adapting processing steps and processing parameters based on the time scale modification of the intermediate audio signal, controlled by a common time scale modification controller. As a detailed embodiment, a jitter buffer management solution for a communication codec capable of encoding and/or decoding complex audio scenes based on transport channels and associated metadata for reconstructing encoded audio formats is disclosed.

Embodiments are related to multi-stage audio processing, time scale modification, parameter adaptation, playout speed, JBM and/or IVAS.

Embodiments according to the invention are useable in the context of 3GPP IVAS.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] Kramer, Kris W.; Robert, Chris C. Forrester; Joly, Nepean: JITTER BUFFER MANAGEMENT; U.S. Pat. No. 6,658,027 B1; December 2003
[2] ETSI TS 126 448: Universal Mobile Telecommunications System (UMTS); LTE; EVS Codec Jitter Buffer Management (3GPP TS 26.448 version 12.0.0 Release 12)
[3] Reuschl, Stefan; Döhla, Stefan; Lecomte, Jeremie; Jander, Manuel: Jitter Buffer Control, Audio Decoder, Method and Computer Program, U.S. Pat. No. 9,997,162 B2; June 2018
[4] IVAS Design Constraints (IVAS-4), Version 1.0.0, https://www.3gpp.org/ftp/tsg_sa/WG4_CODEC/IVAS_Permanent_Documents/IVAS-4_S4-2211619.zip
[5] Fuchs, Guillaume, et al: Apparatus and Method for Encoding or Decoding Directional Audio Coding Parameters using Quantization and Entropy Coding; U.S. Pat. No. 11,367,454 B2, June 2022
[6] Bayer, Stefan; Boutheon, Alexandre; Fuchs, Guillaume; Multrus, Markus; Küch, Fabian; Thiergart, Oliver; Disch, Sascha; Herre, Jürgen: Parameter Encoding and Decoding, European Patent Application EP3984028A2, June 2020
[7] Bayer, Stefan, et al: Audio Scene Encoder, Audio Scene Decoder and Related Methods Using Hybrid Encoder/Decoder Spatial Analysis, European Patent Specification EP 3 724 876 B1, May 2022

1. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals.

2. Audio processor according to claim 1,
wherein the audio processor is configured to perform the second processing in dependence on one or more parameters.

3. Audio processor according to claim 1,
wherein the audio processor is configured to adapt the second processing to the time scale modification.

4. Audio processor according to claim 1,
wherein the audio processor is configured to adapt one or more processing parameters to the time scale modification, to acquire adapted processing parameters,
wherein the audio processor is configured to perform the second processing in dependence on the one or more adapted parameters.

5. Audio processor according to claim 4,
wherein the one or more processing parameters are temporally associated with the one or more intermediate audio signals,
wherein the audio processor is configured to acquire the adapted processing parameters such that the adapted processing parameters are adapted to a timing of the time-scale-modified intermediate audio signals.

6. Audio processor according to claim 4,
wherein the audio processor is configured to acquire the adapted processing parameters using a temporal interpolation or using a temporal extrapolation.

7. Audio processor according to claim 1,
wherein the audio processor is configured to apply a time scale modification on one or more decoded transport channels.

8. Audio processor according to claim 1,
wherein the audio processor is configured to acquire or reconstruct a plurality of output audio channels on the basis of the one or more decoded transport channels and metadata.

9. Audio processor according to claim 1,
wherein the audio processor is configured to apply a same time scale modification to a plurality of decoded transport channels.

10. Audio processor according to claim 1,
wherein the audio processor is configured to adapt metadata for an acquisition or reconstruction of the output audio channels in dependence on the time scale modification.

11. Audio processor according to claim 1,
wherein audio processor is configured to perform the first processing for time segments of a first length; and
wherein audio processor is configured to perform the second processing for time segments of a second length which is shorter than the first length, or
wherein the audio processor is configured to perform the second processing with step-wise temporal increments of a second length, which is smaller than the first length,
wherein one or more intermediate audio signals of the second length are input into the second processing for each execution of the second processing.

12. Audio processor according to claim 11,
wherein a granularity of the time scale modification is finer than the second length, such that the time scale modification may result in frame lengths of the one or more time scale modified intermediate audio signals which deviate from integer multiples of the second length.

13. Audio processor according to claim 1,
wherein the first processing is configured to block-wisely provide time domain samples, wherein a block of time domain samples provided by the first processing comprises a first number of time domain samples; and
wherein the second processing is configured to operate on blocks of time domain samples which are based on time-scale modified time domain samples that are derived from the time domain samples provided by the first processing using the time scale modification,
wherein the blocks of time domain samples processed by the second processing comprise a shorter length than the blocks of time domain samples provided by the first processing; or
wherein the second processing is configured to input, per processing step, a block of a plurality of time domain samples which is based on time-scale modified time domain samples that are derived from the time domain samples provided by the first processing using the time scale modification,
wherein the block of a plurality of time domain samples input into the second processing per processing step comprises a shorter length than the blocks of time domain samples provided by the first processing.

14. Audio processor according to claim 1,
wherein blocks of time domain samples processed by the second processing comprise a plurality of time domain samples.

15. Audio processor according to claim 1,
wherein metadata, which are used in the second processing, are associated with sub-frames of the input audio signal representation, and/or are associated with sub-frames of the one or more intermediate audio signals,
wherein a subframe comprises on or more time slots,
wherein the audio processor is configured to provide the one or more time-scale modified intermediate audio signals such that a respective frame of the one or more time scale modified intermediate audio signals comprises a different length when compared to a corresponding frame of the input audio signal representation and/or when compared to a corresponding frame of one or more intermediate audio signals.

16. Audio processor according to claim 1,
wherein the audio signal processor is configured to provide the one or more time-scale-modified intermediate audio signals such that a length of a respective frame of the one or more time-scale-modified intermediate audio signals is different from a multiple of a block size used in the second processing; and/or
wherein the audio processor is configured to perform the second processing with step-wise temporal increments,
wherein the audio signal processor is configured to provide the one or more time-scale-modified intermediate audio signals such that a length of a respective frame of the one or more time-scale-modified intermediate audio signals is different from a multiple of the temporal increments.

17. Audio processor according to claim 1,
wherein the audio signal processor is configured to form a block of samples for the second processing on the basis of one or more time domain samples associated with a previous frame of the one or more time-scale-modified intermediate audio signals and on the basis of one or more time domain samples associated with a current frame of the one or more time-scale-modified intermediate audio signals, and
wherein the audio signal processor is configured to form one or more blocks of samples for the second processing on the basis of a plurality time domain samples associated with a current frame of the one or more time-scale-modified intermediate audio signals, and
wherein the audio signal processor is configured to buffer one or more residual time domain samples, i.e. excessive time domain samples which are not sufficient for a formation of a block of samples for the second processing, associated with a current frame of the one or more time-scale-modified intermediate audio signals for a formation of a block of samples for the second processing which includes one or more time domain samples associated with a subsequent frame of the one or more time-scale-modified intermediate audio signals.

18. Audio processor according to claim 1,
wherein the audio processor is configured to use one or more buffered residual time domain samples, i.e. excessive time domain samples which are not sufficient for a formation of a block of samples for the second processing, associated with a previous frame and a maximum possible number of time domain samples associated with the current frame of the one or more time-scale-modified intermediate audio signals for a formation of blocks of samples for the second processing associated with the current frame.

19. Audio processor according to claim 1,
wherein a temporal resolution of metadata, which is used in the second processing, is smaller than a time resolution of the second processing.

20. Audio processor according to claim 1,
wherein the one or more intermediate audio signals are one or more transport channel signals.

21. Audio processor according to claim 1,
wherein the audio processor is configured to perform the time scale modification using a quality control mechanism.

22. Audio processor according to claim 1,
wherein the audio processor is configured to switch between a quality-controlled time scale modification mode and a non-quality-controlled time scale modification mode in dependence on one or more characteristics of the one or more intermediate audio signals and/or in dependence on a side information.

23. Audio processor according to claim 1,
wherein the audio processor is configured to operate in a non-quality controlled time scale modification mode.

24. Audio processor according to claim 1,
wherein the audio processor is configured to selectively switch to a special time scale modification mode for frames classified as silent; and
wherein the audio processor is configured to perform the time scale modification in such a manner that no buffering of residual frames is required, when operating in the special time scale modification mode;
wherein a number of time domain samples of a current time-scale modified frame plus a number of buffered time domain samples of a previous time scale modified frame is an integer multiple of a number of time domain samples of a block of time domain samples processed by the second processing, or
wherein a number of time domain samples of a current time-scale modified frame plus a number of buffered time domain samples of a previous time scale modified frame is an integer multiple of a number of time domain samples input into the second processing to make a temporal increment
when operating in the special time scale modification mode.

25. Audio processor according to claim 1,
wherein the audio processor is configured to adapt a size of subframes, which are used in the second processing or which are input into the second processing as a block of new samples to make a temporal increment, to the time scale modification.

26. Audio processor according to claim 25,
wherein the audio processor is configured to adapt a number of time slots which are processed in the second processing, or which are input into the second processing as a block of new samples to make a temporal increment, to the time scale modification.

27. Audio processor according to claim 1,
wherein the audio processor is configured to perform the time scale modification using one or more overlap-and-add operations overlapping different segments of the one or more intermediate audio signals,
wherein the audio processor is configured adapt metadata where overlap-and-add operations are applied to different segments of the one or more intermediate audio signals, to acquire adapted metadata associated with frames or subframes of the one or more time-scale-modified intermediate audio signals.

28. Audio processor according to claim 27,
wherein the audio processor is configured to linearly combine metadata associated with frames or subframes of the one or more intermediate audio signals which are involved in an overlap-and-add operation, to acquire metadata associated with resulting frames or subframes of one or more the time scale modified intermediate audio signals.

29. Audio processor according to claim 1,
wherein the audio processor is configured to identify a segment, out of a plurality of candidate segments which are portions of a given audio frame of an intermediate audio signal, for an overlap-and-add with a predetermined portion of the given audio frame, using a determination of a waveform similarity, in order to acquire a shortened version of the given audio frame.

30. Audio processor according to claim 29, wherein the audio processor is configured to include, at an end of the shortened version of the given audio frame, an unmodified portion of the given audio frame which follows the identified segment in an original version of the given audio frame.

31. Audio processor according to claim 1,
wherein the audio processor is configured to identify a segment, out of a plurality of candidate segments which are portions comprising values of a previous audio frame of an intermediate audio signal preceding a given audio frame, for an overlap-and-add with a predetermined portion of the given audio frame, using a determination of a waveform similarity, in order to acquire a lengthened version of the given audio frame.

32. Audio processor according to claim 31, wherein the audio processor is configured to include, at an end of the lengthened version of the given audio frame, an unmodified portion comprising values of the given audio frame which follows the identified segment.

33. Audio processor according to claim 1,
wherein the audio processor is configured to time-interpolate between one or more processing parameters associated with a previous frame of the one or more intermediate audio signals and one or more processing parameters associated with a current frame of the one or more intermediate audio signals, in order to acquire processing parameters associated with different time instances of a current frame of the one or more time-scale modified intermediate audio signals using an interpolation function which determines contributions of the one or more processing parameters associated with the previous frame and contributions of one or more processing parameters associated with the current frame in a linear combination of processing parameters.

34. Audio processor according to claim 33,
wherein the interpolation function is a linear or piecewise linear function mapping a time index onto a weighting value that determines contributions of a processing parameter associated with a previous frame and of a processing parameter associated with a current frame to a time-interpolated processing parameter.

35. Audio processor according to claim 33,
wherein for a temporally shortened audio frame, the interpolation function comprises a larger slope for a portion of the time scale modified current frame which has been acquired using an overlap-add-combination than for a portion of the time scale modified current frame which is unmodified; and/or
wherein for a temporally lengthened audio frame, the interpolation function comprises a smaller slope for a portion of the time scale modified current frame which has been acquired using an overlap-add-combination than for a portion of the time scale modified current frame which is unmodified.

36. Audio processor according to claim 33,
wherein the audio processor is configured to acquire interpolated processing parameters Pinter[n] associated with time instances having time index n according to
$$Pinter [ n ] = ga , f [ n ] P + ( 1 - ga , f ) Pprev ,$$
wherein P is a processing parameter or a set of processing parameters associated with a current frame of the one or more intermediate audio signals,
wherein Pprev is a processing parameter or a set of processing parameters associated with a previous frame of the one or more intermediate audio signals,
wherein Pinter is a processing parameter or a set of processing parameters associated with a time instance n in a current frame of the one or more time scale modified intermediate audio signals, and
wherein ga,f is an interpolation function.

37. Audio processor according to claim 36,
wherein the interpolation function ga,f is defined as
$${g}_{a , f} [ n ] = max ( 0 , {g}_{a} [ n ] ) , and$$
$$wherein$$
$${g}_{a} [ n ] = \{ \begin{matrix}\frac{n + 1 ( {L}_{seg} - {L}_{rem} )}{2 {L}_{seg}} , {L}_{Seg} \leq n < {L}_{f} \\ ( n + 1 ) \frac{2 {L}_{Seg} + 1 - {L}_{rem}}{2 {L}_{seg} ( {L}_{Seg} - 1 )} , 0 \leq n < {L}_{seg}\end{matrix}$$
wherein n is a time index,
wherein
Lrem=Lf−Lseg,
wherein Lf is a length of a frame to be processed;
wherein Lseg is the length of a portion in which an overlap-and-add is applied by the time scale modification.

38. Audio processor according to claim 1,
wherein the audio processor is configured to perform, as the second processing, a processing of values of the one or more time-scale-modified intermediate audio signals according to
$$y [ n ] = ( {g}_{a , f} [ n ] M + ( 1 - {g}_{a , f} [ n ] ) {M}_{p r e v} ) x [ n ] , 0 \leq n < {L}_{f}$$
or according to
$${y}_{k} [ n ] = ( {g}_{a , f} [ n ] {M}_{k} + ( 1 - {g}_{a , f} [ n ] ) {M}_{k , p r e v} ) {x}_{k} [ n ] , 0 \leq n < {L}_{f} ,$$
wherein x[n] and xk[n] are of values or sets of value of the one or more time-scale-modified intermediate audio signals,
wherein M is a processing parameter or a set of processing parameters associated with a current frame of the one or more intermediate audio signals;
wherein Mprev is a processing parameter or a set of processing parameters associated with a previous frame of the one or more intermediate audio signals,
wherein n is a time index,
wherein Lf is a length of a frame to be processed, and
wherein ga,f is an interpolation function.

39. Audio processor according to claim 1,
wherein the audio processor is configured to perform the second processing using processing parameters associated with subframes of an audio frame.

40. Audio processor according to claim 1,
wherein the audio processor is configured to acquire a processing rule for the second processing using processing parameters associated with a given subframe.

41. Audio processor according to claim 1,
Wherein the audio processor is configured to determine a mapping vector defining an association between time slots of the one or more time scale modified intermediate audio signals and subframe indices of subframes of the one or more original intermediate audio signals in dependence on the time scale modification such that the mapping describes which processing parameters are allocated with which time slot of the time scale modified intermediate audio signals.

42. Audio processor according to claim 41,
Wherein the audio processor is configured to determine the mapping vector according to
$${m}_{s f} [ n ] = modulo ( {n}_{offset} + max ( 0 , \frac{⌊ ( 2 {L}_{s e g} - 1 ) {g}_{a , m a p} [ n ] ⌉}{{L}_{s f}} ) , {L}_{m d} )$$
or according to
$${m}_{s f} [ n ] = max ( 0 , \frac{⌊ ( 2 {L}_{s e g} - 1 ) {g}_{a , m a p} [ n ] ⌉}{{L}_{s f}} )$$
Wherein m_{sf}[n] is an element of the mapping vector;
Wherein n is a time slot index;
Wherein n_{offset} is an offset value;
Wherein L_{seg} is a half of a length of a frame of the one or more original intermediate audio signals in time slots;
Wherein 2L_{seg} is a length of a frame of the one or more original intermediate audio signals in time slots;
Wherein Lsf is a length of a subframe in time slots;
Wherein L_{md} is a length of a metadata buffer;
Wherein n_{offset} is; and
Wherein g_{a,map}[n] is an interpolation function;
Wherein └ ┐ denotes a rounding to a nearest integer;
Wherein modulo is a modulo operation and
Wherein a division is an integer division.

43. Audio processor according to claim 42,
wherein
$${g}_{a , map} [ n ] = \{ \begin{matrix}\frac{n + 1 ( {L}_{seg} - {L}_{rem} )}{2 {L}_{seg} - 1} , {L}_{Seg} \leq n < {L}_{f} \\ n \frac{2 {L}_{Seg} - {L}_{rem}}{{L}_{seg} ( 2 {L}_{Seg} - 1 )} , 0 \leq n < {L}_{seg}\end{matrix}$$
wherein L_{f} is a length of a frame to be processed in time slots;
Wherein Lᵣₑₘ=L_{f}−L_{seg}.

44. Audio processor according to claim 1,
Wherein the audio processor is configured to determine a mapping vector defining an association between time slots of the one or more time scale modified intermediate audio signals and time slots of the one or more original intermediate audio signals in dependence on the time scale modification,
such that the mapping vector describes which processing parameters are allocated with which time slot of the time scale modified intermediate audio signals.

45. Audio processor according to claim 44,
wherein the audio processor is configured to determine the mapping vector according to
$${m}_{t s} [ n ] = max ( 0 , ⌊ ( 2 {L}_{s e g} - 1 ) {g}_{a , map} [ n ] ⌉ )$$
Wherein n is a time slot index,
Wherein 2Lseg is a length of a frame of the one or more original intermediate audio signals in time slots; and
Wherein g_{a,map}[n] is an interpolation function.

46. Audio processor according to claim 1,
Wherein the audio processor is configured to determine a mapping vector defining an association between time slots of the one or more time scale modified intermediate audio signals] and time slots of one or more original intermediate audio signals in dependence on the time scale modification,
such that the mapping vector describes which processing parameters are allocated with which time slot of the time scale modified intermediate audio signals.

47. Audio processor according to claim 41,
wherein the audio processor is configured to determine processing parameters associated with a given subframe of the one or more time scale modified intermediate audio signals using processing parameters associated with time slots making up the given subframe of the one or more time scale modified intermediate audio signals,
or
wherein the audio processor may be configured to acquire rendering rules or upmixing rules or intermediate parameters per slot using processing parameters associated with respective slots, and to acquire a rendering rule or an upmixing rule or intermediate parameters associated with a subframe using an averaging of the rendering rules or upmixing rules or intermediate parameters associated with the slots making up the subframe.

48. Audio processor according to claim 1,
Wherein the audio processor is configured to adapt an interpolation between slots of a subframe to a size of a subframe acquired by the time scale modification.

49. Audio processor according to claim 1,
wherein the audio processor is configured to modify a subframe grid of subframes of the one or more time scale modified intermediate audio signals in dependence on a time scale modification of a current frame,
wherein lengths of subframes of the one or more time scale modified intermediate audio signals are left unchanged, and
wherein the second processing is configured to perform a subframe-based operation.

50. Audio processor according to claim 1,
wherein the first processing is an audio decoding.

51. Audio processor according to claim 1,
wherein the first processing comprises at least one out of a decoding, a rendering, a reconstruction, and an encoding; and/or
wherein the second processing comprises at least one out of a decoding, a rendering, a reconstruction, and an encoding.

52. Audio processor according to claim 1,
wherein the audio processor is configured to receive the input audio signal representation from an input buffer.

53. Audio processor according to claim 1,
wherein the audio processor is configured to receive the input audio signal representation from a jitter buffer; and
wherein the audio processor comprises a time scaling control to adjust the time scale modification,
wherein the tie scaling control is a jitter buffer control.

54. Audio processor according to claim 1,
wherein the first processing comprises a decoding of encoded transport channels; and
wherein the second processing comprises a rendering configured to reconstruct an encoded or intermediate audio format on the basis of time scale modified transport channels and associated metadata and to render the encoded or intermediate audio format to an output format.

55. Audio processor according to claim 54,
wherein the rendering is configured to reconstruct the encoded audio format or the intermediate audio format and to render the encoded audio format or the intermediate audio format to the output format in two consecutive processing steps.

56. Audio processor according to claim 1,
wherein the functionalities of the audio processor are distributed to two or more devices, with an interface in between.

57. Audio processor according to claim 1,
wherein the audio processor comprises an interface configured to provide the time scale modified intermediate audio signals and associated metadata for a subsequent rendering.

58. Audio processor according to claim 1,
wherein the second processing is a rendering,
wherein the rendering is configured to process a reconstruction of an encoded audio format and/or of an intermediate audio format and a rendering of the reconstructed encoded audio format and/or of the intermediate audio format in a combined processing step.

59. The audio processor according to claim 1,
wherein the one or more intermediate audio signals are time domain signals, and
wherein the audio processor is configured to perform the time scale modification on the time domain intermediate audio signals.

60. The audio processor according to claim 1,
wherein the audio processor is configured to synchronize a time scaling operation over a plurality of intermediate audio signals.

61. The audio processor according to claim 1,
Wherein the audio processor is configured to modify a transient position information in dependence on the time scale modification.

62. The audio processor according to claim 61,
Wherein the audio processor is configured to acquire an adapted transient position according to
$${n}_{T , a} = max ( 0 , {n}_{T} + ( {L}_{f} - 2 {L}_{s e g} ) )$$
n_{T} is an original transient position value,
Wherein Lf is a length of a frame of the one or more time scale modified intermediate audio signals; and
Wherein 2Lseg is a length of a frame of the one or more original intermediate audio signals.

63. An audio processing system for providing a processed audio signal representation on the basis of an input audio signal representation,
wherein the audio processing system is configured to perform a plurality of processing steps, in order to provide the processed audio signal representation on the basis of the input audio signal representation;
wherein the audio processing system is configured to perform a time scale modification on one or more intermediate audio signals, which are provided by a first processing on the basis of the input audio representation, in order to acquire one or more time-scale-modified intermediate audio signals, and
wherein the audio processing system is configured to perform a second processing, which follows the first processing and which provides the processed audio signal representation, on the basis of the one or more time-scale-modified intermediate audio signals, or on the basis of signals derived from the one or more time scale modified intermediate audio signals;
wherein functionalities of the audio processing system are distributed to two or more devices.

64. Audio processing system according to claim 63,
Wherein the audio processing system comprises an interface for providing the time scale modified intermediate audio signals and associated adapted metadata to a second processing which takes place in a different device than the first processing.

65. Audio decoder for providing a decoded audio representation on the basis of an encoded audio representation,
wherein the audio decoder comprises an audio processor of claim 1.

66. A method for providing a processed audio signal representation on the basis of an input audio signal representation,
wherein the method comprises performing a plurality of processing steps, in order to provide the processed audio signal representation on the basis of the input audio signal representation;
wherein the method comprises performing a time scale modification on one or more intermediate audio signals, which are provided by a first processing on the basis of the input audio representation, in order to acquire one or more time-scale-modified intermediate audio signals, and
wherein the method comprises performing a second processing, which follows the first processing and which provides the processed audio signal representation, on the basis of the one or more time-scale-modified intermediate audio signals.

67. A non-transitory digital storage medium having a computer program stored thereon to perform the method for providing a processed audio signal representation on the basis of an input audio signal representation,
wherein the method comprises performing a plurality of processing steps, in order to provide the processed audio signal representation on the basis of the input audio signal representation;
wherein the method comprises performing a time scale modification on one or more intermediate audio signals, which are provided by a first processing on the basis of the input audio representation, in order to acquire one or more time-scale-modified intermediate audio signals, and
wherein the method comprises performing a second processing, which follows the first processing and which provides the processed audio signal representation, on the basis of the one or more time-scale-modified intermediate audio signals,
when said computer program is run by a computer.

68. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing, that is performed by the audio processor, on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein audio processor is configured to perform the first processing for time segments of a first length; and
wherein audio processor is configured to perform the second processing for time segments of a second length which is shorter than the first length, or
wherein the audio processor is configured to perform the second processing with temporal increments of a second length, which is smaller than the first length, wherein one or more intermediate audio signals of the second length are input into the second processing for each execution of the second processing;
wherein a granularity of the time scale modification is finer than the second length, such that the time scale modification may result in frame lengths of the one or more time scale modified intermediate audio signals which deviate from integer multiples of the second length.

69. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio signal processor is configured to provide the one or more time-scale-modified intermediate audio signals such that a length of a respective frame of the one or more time-scale-modified intermediate audio signals is different from a multiple of a block size used in the second processing; and/or
wherein the audio processor is configured to perform the second processing with step-wise temporal increments,
wherein the audio signal processor is configured to provide the one or more time-scale-modified intermediate audio signals such that a length of a respective frame of the one or more time-scale-modified intermediate audio signals is different from a multiple of the temporal increments.

70. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio signal processor is configured to form a block of samples for the second processing on the basis of one or more time domain samples associated with a previous frame of the one or more time-scale-modified intermediate audio signals and on the basis of one or more time domain samples associated with a current frame of the one or more time-scale-modified intermediate audio signals, and
wherein the audio signal processor is configured to form one or more blocks of samples for the second processing on the basis of a plurality time domain samples associated with a current frame of the one or more time-scale-modified intermediate audio signals, until there are not enough time domain samples associated with a current frame of the one or more time-scale-modified intermediate audio signals left to form a block of samples for the second processing,
such that blocks of samples for the second processing having uniform length are formed even if the time scale modification changes a frame length to be different from an integer multiple of the length of the blocks of samples used for the second processing, and
wherein the audio signal processor is configured to buffer one or more residual time domain samples, i.e. excessive time domain samples which are not sufficient for a formation of a block of samples for the second processing, associated with a current frame of the one or more time-scale-modified intermediate audio signals for a formation of a block of samples for the second processing which includes one or more time domain samples associated with a subsequent frame of the one or more time-scale-modified intermediate audio signals.

71. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to use one or more buffered residual time domain samples, i.e. excessive time domain samples which are not sufficient for a formation of a block of samples for the second processing, associated with a previous frame and a maximum possible number of time domain samples associated with the current frame of the one or more time-scale-modified intermediate audio signals for a formation of blocks of samples for the second processing associated with the current frame,
such that blocks of samples for the second processing having uniform length are formed even if the time scale modification changes a frame length to be different from an integer multiple of the length of the blocks of samples used for the second processing.

72. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to selectively switch to a special time scale modification mode for frames classified as silent; and
wherein the audio processor is configured to perform the time scale modification in such a manner that no buffering of residual frames is required, when operating in the special time scale modification mode;
wherein a number of time domain samples of a current time-scale modified frame plus a number of buffered time domain samples of a previous time scale modified frame is an integer multiple of a number of time domain samples of a block of time domain samples processed by the second processing, or
wherein a number of time domain samples of a current time-scale modified frame plus a number of buffered time domain samples of a previous time scale modified frame is an integer multiple of a number of time domain samples input into the second processing to make a temporal increment
when operating in the special time scale modification mode.

73. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to time-interpolate between one or more processing parameters associated with a previous frame of the one or more intermediate audio signals and one or more processing parameters associated with a current frame of the one or more intermediate audio signals, in order to acquire processing parameters associated with different time instances of a current frame of the one or more time-scale modified intermediate audio signals using an interpolation function which determines contributions of the one or more processing parameters associated with the previous frame and contributions of one or more processing parameters associated with the current frame in a linear combination of processing parameters;
wherein for a temporally shortened audio frame, the interpolation function comprises a larger slope for a portion of the time scale modified current frame which has been acquired using an overlap-add-combination than for a portion of the time scale modified current frame which is unmodified; and/or
wherein for a temporally lengthened audio frame, the interpolation function comprises a smaller slope for a portion of the time scale modified current frame which has been acquired using an overlap-add-combination than for a portion of the time scale modified current frame which is unmodified.

74. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to time-interpolate between one or more processing parameters associated with a previous frame of the one or more intermediate audio signals and one or more processing parameters associated with a current frame of the one or more intermediate audio signals, in order to acquire processing parameters associated with different time instances of a current frame of the one or more time-scale modified intermediate audio signals using an interpolation function which determines contributions of the one or more processing parameters associated with the previous frame and contributions of one or more processing parameters associated with the current frame in a linear combination of processing parameters;
wherein the audio processor is configured to acquire interpolated processing parameters Pinter[n] associated with time instances having time index n according to Pinter[n]=ga,f[n]P+(1−ga,f)Pprev,
wherein P is a processing parameter or a set of processing parameters associated with a current frame of the one or more intermediate audio signals,
wherein Pprev is a processing parameter or a set of processing parameters associated with a previous frame of the one or more intermediate audio signals,
wherein Pinter is a processing parameter or a set of processing parameters associated with a time instance n in a current frame of the one or more time scale modified intermediate audio signals, and
wherein ga,f is an interpolation function;
wherein the interpolation function ga,f is defined as
$${g}_{a , f} [ n ] = max ( 0 , {g}_{a} [ n ] ) , and$$
$$wherein$$
$${g}_{a} [ n ] = \{ \begin{matrix}\frac{n + 1 ( {L}_{seg} - {L}_{rem} )}{2 {L}_{seg}} , {L}_{Seg} \leq n < {L}_{f} \\ ( n + 1 ) \frac{2 {L}_{Seg} + 1 - {L}_{rem}}{2 {L}_{seg} ( {L}_{Seg} - 1 )} , 0 \leq n < {L}_{seg}\end{matrix}$$
wherein n is a time index,
wherein
$$Lrem = Lf - Lseg ,$$
wherein Lf is a length of a frame to be processed;
wherein Lseg is the length of a portion in which an overlap-and-add is applied by the time scale modification.

75. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to perform, as the second processing, a processing of values of the one or more time-scale-modified intermediate audio signals according to
$$y [ n ] = ( {g}_{a , f} [ n ] M + ( 1 - {g}_{a , f} [ n ] ) {M}_{p r e v} ) x [ n ] , 0 \leq n < {L}_{f}$$
or according to
$${y}_{k} [ n ] = ( {g}_{a , f} [ n ] {M}_{k} + ( 1 - {g}_{a , f} [ n ] ) {M}_{k , p r e v} ) {x}_{k} [ n ] , 0 \leq n < {L}_{f} ,$$
wherein x[n] and xk[n] are of values or sets of value of the one or more time-scale-modified intermediate audio signals,
wherein M is a processing parameter or a set of processing parameters associated with a current frame of the one or more intermediate audio signals;
wherein Mprev is a processing parameter or a set of processing parameters associated with a previous frame of the one or more intermediate audio signals,
wherein n is a time index,
wherein Lf is a length of a frame to be processed, and
wherein ga,f is an interpolation function.

76. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
Wherein the audio processor is configured to determine a mapping vector defining an association between time slots of the one or more time scale modified intermediate audio signals and subframe indices of subframes of the one or more original intermediate audio signals in dependence on the time scale modification such that the mapping describes which processing parameters are allocated with which time slot of the time scale modified intermediate audio signals.

77. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
Wherein the audio processor is configured to determine a mapping vector defining an association between time slots of the one or more time scale modified intermediate audio signals and time slots of the one or more original intermediate audio signals in dependence on the time scale modification,
such that the mapping vector describes which processing parameters are allocated with which time slot of the time scale modified intermediate audio signals.

78. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to modify a subframe grid of subframes of the one or more time scale modified intermediate audio signals in dependence on a time scale modification of a current frame,
wherein lengths of subframes of the one or more time scale modified intermediate audio signals are left unchanged, and
wherein the second processing is configured to perform a subframe-based operation.

79. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
Wherein the audio processor is configured to modify a transient position information in dependence on the time scale modification.

80. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to determine a mapping vector defining an association between time slots of the one or more time scale modified intermediate audio signals and subframe indices of subframes of the one or more original intermediate audio signals in dependence on the time scale modification such that the mapping describes which processing parameters are allocated with which time slot of the time scale modified intermediate audio signals;
wherein the audio processor is configured to determine the mapping vector according to
$${m}_{s f} [ n ] = modulo ( {n}_{offset} + max ( 0 , \frac{⌊ ( 2 {L}_{s e g} - 1 ) {g}_{a , m a p} [ n ] ⌉}{{L}_{s f}} ) , {L}_{m d} )$$
or according to
$${m}_{s f} [ n ] = max ( 0 , \frac{⌊ ( 2 {L}_{s e g} - 1 ) {g}_{a , m a p} [ n ] ⌉}{{L}_{s f}} )$$
Wherein m_{sf}[n] is an element of the mapping vector;
Wherein n is a time slot index;
Wherein n_{offset} is an offset value;
Wherein L_{seg} is a half of a length of a frame of the one or more original intermediate audio signals in time slots;
Wherein 2L_{seg} is a length of a frame of the one or more original intermediate audio signals in time slots;
Wherein Lsf is a length of a subframe in time slots;
Wherein L_{md} is a length of a metadata buffer;
Wherein n_{offset} is; and
Wherein g_{a,map}[n] is an interpolation function;
Wherein └ ┐ denotes a rounding to a nearest integer;
Wherein modulo is a modulo operation and
Wherein a division is an integer division.

81. An audio processor for providing a processed audio signal representation on the basis of an input audio signal representation,
wherein the audio processor is configured to perform a plurality of processing steps, in order to provide the processed audio signal representation on the basis of the input audio signal representation;
wherein the audio processor is configured to perform a time scale modification on one or more intermediate audio signals, which are provided by a first processing on the basis of the input audio representation, in order to acquire one or more time-scale-modified intermediate audio signals, and
wherein the audio processor is configured to perform a second processing, which follows the first processing and which provides the processed audio signal representation, on the basis of the one or more time-scale-modified intermediate audio signals;
wherein the audio processor is configured to determine a mapping vector defining an association between time slots of the one or more time scale modified intermediate audio signals and time slots of the one or more original intermediate audio signals in dependence on the time scale modification,
such that the mapping vector describes which processing parameters are allocated with which time slot of the time scale modified intermediate audio signals,
wherein the audio processor is configured to determine the mapping vector according to
$${m}_{t s} [ n ] = max ( 0 , ⌊ ( 2 {L}_{s e g} - 1 ) {g}_{a , map} [ n ] ⌉ )$$
Wherein n is a time slot index,
Wherein 2Lseg is a length of a frame of the one or more original intermediate audio signals in time slots; and
Wherein g_{a,map}[n] is an interpolation function.
